(19) United States
(12) Patent Application Publication
(10) Pub. No.: US 2019/0158860 A1
(43) Pub. Date: May 23, 2019

(54) VIDEO DECODING DEVICE

(71) Applicant: SHARP KABUSHIKI KAISHA, Sakai City, Osaka (JP)

(72) Inventors: YUKINOBU YASUGI, Sakai City, Osaka (JP); TOMOHIRO IKAI, Sakai City (JP)

(21) Appl. No.: 16/099,665

(22) PCT Filed: Apr. 26, 2017
(86) PCT No.: PCT/JP2017/016626

§ 371 Date: Nov. 7, 2018

(30) Foreign Application Priority Data
May 13, 2016 (JP) 2016-097458

(51) Int. Cl. H04N 19/44; H04N 19/513

(52) U.S. Cl. CPC H04N 19/44; H04N 19/513

(57) ABSTRACT

In a video decoding device which refers to a prediction image obtained by motion compensation using a motion vector to generate a decoded image, a first derivation unit derives, as an initial motion source vector, a motion vector in a block or sub-block with a feature amount satisfying a prescribed condition, among multiple blocks or sub-blocks neighboring to a target block including a target sub-block.

### TECHNICAL FIELD

An embodiment of the disclosure relates to a video decoding device.

### BACKGROUND ART

In order to efficiently transmit or record video, a video coding device which generates coded data by coding video, and a video decoding device which generates a decoded image by decoding the coded data have been used.

Specific examples of a video coding scheme include schemes proposed in H-.264/MPEG-4. AVC or High-Efficiency Video Coding (HEVC).

In such a video coding scheme, images (pictures) constituting video are managed by a hierarchical structure including slices obtained by dividing the images, units of coding (also referred to as Coding Units: CUs) obtained by dividing the slices, and Prediction Units (PUs) and Transform Units (TUs) which are blocks obtained by dividing the coding units, and are coded/decoded for each CU.

In such a video coding scheme, generally, an input image is coded/decoded to obtain a local decoded image, based on which a prediction image is generated, the prediction image is subtracted from the input image (original image) to obtain a prediction residual (also referred to as a “difference image” or a “residual image”), and the prediction residual is coded. Examples of a method for generating a prediction image include inter-screen prediction (inter prediction) and intra-screen prediction (intra prediction).

One of video coding and decoding technologies in recent years is disclosed in NPL 1.

### CITATION LIST

### Non Patent Literature

NPL 1: Video/JVET, “Algorithm Description of Joint Exploration Test Model 2”, Joint Video Exploration Team (JVET) of ITU-TSG16 WP3 and ISO/IEC JTC1/SC29/WG11, February 2016, San Diego, USA.

### SUMMARY

### Technical Problem

NPL 1 uses the technology of Advanced temporal motion vector prediction (ATMVP) as a scheme for a motion vector prediction, but further improvement has been demanded in coding efficiency.

An object of an embodiment of the disclosure is to provide an image decoding device capable of improving coding efficiency.

### Solution to Problem

In order to solve the above problems, a video decoding device according to an aspect of the disclosure is a video decoding device for referring to a prediction image obtained by motion compensation using a motion vector to generate a decoded image, the video decoding device including a motion vector candidate derivation unit configured to derive a. motion vector candidate used for the motion compensation, wherein the motion vector candidate derivation unit includes a first derivation unit configured to derive an initial motion source vector MSV0, a second derivation unit configured to derive, as a motion source vector MSV, the initial motion source vector MSV0 or a vector obtained by scaling the initial motion source vector MSV0, and a third derivation unit configured to identify, as a corresponding sub-block CSB, a sub-block which is associated through the motion source vector MSV with a target sub-block on a target picture and is on a motion source picture MSP, and derive, as a motion vector candidate for the target sub-block, a corresponding sub-block motion vector CSBMV which is a motion vector in the corresponding sub-block CSB or a vector obtained by scaling the corresponding sub-block motion vector CSBMV, and the first derivation unit derives, as the initial motion source vector MSV0, a motion vector in a block or sub-block with a feature amount satisfying a prescribed condition among multiple blocks or sub-blocks neighboring a target block including the target sub-block.

Moreover, in order to solve the above problems, a video decoding device according to an aspect of the disclosure is a video decoding device for referring to a prediction image obtained by motion compensation using a motion vector to generate a decoded image, the video decoding device including a motion vector candidate derivation unit configured to derive a motion vector candidate used for the motion compensation, wherein the motion vector candidate derivation unit includes a first derivation unit configured to derive an initial motion source vector MSV0, a second derivation unit configured to derive, as a motion source vector MSV, the initial motion source vector MSV0 or a vector obtained by scaling the initial motion source vector MSV0, and a third derivation unit configured to identify, as a corresponding sub-block CSB, a sub-block which is associated through the motion source vector MSV with a target sub-block on a target picture and is on a motion source picture MSP, and derive, as a motion vector candidate for the target sub-block, a corresponding sub-block motion vector CSBMV which is a motion vector in the corresponding sub-block CSB or a vector obtained by scaling the corresponding sub-block motion vector CSBMV, and the first derivation unit derives, as the initial motion source vector MSV0, a motion vector in a block or sub-block to which merge prediction is applied among multiple blocks or sub-blocks neighboring a target block including the target sub-block.

Moreover, in order to solve the above problems, a video decoding device according to an aspect of the disclosure is a video decoding device for referring to a prediction image obtained by motion compensation using a motion vector to generate a decoded image, the video decoding device including a motion vector candidate derivation unit configured to derive a motion vector candidate used for the motion compensation, wherein the motion vector candidate derivation unit includes a first derivation unit configured to derive an initial motion source vector MSV0, a second derivation unit configured to derive, as a motion source vector MSV, the initial motion source vector MSV0 or a vector obtained by scaling the initial motion source vector MSV0, and a third derivation unit configured to identify, as a corresponding sub-block CSB, a sub-block which is associated through the motion source vector MSV with a target sub-block on a target picture and is on a motion source picture MSP, and derive, as a motion vector candidate for the target sub-block, a corresponding sub-block motion vector CSBMV which is a motion vector in the corresponding sub-block CSB or a vector obtained by scaling the corresponding sub-block motion vector CSBMV, and the third derivation unit, in a case that a slice which is obtained by partitioning the target picture and includes the target sub-block is a slice to which bidirectional prediction is applied, and the corresponding sub-block CSB is associated with multiple corresponding sub-block motion vectors CSBMV, derives, as bidirectional motion vector candidates for the target sub-block, higher priority corresponding sub-block motion vectors CSBMV among the multiple corresponding sub-block motion vectors CSBMV, or vectors obtained by scaling the higher priority corresponding sub-block motion vector CSBMV.

### Advantageous Effects of Disclosure

According to the above configuration, coding efficiency can be improved.

### BRIEF DESCRIPTION OF DRAWINGS

FIGS. 1A to 1F are diagrams illustrating a hierarchical structure of data of a coded stream according to the present embodiment.

FIGS. 2A to 2H are diagrams illustrating patterns for a PU partition mode. FIGS. 2A to 2H respectively illustrate partition shapes in cases that the PU partition mode is 2N×2N, 2N×N, 2N×nU, 2N×nD, N×2N, nL×2N, nR×2N, and N×N.

FIG. 3 is a conceptual diagram illustrating an example of a reference picture list.

FIG. 4 is a conceptual diagram illustrating an example of a reference picture.

FIG. 5 is a schematic diagram illustrating a configuration of an image decoding device according to the present embodiment.

FIG. 6 is a schematic diagram illustrating a configuration of an inter-prediction parameter decoding unit according to the present embodiment.

FIG. 7 is a schematic diagram illustrating a configuration of a merge prediction parameter derivation unit according to the present embodiment.

FIG. 8 is a schematic diagram illustrating a configuration of a merge candidate derivation unit according to the present embodiment.

FIG. 9 is a schematic diagram illustrating a configuration of an ATMVP merge candidate derivation unit according to the present embodiment.

FIG. 10 is a schematic diagram illustrating a configuration of an AMVP prediction parameter derivation unit according to the present embodiment.

FIG. 11 is a conceptual diagram illustrating an example of a vector candidate.

FIG. 12 is a schematic diagram illustrating a configuration of an inter-prediction parameter decoding controller according to the present embodiment.

FIG. 13 is a schematic diagram illustrating a configuration of an inter-prediction image generation unit according to the present embodiment.

FIG. 14 is a block diagram illustrating a configuration of an image coding device according to the present embodiment.

FIG. 15 is a schematic diagram illustrating a configuration of an inter-prediction parameter coding unit according to the present embodiment,

FIG. 16 is a schematic diagram illustrating a configuration of an image transmission system according to an embodiment of the disclosure.

FIG. 17 is a flowchart illustrating a flow of inter-prediction syntax decoding processing which is performed by the inter-prediction parameter decoding controller according to the present embodiment.

FIGS. 18A and 18B are flowcharts illustrating a flow of motion vector derivation processing which is performed by the inter-prediction parameter decoding unit according to the present embodiment.

FIG. 19 is a flowchart illustrating a flow of merge candidate derivation processing which is performed by the merge candidate derivation unit according to the present embodiment.

FIG. 20 is a conceptual diagram illustrating a block referred to in deriving a neighboring MV and a TMVP.

FIG. 21 is a flowchart illustrating a flow of ATMVP derivation processing which is performed by the ATM VP merge candidate derivation unit according to the present embodiment.

FIG. 22 is a conceptual diagram illustrating a PU referred to in deriving an initial motion source vector.

FIG. 23 is a flowchart illustrating the flow of processing for determining a reference list which is a search target in acquiring the initial motion source vector according to the present embodiment, the processing being performed by a first derivation unit.

FIG. 24 is a conceptual diagram illustrating a center block in a case that a target PU is partitioned into 4×4 sub-blocks.

FIG. 25 is a flowchart illustrating a flow of motion source picture derivation processing which is performed by a second derivation unit according to the present embodiment.

FIG. 26 is a flowchart illustrating the flow of the motion source picture derivation processing which is performed by the second derivation unit according to the present embodiment.

FIG. 27 is a conceptual diagram illustrating initial motion source vector scale processing which is performed by the second derivation unit according to the present embodiment.

FIG. 28 is a conceptual diagram illustrating a corresponding motion vector CMV.

FIG. 29 is a flowchart illustrating a flow of processing of deriving an ordered list PicList containing reference pictures, as elements, each of which is a search target in acquiring a motion source picture MSP according to the present embodiment, the processing being performed by the second derivation unit.

FIG. 30 is a conceptual diagram illustrating default motion vector derivation processing which is performed by the second derivation unit according to the present embodiment.

FIG. 31 is a conceptual diagram illustrating corresponding motion vector scale processing which is performed by the second derivation unit according to the present embodiment.

FIGS. 32A and 32B are conceptual diagrams illustrating corresponding sub-block motion vector scale processing which is performed by a third derivation unit according to the present embodiment.

FIG. 33 is a conceptual diagram illustrating blocks which are referred to in derivation of a STMVP performed by a STMVP merge candidate derivation unit according to the present embodiment.

FIG. 34 is a flowchart illustrating an example of a flow of initial motion source vector derivation processing which is performed by the first derivation unit according to the present embodiment.

FIG. 35 is a flowchart illustrating another example of the flow of the initial motion source vector derivation processing which is performed by the first derivation unit according to the present embodiment.

FIG. 36 is a flowchart illustrating yet another example of the flow of the initial motion source vector derivation processing which is performed by the first derivation unit according to the present embodiment.

FIG. 37 is a flowchart illustrating yet another example of the flow of the initial motion source vector derivation processing which is performed by the first derivation unit according to the present embodiment.

FIG. 38 is a flowchart illustrating yet another example of the flow of the initial motion source vector derivation processing which is performed by the first derivation unit according to the present embodiment.

FIG. 39 is a conceptual diagram illustrating the corresponding sub-block motion vector scale processing which is performed by the third derivation unit using a higher priority corresponding sub-block motion vector according to the present embodiment.

FIGS. 40A and 40B are diagrams illustrating configurations of a transmission device equipped with the above image coding device and a reception device equipped with the above image decoding device. FIG. 40A illustrates the transmission device equipped with the image coding device and FIG. 40B illustrates the reception device equipped with image decoding device.

FIGS. 41A and 41B are diagrams illustrating configurations of a recording device equipped with the above image coding device and a reproducing device equipped with the above image decoding device. FIG. 41A illustrates the recording device equipped with the image coding device and FIG. 41B illustrates the reproducing device equipped with the image decoding device.

### DESCRIPTION OF EMBODIMENTS

### First Embodiment

Hereinafter, embodiments of the disclosure are described with reference to the drawings.

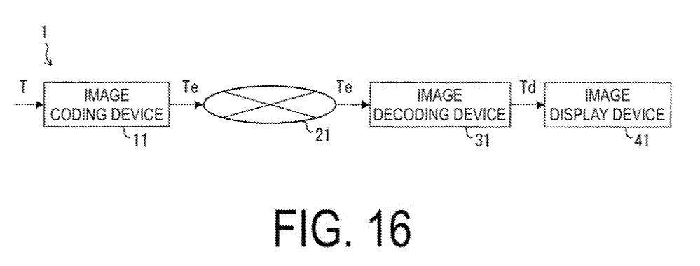

FIG. 16 is a schematic diagram illustrating a configuration of an image transmission system 1 according to the present embodiment.

The image transmission system 1 is a system in which a code obtained by coding a coding target image is transmitted and the image obtained by decoding the transmitted code is displayed. The image transmission system 1 is configured to include an image coding device (video coding device) 11, a network 21, an image decoding device (video decoding device) 31, and an image display device 41.

Signals T indicating the image are input to the image coding device 11.

The network 21 transmits a coded stream Te generated by the image coding device 11 to the image decoding device 31. The network 21 includes the Internet (internee), a Wide Area Network (WAN), or a Local Area Network (LAN), or a combination thereof. The network 21 is not necessarily limited to a bidirectional communication network, but may be a unidirectional or bidirectional communication network transmitting broadcast waves such as digital terrestrial broadcasting and satellite broadcasting. The network 21 may be substituted by a storage medium on which the coded stream Te is recorded such as a Digital Versatile Disc (DVD) and a Blue-ray Disc (registered trademark) (BD).

The image decoding device 31 decodes each coded stream Te transmitted by the network 21, and generates one or multiple decoded images Td.

The image display device 41 displays all or some of one or multiple decoded images Td generated by the image decoding device 31. The image display device 41 includes a display device, for example, a liquid crystal display and an organic Electro-luminescence (EL) display.

### Structure of Coded Stream Te

Before describing in detail the image coding device 11 and the image decoding device 31 according to the present embodiment, a description is given of a data structure of the coded stream Te which is generated by the image coding device 11 and decoded by the image decoding device 31.

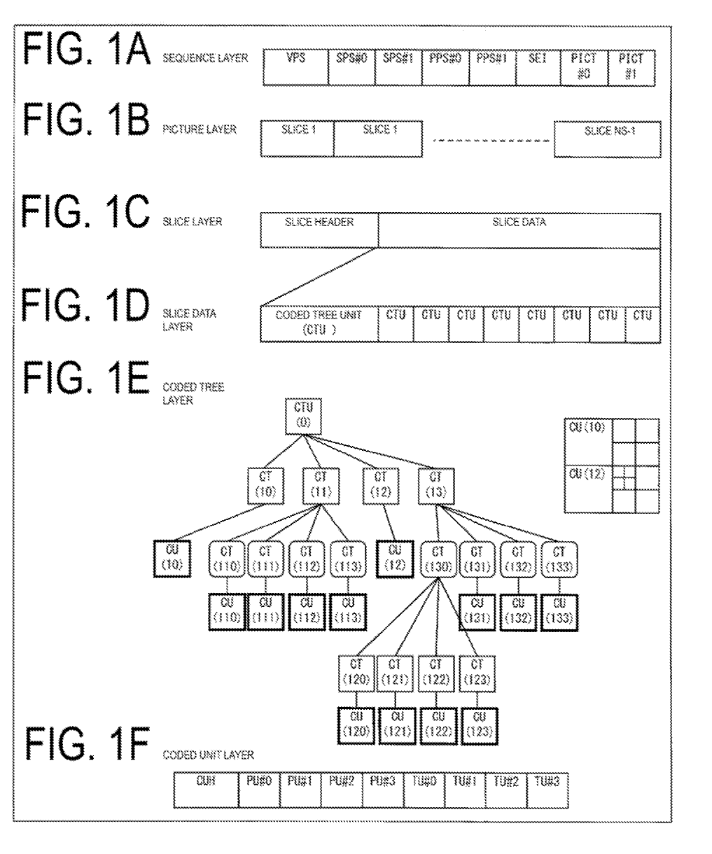

FIGS. 1A to 1F are diagrams illustrating a hierarchical structure of data in the coded stream Te. The coded stream Te exemplarily contains a sequence and multiple pictures constituting the sequence. FIGS. 1A to 1F are diagrams respectively illustrating a sequence layer specifying a sequence SEQ, a picture layer specifying a picture PICT, a slice layer specifying a slice 5, a slice data layer specifying slice data, a coded tree layer specifying a coded tree unit included in the slice data, and a coded unit layer specifying a Coding Unit (CU) included in the coding tree.

### Sequence Layer

The sequence layer specifies a set of data to which the image decoding device 31 refers in order to decode the sequence SEQ to be processed. The sequence SEQ contains, as illustrated in FIG. 1A, a Video Parameter Set, a Sequence Parameter Set (SPS), a Picture Parameter Set (PPS), a picture PICT, and Supplemental Enhancement Information (SEI). Here, a value following “if” indicates a layer ID in scalable coding. The layer ID is used to distinguish pictures in a case that a certain time period is constituted by one or more pictures. FIGS. 1A to 1F illustrate an example in which there is coded data of #0 and #1, that is, a layer 0 and a layer 1, but types of layer and the number of layers are not limited thereto. Note that the layer ID is omitted because a case of not the scalable coding is described below. However, in a case of using the scalable coding also, a method described below can be applied to pictures in the identical layer (pictures having the same layer ID).

The video parameter set VPS specifies, a set of coding parameters common to multiple sequences and a set of coding parameters associated with layers contained in the sequence and individual layers.

The sequence parameter set SPS specifies a set of coding parameters to which the image decoding device 31 refers in order to decode a target sequence. For example, the width and height of a picture are specified. There may be multiple SPSs. In this case, any of multiple SPSs is selected from the PPS.

The picture parameter set PPS specifies a set of coding parameters to which the image decoding device 31 refers in order to decode pictures in the target sequence. For example, the PPS includes a reference value of a quantization width (pie_init_qp_minus26) used to decode the picture and a flag indicating that a weighted prediction is applied (weighted_pred_flag). There may be multiple PPSs. In this case, any of multiple PPSs is selected from the pictures in the target sequence.

### Picture Layer

The picture layer specifies a set of data to which the image decoding device 31 refers in order to decode a picture PICT to be processed. The picture PICT contains slices S0 to SNS-1 (NS represents the total number of slices contained in the picture PICT) as illustrated in FIG. 1B.

Hereinafter, the slices S0 to SNS-1 may be expressed with their suffixes omitted in a case of not necessary to be distinguished from each other. The same holds for other data with a suffix which is contained in the coded stream Te described below.

### Slice Layer

The slice layer specifies a set of data to which the image decoding device 31 refers in order to decode a slice S to he processed. The slice S contains a slice header SH and slice data SDATA, as illustrated in FIG. 1C.

The slice header SH contains a coding parameter group to which the image decoding device 31 refers in order to determine a method of decoding a target slice. Slice type specifying information (slice_type) specifying a slice type is an example of the coding parameter contained in the slice header SH.

Examples of the slice type specifiable by the slice type specifying information include (1) I slice that is coded using intra prediction only, (2) P slice that is coded using unidirectional prediction or intra prediction, and (3) B slice that is coded using unidirectional prediction, bidirectional prediction, or intra prediction.

The slice header SH may include reference to the picture parameter set PPS (pic_parameter_set_id) which is contained in the above sequence layer.

### Slice Data Layer

The slice data layer specifies a set of data to which the image decoding device 31 refers in order to decode slice data SDATA to be processed. The slice data SDATA contains a Coded Tree Unit (CTU) as illustrated in FIG. ID. The CTU is a block having a fixed size (e.g., 6.4×64) constituting a slice, and may be also referred to as a Largest Cording Unit (LCU).

### Coded Tree Layer

The coded tree layer specifies a set of data to Which the image decoding device 31 refers in order to decode a coded tree unit to be processed as illustrated in FIG. 1E. The coded tree unit is partitioned by recursive quadtree partitioning. A node of a tree structure obtained by the recursive quadtree partitioning is called a coding tree (CT). An intermediate node of the quadtree is a Coded Quad Tree (CQT) and the coded tree unit itself is specified as a top CQT. The CTU contains a split flag (split_flag), and is partitioned into four coded tree units CTU in a case that split_flag is 1. In a case that split flag is 0, the coded tree unit CTU is not partitioned and has one Coded Unit (CU) as a node. The coding unit CU is a terminal node of the coded tree layer and is not partitioned any further in this layer. The coding unit CU is a basic unit for coding processing.

In a case that a size of the coded tree unit CTU is 64×64 pixel, a size of the coding unit may he any of 64×64 pixel, 32×32 pixel, 16×16 pixel, and 8×8 pixel,

### Coded Unit Layer

The coded unit layer specifics a set of data to which the image decoding device 31 refers in order to decode a coding unit to be processed, as illustrated in FIG. 1F. Specifically, the coding unit includes a prediction tree, a transform tree, and a CU header CUH. The CU header specifies a split flag, a division pattern, a prediction mode, and the like.

The prediction tree specifies prediction information (reference picture index, motion vector, etc.) of each of the prediction units (PU) which are obtained by partitioning the coding unit into one or multiple pieces. In other words, the prediction unit/units is/are one or multiple non-overlapping areas which constitute the coding unit. The prediction tree includes one or multiple prediction units which are obtained by the above partitioning. Hereinafter, a unit of prediction obtained by further partitioning the prediction unit is called a “sub-block”. The sub-block is configured with multiple In a case that a size of the prediction unit is equal to a size of the sub-block, the number of sub-blocks in the prediction unit is one. In a case that a size of the prediction unit is larger than a size of the sub-block, the prediction unit is partitioned into the sub-blocks. For example, in a case that a size of the prediction unit is 8×8 and a size of the sub-block is 4×4, the prediction unit is partitioned horizontally into two and vertically into two to be partitioned into four sub-blocks.

Prediction processing may be performed for each of these prediction units (sub-blocks).

A type of partition for the prediction tree is roughly classified into two for a case of the intra prediction and a case of the inter prediction. The intra prediction is prediction within an identical picture, and the inter prediction is prediction processing performed between pictures different from each other e.g., between display times, between layer images in scalable coding).

In the case of the intra prediction, a partition method includes method using 2N×2N (the same size as the coding unit) and N×N.

In the case of the inter prediction, a partition method includes coding in a PU partition mode (part mode) in the coded data, and includes methods using 2N×2N (the same size as the coding unit), 2N×N, 2N×nU, 2N×nD, N×2N, nL×2N, nR×2N, and N×N. Note that 2N×nU indicates that a 2N×2N coding unit are partitioned into two areas, 2N×0.5N and 2N×1.5N, in this order from the upside. 2N×nD indicates that a 2N×2N coding unit is partitioned into two areas, 2N×1.5N and 2N×0.5N, in this order from the upside. nL×2N indicates that a 2N×2N coding unit is partitioned into two areas. 0.5N×2N and 1.5N×2N, in this order from the left. nR×2N indicates that a 2N×2N coding unit is partitioned into two areas, 1.5N×2N and 0.5N×1.5N, in this order from the left. The number of partitions is any of 1, 2, and 4, and thus, the number of PUs included in the CU is 1 to 4. These PUs are expressed as PU0, PU1, PU2, and PU3 in this order.

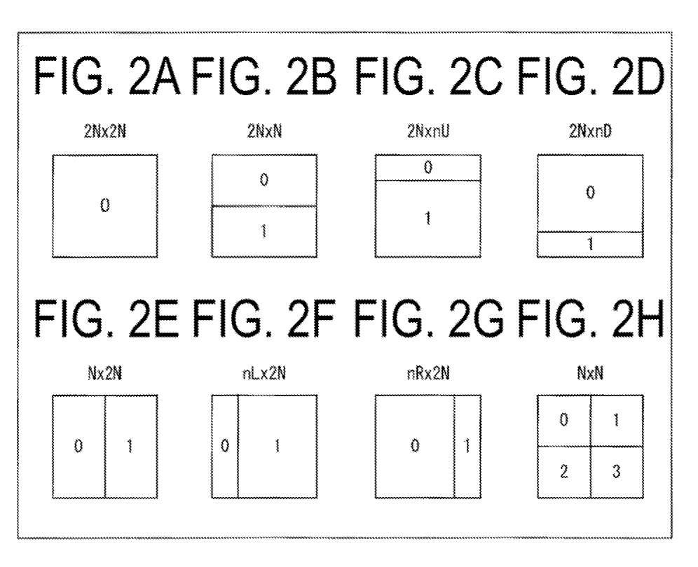

Each of FIGS. 2A to 2H specifically illustrates a boundary location of PU partitioning in the CU for each partition type.

FIG. 2A illustrates a PU partition mode for 2N×2N in which the CU is not partitioned.

FIGS. 2B, 2C and 2D illustrate, respectively, partition shapes in cases that the PU partition modes are 2N×N, 2N×nU, and 2N×nD. Hereinafter, the partitions in the cases that the PU partition modes are 2N×N, 2N×nU, and 2N×nD are collectively referred to as a horizontally-long partition.

FIGS. 2E, 2F and 2G illustrate, respectively, partition shapes in the cases that the PU partition modes are N×2N, nL×2N, and nR×2N. Hereinafter, the partitions in the case that the PU partition types are N×2N, nL×2N, and nR×2N are collectively referred to as a vertically-long partition.

The horizontally-long partition and the vertically-long partition are collectively referred to as a rectangular partition.

FIG. 2H illustrates a partition shape in a case that the PU partition mode is N×N. The PU partition modes in FIGS. 2A and 2H are also referred to as square partitioning based on their partition shapes. The PU partition modes in FIGS. 2B to 2G are also referred to as non-square partitioning.

In FIGS. 2A to 2H, the number assigned to each partition indicates an identification number of the partition, and the partitions are processed in an order of the identification number. To be more specific, the identification number represents a scan order for partitioning.

In FIGS. 2A to 2H, assume that an upper left corner is a base point (origin) of the CU.

In the transform tree, the coding unit is partitioned into one or multiple transform units, and a location and size of each transform unit is specified. In other words, the transform unit/units is/are one or multiple non-overlapping areas which constitute the coding unit. The transform tree includes one or multiple transform units which are obtained by the above partitioning.

Partitioning in the transform tree includes that performed by allocating an area having the same size as the coding unit as a transform unit, and that performed by the recursive quadtree partitioning similar to the partitioning of the coded tree unit CTU described above.

Transform processing is performed for each of these transform units.

### Prediction Parameter

A prediction image in the Prediction Unit (PU) is derived according to a prediction parameter associated with the PU. The prediction parameter includes a prediction parameter for intra prediction or a prediction parameter for inter prediction. Hereinafter, the prediction parameter for inter prediction (inter-prediction parameter) is described. The inter-prediction parameter includes prediction list utilization flags predFlagL0 and predFlagL1, reference picture indices refIdxL0 and refIdxL1, and vectors mvL0 and mvL1. The prediction list utilization flags predFlagL0 and predFlagL1 are flags respectively indicating whether or not reference picture lists called L0 list and L1 list are used, and in a case that a value of each thereof is 1, the corresponding reference picture list is used. Here, assume that in a case that an expression “a flag indicating whether or not XX” is used herein, “1” corresponds to a case of XX and “0” corresponds to a case of not XX, and “1” represents true and “0” represents false in logical NOT, logical AND or the like (the same applies hereinafter). However, other values may be used as a true value or a false value in an actual device or methods. A case where two reference picture lists are used, that is, a case where predFlagL0=1 and predFlagL1=1, corresponds to bi-prediction, and a case where one reference picture list is used, that is, a case where (predFlagL0, predFlagL1)=(1, 0) or (predFlagL0, predFlagL1)=(0, 1), corresponds to uni-prediction. Information on the prediction list utilization flag can be also expressed by an inter-prediction indicator inter_pred_idc described below. In general, a prediction image generation unit (prediction image generation device) 308 and prediction parameter memory 307 which are described below use the prediction list utilization flag, and in a case that information concerning which reference picture list is used or not is decoded from the coded data, the inter-prediction indicator inter pred idc is used.

Examples of a syntax element for deriving the inter-prediction parameter included in the coded data include a partition mode part mode, a merge flag merge flag, a merge index merge_idx, an inter-prediction indicator inter_pred_idc, a reference picture index refIdxLX, a prediction vector index mvp_LX_idx, and a difference vector mvdLX, for example.

### Example of Reference Picture List

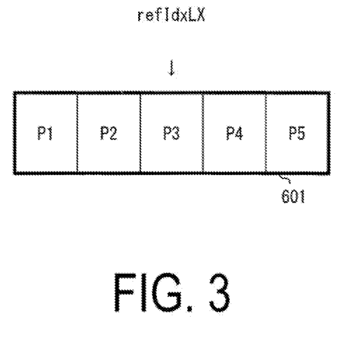

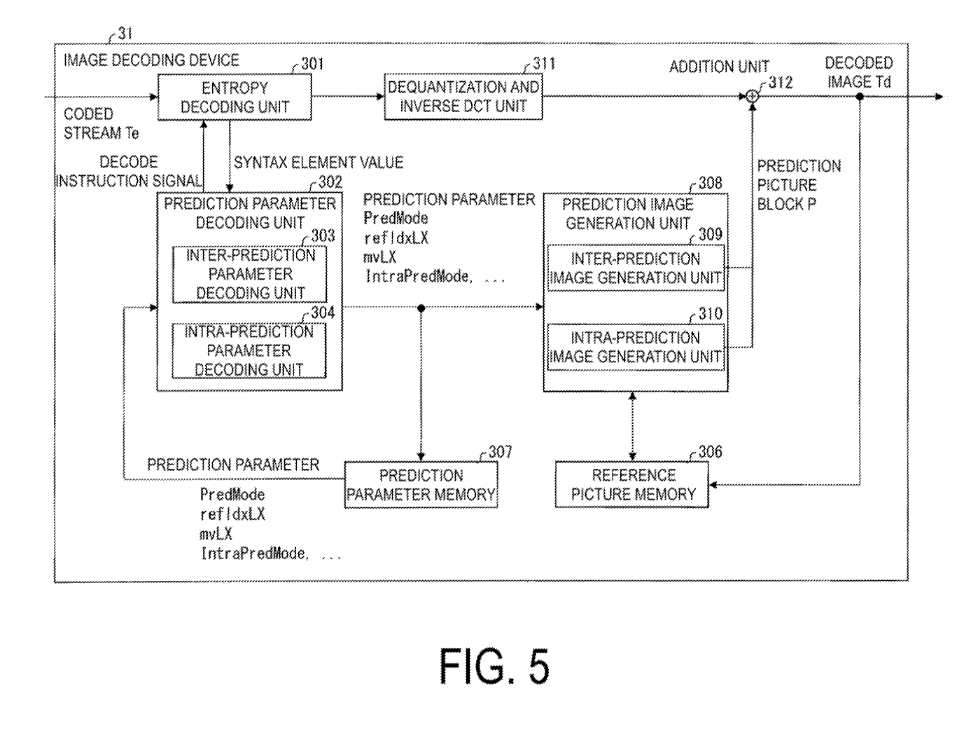

Next, a description is given of an example of the reference picture list The reference picture list is a row constituted by the reference pictures stored in a reference picture memory 306 (FIG. 5). FIG. 3 is a conceptual diagram illustrating an example of the reference picture list. In a reference picture list 601, each of five rectangles horizontally aligned represents a reference picture. Signs P1, P2, P3, P4, and P5 indicated from a left end to the right are signs representing corresponding reference pictures. A suffix of P indicates a picture order count POC. A downward arrow immediately under “refIdxLX” represents that the reference picture index refIdxLX is an index for referring to a reference picture P3 in the reference picture memory 306.

### Example of Reference Pictures

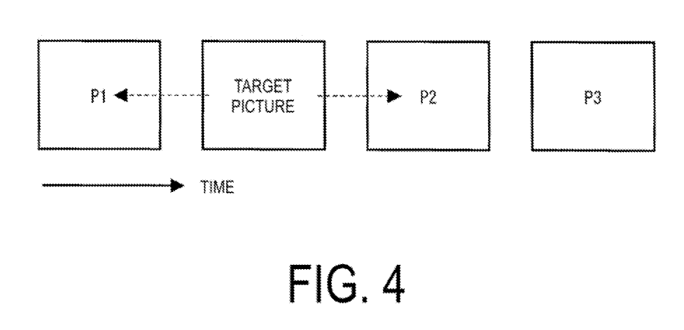

Next, a description is given of an example of the reference pictures which are used to derive a motion vector. FIG. 4 is a conceptual diagram illustrating an example of the reference pictures. In FIG. 4, a horizontal axis represents a display time. Four rectangles illustrated in FIG. 4 represent respectively pictures. The second rectangle from the left among four rectangles represents a decoding target picture (target picture) and the other three rectangles represent the reference pictures. The reference picture P1 indicated by a leftward arrow from the target picture is a previous picture. The reference picture P2 indicated by a rightward arrow from the target picture is a future picture. In FIG. 4, the reference picture P1 or P2 is used in motion prediction in which the target picture is used as a reference.

### Inter-Prediction Indicator and Prediction List Utilization Flag

The inter-prediction indicator interpred_idc, and the prediction list utilization flags predFlagL0 and predFlagL1 are mutually transformable as shown below. Therefore, the prediction list utilization flag may be used as the inter-prediction parameter or inter-prediction indicator may be used. In the following description, in determination using the prediction list utilization flag, the inter-prediction indicator may be alternatively used. In contrast, in determination using the inter-prediction indicator, the prediction list utilization flag may be alternatively used.

inter_pred_idc=(predFlagL1<<1) +predFlagL0

predFlagL0=inter_pred_idc & 1

predFlagL1=inter_pred_idc>>1

where “>>” represents right shift, “<<” represents left shift, and “&” represents logical AND in bit unit.

### Merge Prediction and AMVP Prediction

A prediction parameter decoding (coding) method includes a merge prediction (merge) mode and an Adaptive Motion Vector Prediction (AMVP) mode, and a merge flag merge flag is a flag identifying these modes. In both the merge prediction mode and the AMVP mode, a prediction parameter for an already processed PU is used to derive a prediction parameter for a target PU. The merge prediction mode is a mode in which a prediction list utilization flag predFlagLX (or inter-prediction indicator inter_pred_idc), a reference picture index refIdxLX, and a motion vector mvLX are not included in the coded data, and the prediction parameter already derived for a neighboring PU is used as it is. The AMVP mode is a mode in which the inter-prediction indicator inter_pred _idc, the reference picture index refIdxLX, and the motion vector mvLX are included in the coded data. The motion vector mvLX is coded as a prediction vector index mvp_LX_idx identifying the prediction vector mvpLX and as a difference vector mvdLX.

The inter-prediction indicator inter_pred_idc is data indicating types and the number of the reference pictures, and has a value PRED_L0, PRED_L1, or PRED_BI. PRED_L0 and PRED_L1 indicate that the reference pictures stored in the reference picture lists called L0 list and L1 list, respectively, are used, and indicate that one reference picture is used (uni-prediction). The predictions using L0 list and L1 list are called L0 prediction and L1 prediction, respectively. PRED_BI indicates that two reference pictures are used (hi-prediction), and indicates that two reference pictures stored in L0 list and L1 list are used. The prediction vector index mvp_LX_idx is an index indicating a prediction vector, and the reference picture index refIdxLX is an index indicating a reference picture stored in the reference picture list. “LX” is a description method used in a case that the L0 prediction and the L1 prediction are not distinguished from each other, and a parameter for L0 list and a parameter for L1 list are distinguished by replacing “LX” with “L0” or “L1”. For example, refIdxL0 is a reference picture index used for the L0 prediction, refIdxL1 is a reference picture index used for the L1 prediction, and refIdxLX is an expression used in a case that refIdxL0 and refIdxL1 are not distinguished from each other.

The merge index merge_idx is an index indicating which prediction parameter is used as a prediction parameter for the decoding target PU, among prediction parameter candidates (merge candidates) derived from the PU on which the processing is completed.

### Motion Vector

The motion vector mvLX indicates a displacement between the blocks on two pictures which are different in times. The prediction vector and difference vector for the motion vector mvLX are called respectively a prediction vector mvpLX and a difference vector mvdLX. In the following description, the “motion vector” may include information of a reference picture index refIdx indicating which picture the vector is for. Therefore, a condition that “a block A is associated with a block B through a motion vector MV and a reference picture index refIdx” may be merely expressed as “a block A is associated with a block B through a motion vector MV”.

### Configuration of Image Decoding Device

Next, a description is given of a configuration of the image decoding device 31 according to the present embodiment. FIG. 5 is a schematic diagram illustrating the configuration of the image decoding device 31 according to the present embodiment. The image decoding device 31 is configured to include an entropy decoding unit 301, a prediction parameter decoding unit 302, a reference picture memory 306, a prediction parameter memory 307, a prediction image generation unit 308, a dequantization and inverse DCT unit 311, and an addition unit 312.

The prediction parameter decoding unit 302 is configured to include an inter-prediction parameter decoding unit 303 and an intra-prediction parameter decoding unit 304. The prediction image generation unit 308 is configured to include an inter-prediction image generation unit 309 and an intra-prediction image generation unit 310.

The entropy decoding unit 301 performs entropy decoding on the coded stream Te input from outside to demultipiex and decode individual codes (syntax elements). Examples of the demultiplexed codes include the prediction information for generating the prediction image and residual information for generating the difference image.

The entropy decoding unit 301 outputs some of the demultiplexed codes to the prediction parameter decoding unit 302. Some of the demultiplexed codes are, for example, a prediction mode predMode, partition mode part_mode, merge flag merge_flag, merge index merge idx, inter-prediction indicator inter_pred_idc, reference picture index refIdxLX, prediction vector index mvp_LX_idx, and difference vector mvdLX. Control on which code is to be decoded is based on an instruction from the prediction parameter decoding unit 302. The entropy decoding unit 301 outputs quantized coefficients to the dequantization and inverse DCT unit 311. The quantized coefficients are coefficients obtained by performing Discrete Cosine Transform (DCT) on the residual signal and quantization in the coding processing.

The inter-prediction parameter decoding unit 303 refers to the prediction parameter stored in the prediction parameter memory 307, based on the code input from the entropy decoding unit 301 to decode the inter-prediction parameter.

The inter-prediction parameter decoding unit 303 outputs the decoded inter-prediction parameter to the prediction image generation unit 308 and stores the parameter in the prediction parameter memory 307. The inter-prediction parameter decoding unit 303 is described in detail later.

The intra-prediction parameter decoding unit 304 refers to the prediction parameter stored in the prediction parameter memory 307, based on the code input from the entropy decoding unit 301 to decode the intra-prediction parameter. The intra-prediction parameter is a parameter used for processing to predict the CU within one picture, for example, an intra-prediction mode IntraPredMode. The intra-prediction parameter decoding unit 304 outputs the decoded intra-prediction parameter to the prediction image generation unit 308 and stores the parameter in the prediction parameter memory 307.

The intra-prediction parameter decoding unit 304 may derive an intra-prediction mode different in luminance and chrominance. In this case, the intra-prediction parameter decoding unit 304 decodes a luminance prediction mode intraPredModeY as a prediction parameter for luminance, and a chrominance prediction mode IntraPredModeC as a prediction parameter for chrominance. The luminance prediction mode IntraPredModeY has 35 modes, which correspond to planar prediction (0), DC prediction (1), and angular predictions (2 to 34). The chrominance prediction mode IntraPredModeC uses any of the following including, planar prediction (0), the DC prediction (1), the angular predictions (2 to 34), and LM mode (35). The intra-prediction parameter decoding unit 304 decodes a flag indicating whether or not IntraPredModeC is the same mode as the luminance mode, may assign IntraPredModeC equal to IntraPredModeY in a case that the flag indicates the same mode as the luminance mode, and may decode the planar prediction (0), the DC prediction (1), the angular predictions (2 to 34), and the LM mode (35) as

IntraPredModeC in a case that the flag indicates a mode different from the luminance mode.

The reference picture memory 306 stores the decoded image of the CU generated by the addition unit 312 in a predefined location for each decoding target picture and CU,

The prediction parameter memory 307 stores the prediction parameters in a predefined location for each decoding target picture and CU. To be more specific, the prediction parameter memory 307 stores the inter-prediction parameter decoded by the inter-prediction parameter decoding unit 303, the intra-prediction parameter decoded by the intra-prediction parameter decoding unit 304, and the prediction mode predMode demultiplexed by the entropy decoding unit 301 Examples of the stored inter-prediction parameter include the prediction list utilization flag prcdFlagLX (inter-prediction indicator inter_pred_idc), the reference picture index refIdxLX, and the motion vector mvLX.

Input to the prediction image generation unit 308 are the prediction mode predMode which is input from the entropy decoding unit 301 and the prediction parameters from the prediction parameter decoding unit 302. The prediction image generation unit 308 reads out the reference picture from the reference picture memory 306. The prediction image generation unit 308 uses the input prediction parameters and the read-out reference picture to generate a prediction image of the PU in the prediction mode indicated by the prediction mode predMode.

Here, in a case that the prediction mode predMode indicates the inter-prediction mode, the inter-prediction image generation unit 309 uses the inter-prediction parameter input from the inter-prediction parameter decoding unit 303 and the read-out reference picture to generate the prediction image of the PU by the inter-prediction.

The inter-prediction image generation unit 309 reads out from the reference picture memory 306 a reference picture block at a location which is indicated by the motion vector mvLX with reference to the decoding target PU from the reference picture indicated by the reference picture index refIdxLX with respect to the reference picture list having the prediction list utilization flag predFlagLX of 1 (L0 list or L1 list). The inter-prediction image generation unit 309 performs prediction, based on the read-out reference picture block to generate the prediction image of the PU. The inter-prediction image generation unit 309 outputs the generated prediction image of the PU to the addition unit 312.

In a case that the prediction mode predMode indicates the intra-prediction mode, the intra-prediction image generation unit 310 uses the intra-prediction parameter input from the intra-prediction parameter decoding unit 304 and the read-out reference picture to perform the intra-prediction. To be more specific, the intra-prediction image generation unit 310 reads out from the reference picture memory 306 the neighboring PU in a predefined range from the decoding target PU in the already decoded PUs of the decoding target picture. The predefined range is, for example, any of left, upper left, upper, and upper right neighboring PUs in a case that the decoding target PU sequentially moves in an order of a so-called raster scan, and depends on the intra-prediction mode. The order of the raster scan is in the order of sequentially moving from a left end to a right end of each row from an upper end to a bottom end in each picture.

The intra-prediction image generation unit 310 performs prediction on the read out neighboring PU in the prediction mode indicated by the intra-prediction mode IntraPredMode to generate the prediction image of the PU. The intra-prediction image generation unit 310 outputs the generated prediction image of the PU to the addition unit 312.

In a case that the intra-prediction parameter decoding unit 304 derives the intra-prediction mode different in luminance and chrominance, the intra-prediction image generation unit 310 generates a luminance prediction image of the PU by any of the planar prediction (0), the DC prediction (1), and the angular predictions (2 to 34) depending on the luminance prediction mode IntraPredModeY, and generates a chrominance prediction image of the PU by any of the planar prediction (0), the DC prediction (1), the angular predictions (2 to 344), and the LM mode (35) depending on the chrominance prediction mode IntraPredModeC.

The dequantization and inverse DCT unit 311 dequantizes the quantized coefficients input from the entropy decoding unit 301 to find DCT coefficients. The dequantization and inverse DCT unit 311 performs Inverse Discrete Cosine Transform (inverse DCT) on the found DCT coefficients to compute a decoded residual signal. The dequantization and inverse DCT unit 311 outputs the computed decoded residual signal to the addition unit 312.

The addition unit 312 adds the prediction image of the PU input from the inter-prediction image generation unit 309 and intra-prediction image generation unit 310 and the decoded residual signal input from the dequantization and inverse DCT unit 311 for each pixel to generate a decoded image of the PU. The addition unit 312 stores the generated decoded image of the PU in the reference picture memory 306, and outputs, to outside, a decoded image Td in which the generated decoded image of the PUs are integrated for each picture.

### Configuration of Inter-Prediction Parameter Decoding Unit

Next, a description is given of a configuration of the inter-prediction parameter decoding unit 303.

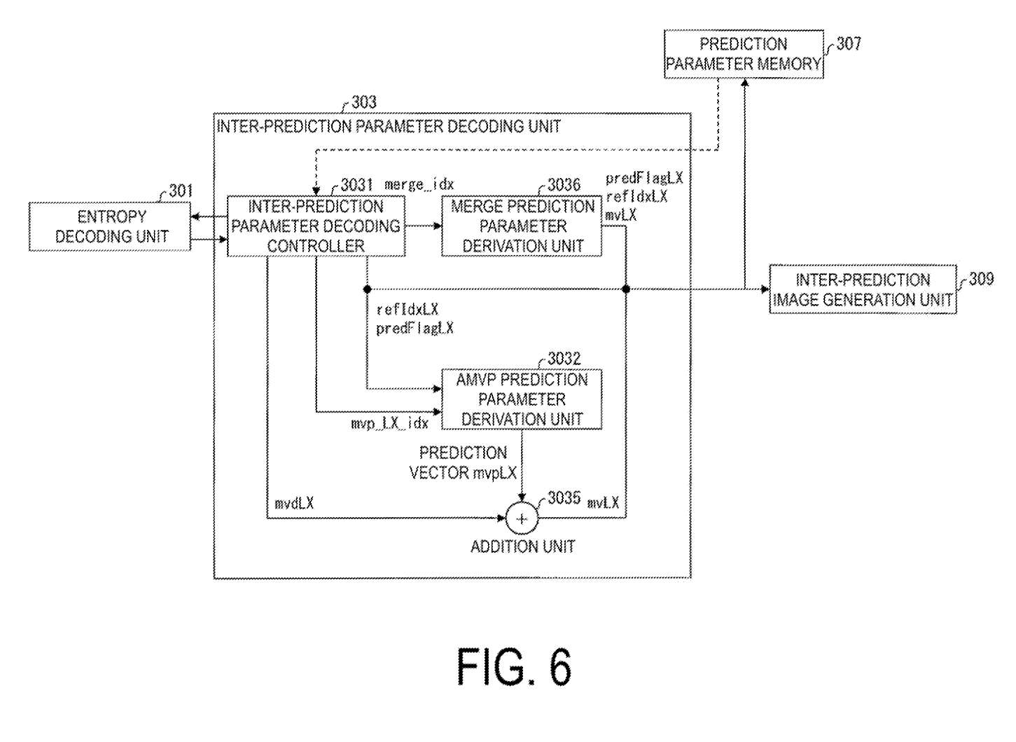

FIG. 6 is a schematic diagram illustrating the configuration of the inter-prediction parameter decoding unit 303 according to the present embodiment. The inter-prediction parameter decoding unit 303 is configured to include an inter-prediction parameter decoding controller 3031, an AMVP prediction parameter derivation unit 3032, an addition unit 3035, and a merge prediction parameter derivation unit (motion vector candidate derivation unit) 3036.

The inter-prediction parameter decoding controller 3031 instructs the entropy decoding unit 301 to decode the code (syntax element) associated with the inter-prediction to extract the code (syntax element) included in the coded data., for example, the partition mode part_mode, the merge flag merge_flag, the merge index merge_idx, the inter-prediction indicator inter_pred_idc, the reference picture index retldxLX, the prediction vector index mvp_LX_idx, and the difference vector mvdLX.

The inter-prediction parameter decoding controller 3031 first extracts the merge flag. An expression that the inter-prediction parameter decoding controller 3031 extracts a certain syntax element means instructing the entropy decoding unit 301 to decode a code of a certain syntax element to read the syntax element from the coded data. Here, in a case that the merge flag indicates a value of 1, that is, the merge prediction mode, the inter-prediction parameter decoding controller 3031 extracts the merge index merge_idx as a prediction parameter related to the merge prediction. The inter-prediction parameter decoding controller 3031 outputs the extracted merge index merge_idx to the merge prediction parameter derivation unit 3036.

In a case that the merge flag merge_flag is 0, that is, indicates the AMVP prediction mode, the inter-prediction parameter decoding controller 3031 uses the entropy decoding unit 301 to extract the AMVP prediction parameter from the coded data. Examples of the AMVP prediction parameter include the inter-prediction indicator inter_idc, the reference picture index refIdxLX, the prediction vector index mvp_LX_idx, and the difference vector mvdLX. The inter-prediction parameter decoding controller 3031 outputs the prediction list utilization flag predFlagLX derived from the extracted inter-prediction indicator inter_pred_idc and the reference picture index refIdxLX to the AMVP prediction parameter derivation unit 3032 and the prediction image generation unit 308 (FIG. 5), and stores the predFlagLX and refIdxLX in the prediction parameter memory 307. The inter-prediction parameter decoding controller 3031 outputs the extracted prediction vector index mvp_LX_idx to the AMVP prediction parameter derivation unit 3032. The inter-prediction parameter decoding controller 3031 outputs the extracted difference vector mvdLX to the addition unit 3035.

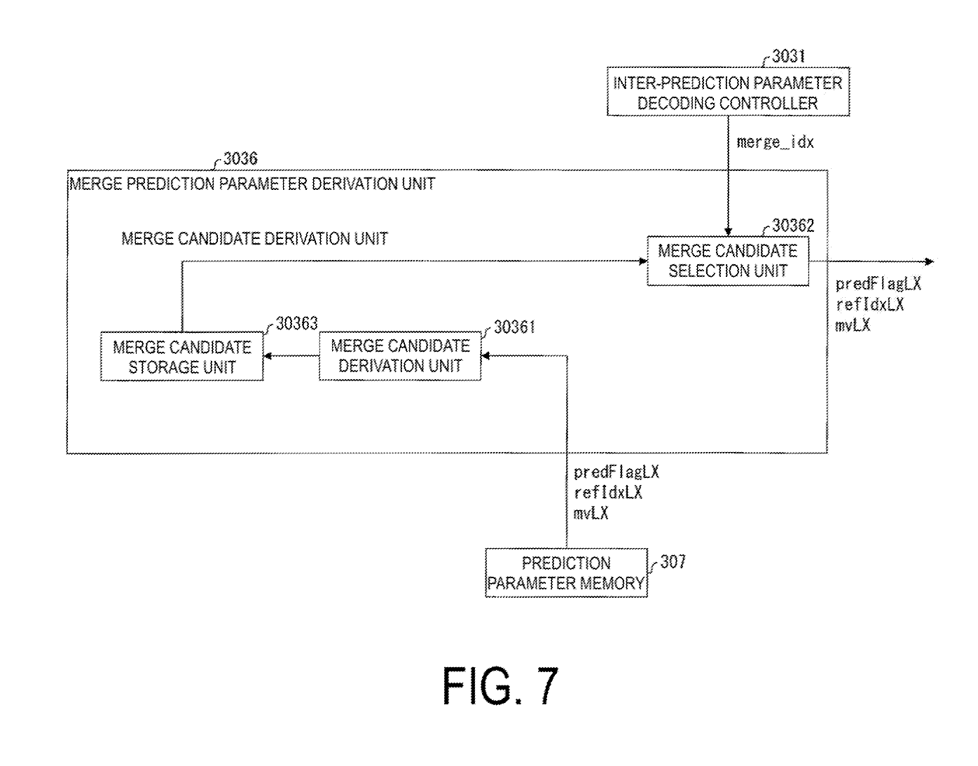

FIG. 7 is a schematic diagram illustrating a configuration of the merge prediction parameter derivation unit 3036 according to the present embodiment. The merge prediction parameter derivation unit 3036 includes a merge candidate derivation unit 30361, a merge candidate selection unit 30362, and a merge candidate storage unit 30363. The merge candidate storage unit 30363 stores therein merge candidates input from the merge candidate derivation unit 30361. The merge candidate is configured to include the prediction list utilization flag predFlagLX, the motion vector mvLX, and the reference picture index refIdxLX. The merge candidate stored in the merge candidate storage unit 30363 is assigned with an index according to a prescribed rule.

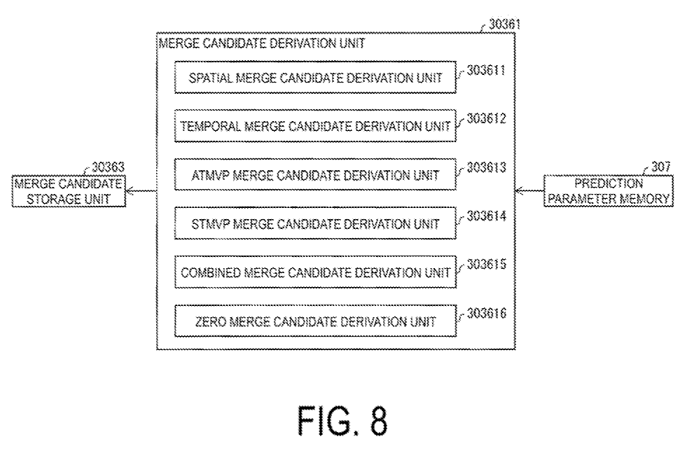

FIG. 8 is a schematic diagram illustrating a configuration of the merge candidate derivation unit 30361 according to the present embodiment. The merge candidate derivation unit 30361 includes a spatial merge candidate derivation unit 303611, a temporal merge candidate derivation unit 303612, an Advanced temporal motion vector prediction (ATMVP) merge candidate derivation unit 303613, a Spatial-temporal motion vector prediction (STMVP) merge candidate derivation unit 303614, a combined merge candidate derivation unit 303615, and a zero merge candidate derivation unit 303616. The processing of deriving the merge candidate by the merge candidate derivation unit 30361 is described later in detail referring to another drawing.

### Spatial Merge Candidate Derivation Unit

The merge candidate derivation unit 303611 reads out the prediction parameters (prediction list utilization flag predFlagLX, motion vector mvLX, reference picture index refIdxLX) stored by the prediction parameter memory 307 according to a prescribed rule to derive the read out prediction parameters as the merge candidates. The merge candidate derived by the spatial merge candidate derivation unit 303611 may be referred to as a neighboring MV. The read out prediction parameters are prediction parameters related to each of the PUs in a predefined range from the decoding target PU (e.g., all or some of PUs in contact with a lower left end, upper left end, and upper right end of the decoding target PU). The neighboring MV derived by the spatial merge candidate derivation unit 303611 is stored in the merge candidate storage unit 30363.

### Temporal Merge Candidate Derivation Unit

The temporal merge candidate derivation unit 303612 reads out, as merge candidates, the prediction parameters for the PU in the reference image including coordinates on the lower right of the decoding target PU from the prediction parameter memory 307. The merge candidate derived by the temporal merge candidate derivation unit 303612 may be referred as a Temporal motion vector prediction (TMVP). As a method of specifying the reference image, the reference picture index refidxLX specified in the slice header may be used, or a minimum one of the reference picture indices refIdxLX of the PUs neighboring to the decoding target PU may be used, for example. The TMVP derived by the temporal merge candidate derivation unit 303612 is stored in the merge candidate storage unit 30363.

### ATMVP Merge Candidate Derivation Unit

The ATMVP merge candidate derivation unit 303613 derives the ATMVP which is a merge candidate obtained by predicting a motion vector for each of the sub-blocks SB of the PU. The ATMVP derived by the ATMVP merge candidate derivation unit 303613 is stored in the merge candidate storage unit 30363. The configuration of the ATMVP merge candidate derivation unit 303613 is described later in detail referring to another drawing.

### STMTP Merge Candidate Derivation Unit

The STMVP merge candidate derivation unit 303614 uses the motion vector which is already derived in a block spatially neighboring to the sub-block SB to derive a STMVP that is the merge candidate. The STMVP derived by the STMVP merge candidate derivation unit 303614 is stored in the merge candidate storage unit 30363.

### Combined Merge Candidate Derivation Unit

The merge candidate derivation unit 303615 uses vectors and reference picture indices of the derived merge candidates which are already derived and stored in the merge candidate storage unit 30363 as vectors for L0 and L1, respectively, to combine, and thus derives a combined merge candidate. The merge candidates derived by the merge candidate derivation unit 30361 is stored in the merge candidate storage unit 30363.

### Zero Merge Candidate Derivation Unit

The zero merge candidate derivation unit 303616 derives a merge candidate including a reference picture index refIdxLX of 0 and both an X component and Y component of 0 of a motion vector mvLX. The merge candidates derived by the merge candidate derivation unit 30361 is stored in the merge candidate storage unit 30363.

### Configuration of ATMVP Merge Candidate Derivation Unit

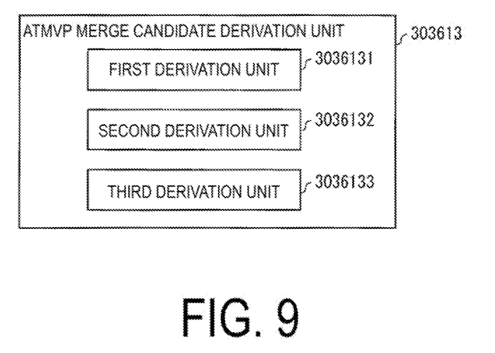

FIG. 9 is a schematic diagram illustrating a configuration of the ATMVP merge candidate derivation unit 303613 according to the present embodiment. The ATMVP merge candidate derivation unit 303613 includes a first derivation unit 3036131, a second derivation unit 3036132, and a third derivation unit 3036133.

### First Derivation Unit

The first derivation unit 3036131 derives an initial value (initial motion source vector) MSV0 of a motion source vector MSV in order to derive the motion source vector MSV, the motion source vector MSV being a motion vector specifying a motion source block MSB, the motion source block MSB being a block on a motion source picture MSP that is a picture referring to motion information of the ATMVP and being a block for reference of the motion information.

### Second Derivation Unit

The second derivation unit 3036132 derives the motion source picture MSP from MSP candidates Pr which are configured with a reference picture of the initial motion source vector MSV0 derived by the first derivation unit 3036131 and the reference pictures in the reference lists for the target PU. The second derivation unit 3036132 acquires an AT reference vector CMV which is a motion vector belonging to the motion source block MSB, the motion source block MSB being a block on the derived motion source picture MSP and being a block specified by the motion source vector MSV, the motion source vector MSV being calculated by scaling the initial motion source vector MSV0.

### Third Derivation Unit

The third derivation unit 3036133 acquires a corresponding sub-block motion vector CSBMV which is a motion vector of a corresponding sub-block CSB on a motion source picture MSP associated through the motion source vector MSV with a target sub-block SB included in the target PU on a target picture Pc. The third derivation unit 3036133 derives a motion vector CSBMVScaled obtained by scaling the corresponding sub-block motion vector CSBMV for a reference picture RefP of the target PU. The third derivation unit 3036133 performs the above processing for each SB to derive the CSBMVScaled of each SB.

The merge candidate selection unit 30362 selects, as an inter-prediction parameter for the target PU, a merge candidate assigned with an index corresponding to the merge index merge_idx input from the inter-prediction parameter decoding controller 3031, among the merge candidates stored in the merge candidate storage unit 30363. The merge candidate selection unit 30362 stores the selected merge candidate in the prediction parameter memory 307 and outputs the candidate to the prediction image generation unit 308.

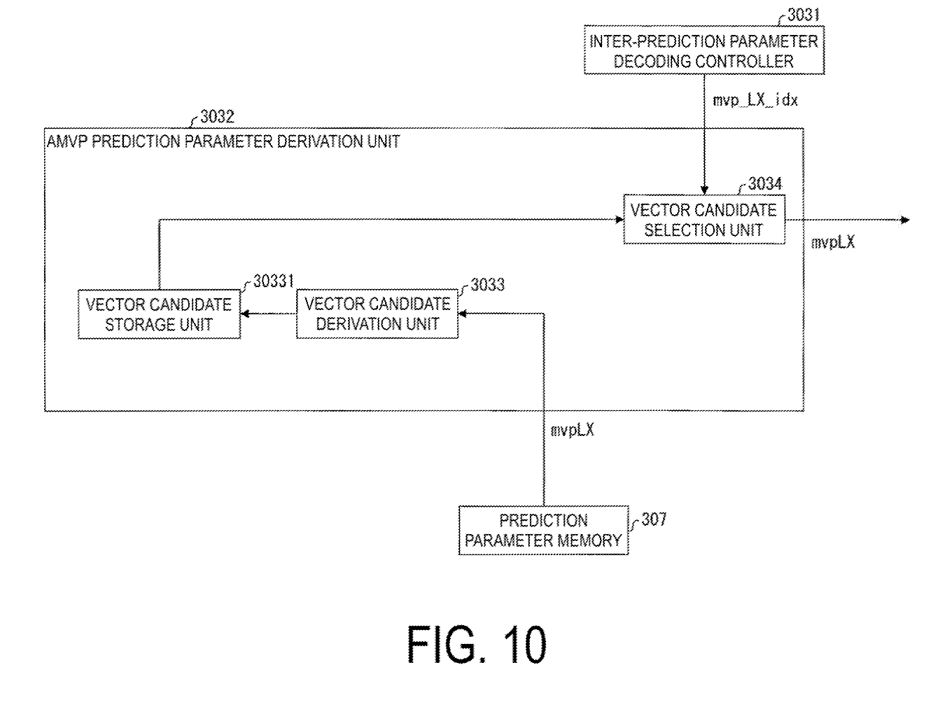

FIG. 10 is a schematic diagram illustrating a configuration of the AMVP prediction parameter derivation unit 3032 according to the present embodiment. The AMVP prediction parameter derivation unit 3032 includes a vector candidate derivation unit 3033, a vector candidate selection unit 3034, and a vector candidate storage unit 30331. The vector candidate derivation unit 3033 reads out the vector stored in the prediction parameter memory 307 as a prediction vector candidate, based on the reference picture index refIdx. The read out vector is a vector related to each of the PUs in a predefined range from the decoding target PU (e.g., all or some of PUs in contact with a lower left end, upper left end, and upper right end of the decoding target PU).

The vector candidate selection unit 3034 selects, as a prediction vector mvpLX, a vector candidate indicated by the prediction vector index mvp_LX_idx input from the inter-prediction parameter decoding controller 3031, among the vector candidates read out by the vector candidate derivation unit 3033. The vector candidate selection unit 3034 outputs the selected prediction vector mvpLX to the addition unit 3035.

The vector candidate selection unit 3034 may be configured to perform a round process (a process to round components of a vector to a value having a prescribed precision) on the selected prediction vector mvpLX.

The vector candidate storage unit 30331 stores therein the vector candidate input from the vector candidate derivation unit 3033. The vector candidate is configured to include the prediction vector mvpLX. The vector candidate stored in the vector candidate storage unit 30331 is assigned with an index according to a prescribed rule.

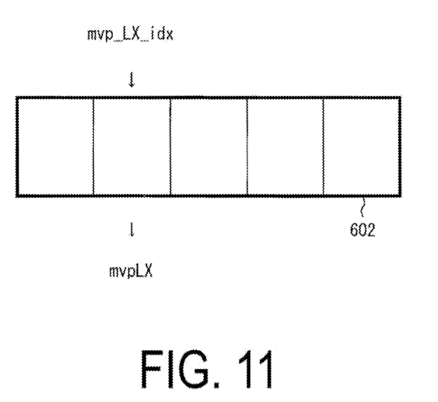

FIG. 11 is a conceptual diagram illustrating an example of the vector candidate. A prediction vector list 602 illustrated in FIG. 11 is a list constituted by multiple vector candidates derived by the vector candidate derivation unit 3033. In the prediction vector list 602, each of five rectangles horizontally aligned represents a prediction vector. A downward arrow immediately under “mvp_LX_idx” located at the second rectangle from the left end, and mvpLX under the arrow indicate that the prediction vector index mvp_LX_idx is an index referring to the vector mvpLX in the prediction parameter memory 307.

The vector candidates are generated based on vectors related to PUs referred to by the vector candidate selection unit 3034. Each PU referred to by the vector candidate selection unit 3034 may be a PU on which the decoding processing is completed, the PU being in a predefined range from the decoding target PU (e.g., neighboring PU). The neighboring PU includes a PU spatially neighboring to the decoding target PU such as a left PU and an upper PU, and a block temporally neighboring to the decoding target PU such a region which includes the same location as the decoding target PU and is obtained from the prediction parameters for the PU different in a display time.

The addition unit 3035 adds the prediction vector mvpLX input from the AMVP prediction parameter derivation unit 3032 and the difference vector mvdLX input from the inter-prediction parameter decoding controller 3031 to compute a motion vector mvLX. The addition unit 3035 outputs the computed motion vector mvLX to the prediction image generation unit 308.

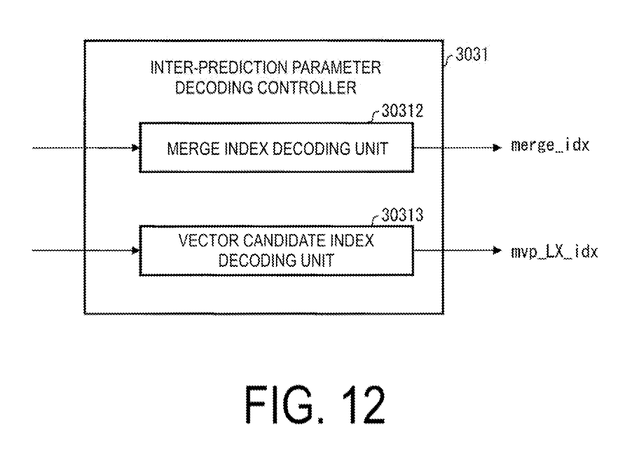

FIG. 12 is a schematic diagram illustrating a configuration of the inter-prediction parameter decoding controller 3031 according to the present embodiment. The inter-prediction parameter decoding controller 3031 is configured to include a merge index decoding unit 30312, a vector candidate index decoding unit 30313, and a not illustrated partition mode decoding unit, merge flag decoding unit, inter-prediction indicator decoding unit, reference picture index decoding unit, vector difference decoding unit, and the like. The partition mode decoding unit, the merge flag decoding unit, the merge index decoding unit, the inter-prediction indicator decoding unit, the reference picture index decoding unit, the vector candidate index decoding unit 30313, and the vector difference decoding unit decode respectively the partition mode part_mode, the merge flag merge_flag, the merge index merge_idx, the inter-prediction indicator inter_idc, the reference picture index refIdxLX, the prediction vector index mvp_LX_idx, and the difference vector mvdLX.

### Inter-Prediction Image Generation Unit 309

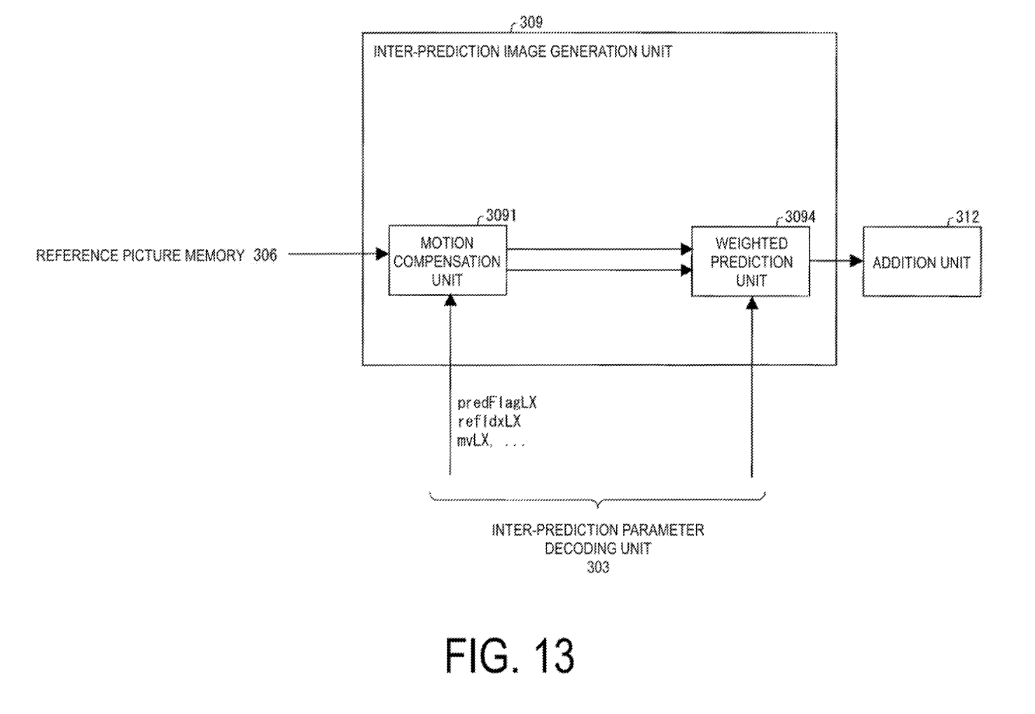

FIG. 13 is a schematic diagram illustrating a configuration of the inter-prediction image generation unit 309 according to the present embodiment. The inter-prediction image generation unit 309 is configured to include a motion compensation unit 3091 and a weighted prediction unit 3094.

### Motion Compensation

The motion compensation unit 3091 reads out from the reference picture memory 306 a block which is displaced by a motion vector mvLX from a starting point at a location of the decoding target PU in the reference picture specified by the reference picture index refIdxLX, based on the inter-prediction parameters input from the inter-prediction parameter decoding unit 303 (such as the prediction list utilization flag predFlagLX, the reference picture index refIdxLX, and the motion vector mvLX) to generate an interpolation image (a motion compensation image). Here, in a case that a precision of the motion vector mvLX is not an integer precision, a motion compensation image is generated by filtering called a motion compensation filter for generating a pixel at decimal position.

Hereinafter, an interpolation image of the PU derived based on the inter-prediction parameters is called a PU interpolation image, and an interpolation image derived based on the inter-prediction parameters for OBMC is called an OBMC interpolation image. In a case the OBMC processing is not performed, the PU interpolation image without change is the motion compensation image of the PU. In a case the OBMC processing is performed, the motion compensation image of the PU is derived from the PU interpolation image and the OBMC interpolation image.

### Weighted Prediction

The weighted prediction unit 3094 multiplies an input motion compensation image predSamplesLX by weight coefficients to generate a prediction image of the PU. The input motion compensation image predSamplesLX in the case of the residual prediction is an image on which the residual prediction is applied. In a case that one of reference list utilization flags (predFlagL0 or predFlagL1) is 1 (that is, in a case of the uni-prediction) and the weighted prediction is not used, processing by the following equation is performed to conform the input motion compensation image predSamplesLX (LX is L0 or L1) to the number of pixel bits bitDepth.

predSamples [x][y]=Clip3(0,(1<<bitDepth)−1,(predSamplesLX[x][y]+offset1)>>shift1)

where shift1=14−bitDepth, offset1=1<<(shift1−1). Clip3 (a, b, c) is a function which returns “a” in a case of c<a, “b” in a case of c>b, and “c” in other cases (where, a <=b).

In a case that both of the reference list utilization flags (predFlagL0 and predFlagL1) are 1 (that is, in a case of the hi-prediction) and the weighted prediction is not used, processing by the following equation is performed to average the input motion compensation images predSamplesL0 and predSamplesL1 to be conformed to the number of pixel bits.

predSamples [x][y]=Clip3(0,(1<<bitDepth)−1, (predSamplesL0[x][y]+predSamplesL1[x][y]offset2)>>shift2)

where shift2=15−bitDepth, offset2=1<<(shift2−1).

Furthermore, in a case of the uni-prediction and that the weighted prediction is performed, the weighted prediction unit 3094 derives a weighted prediction coefficient w0 and an offset o0 from the coded data and performs processing by the following equation.

predSamples[x][y]=Clip3 (0, <<bitDepth ((predSamplesLX[x][y]*w0+2̂(log 2WD−1))>>log 2WD)+o0)

where log 2WD represents a variable indicating a prescribed shift amount.

Further, in a case of the bi-prediction and that the weighted prediction is performed, the weighted prediction unit 3094 derives weighted prediction coefficients w0, w1, o0, and o1 from the coded data and performs processing by the following equation.

predSamples [x][y]=Clip3(0, (1<<bitDepth)−1, (predSamplesL0[x][y]*w0+predSamplesL1[x][y]*w1+((o0+o1+1)<<log 2WD)) >>(log 2WD+1))

### Motion Vector Decoding Processing

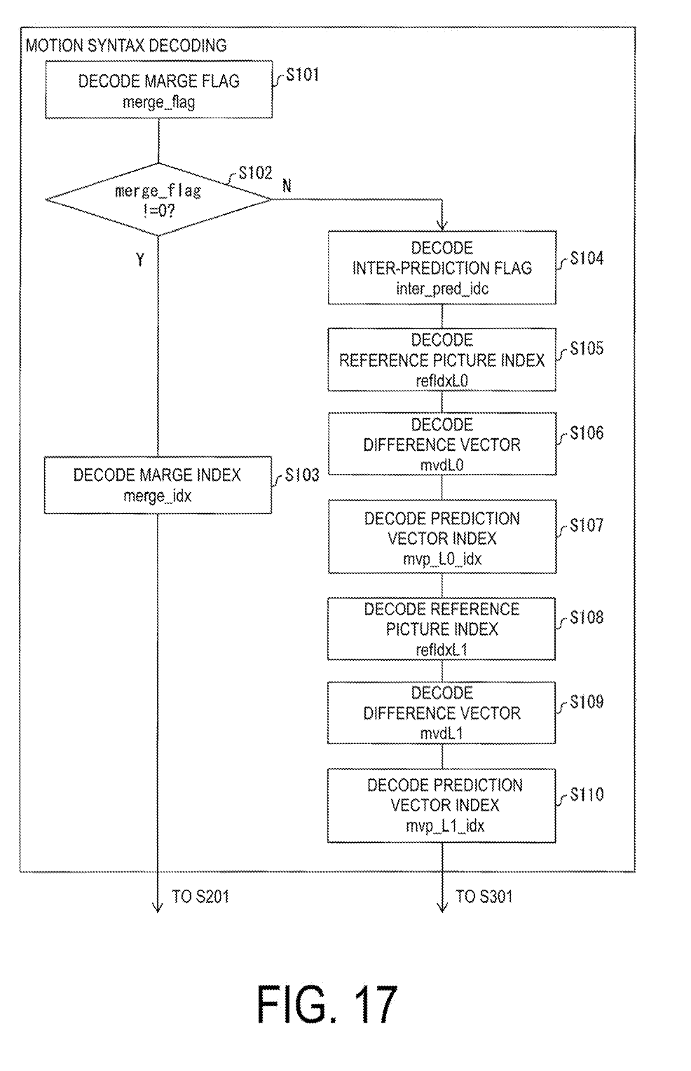

Hereinafter, a description is specifically given of the motion vector decoding processing according to the present embodiment with reference to FIG. 17.

As clearly seen from the above description, the motion vector decoding processing according to the present embodiment includes processing of decoding the syntax element associated with the inter-prediction (also referred to as motion syntax decoding processing) and processing of deriving the motion vector (motion vector derivation processing).

### Motion Syntax Decoding Processing

FIG. 17 is a flowchart illustrating a flow of inter-prediction syntax decoding processing which is performed by the inter-prediction parameter decoding controller 3031. In the following description in FIG. 17, each process is performed by the inter-prediction parameter decoding controller 3031 unless otherwise specifically described.
First, the merge flag merge_flag is decoded at step S101, and merge_flag!=0? (whether or not merge_flag equals to 0) is determined at step S102.

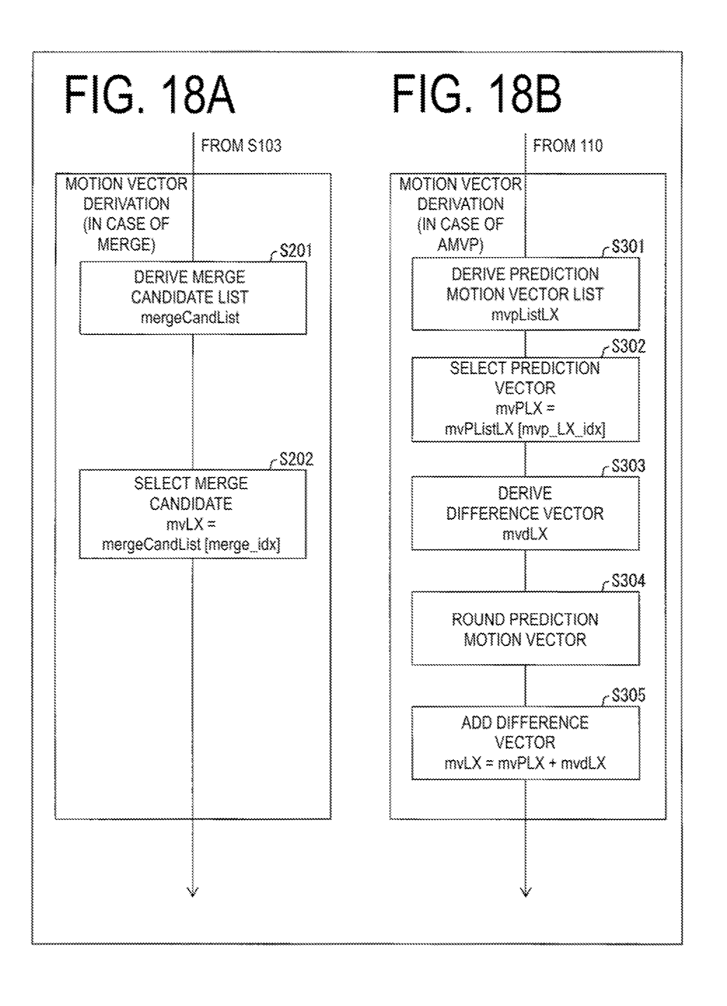

In a case that merge_flag!=0 is true (Y at S102), the marge index merge_idx is decoded at S103 and the process proceeds to the motion vector derivation processing in the merge mode (S201) (in FIG. 18A).

In a case that merge_flag!=0 is false (N at S102), the inter-prediction indicator inter_pred_idc is decoded at S104, the reference picture index refIdxL0 is decoded at S105, the syntax of the difference vector mvdL0 is decoded at S106, and the prediction vector index mvp_L0_idx is decoded at S107.

The reference picture index refIdxL1 is decoded at S108, the syntax of the difference vector mvdL1 is decoded at S109, and the prediction vector index mvp_L1_idx is decoded at S110, and the process proceeds to the motion vector derivation processing in the AMVP mode (S301) (in FIG. 18B).

In a case that the inter-prediction indicator inter_pred_idc is equal to 0, that is, indicates the L0 prediction (PRED_L0), the processes at S108 to S110 are not necessary. On the other hand, in a case that the inter-prediction indicator inter_pred_idc is equal to 1, that is, indicates the L1 prediction (PRED_L1), the processes at S105 to S107 are not necessary. In a case that the inter-prediction indicator inter pred idc is equal to 2, that is, indicates the bi-prediction (PRED_BI), steps at S105 to S110 are performed.

### Motion Vector Derivation Processing

Next, the motion vector derivation processing is described using FIGS. 18A and 18B.

FIGS. 18A and 18B are flowcharts illustrating a flow of the motion vector derivation processing which is performed by the inter-prediction parameter decoding unit 303 according to the present embodiment.

### Motion Vector Derivation Processing in Merge Prediction Mode

FIG. 18A is a flowchart illustrating a flow of the motion vector derivation processing in the merge prediction mode. As illustrated in FIG. 18A, the merge candidate derivation unit 30361 derives the merge candidate list mergeCandList at S201, and at S202 the merge candidate selection unit 30362 selects the merge candidate mvLX specified by the marge index merge_idx, based on the mergeCandList [merge_idx]. For example, the merge candidate is derived based on mvLX=mergeCandList [merge_idx].

### Merge Candidate Derivation Processing

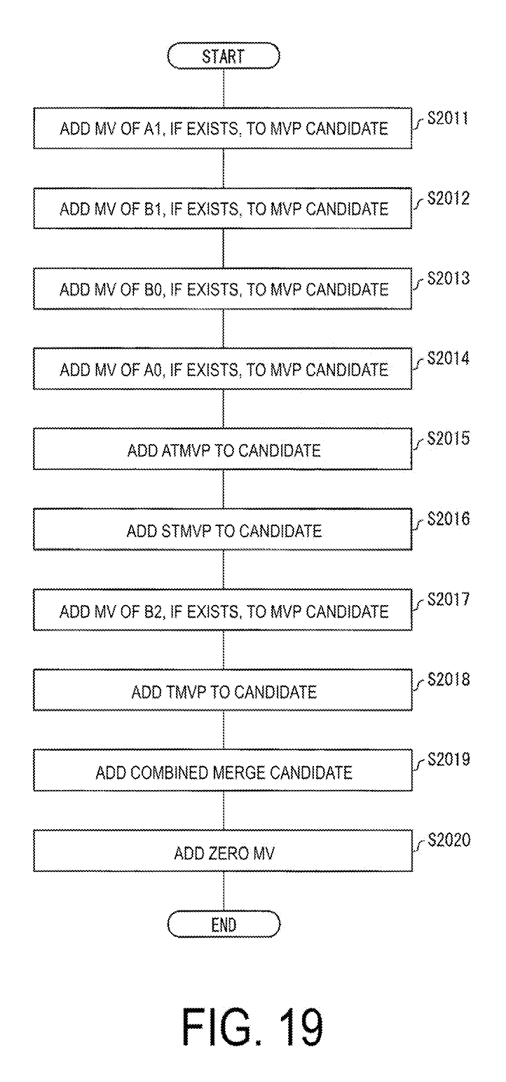

The merge candidate list derivation processing (at S201 described above) is described in detail with reference to FIG. 19. FIG. 19 is a flowchart illustrating a flow of the merge candidate derivation processing which is performed by the merge candidate derivation unit 30361 according to the present embodiment.

### Processing of Deriving Motion Vectors MV of PU A1, PU B1, PU B0, and PU A0

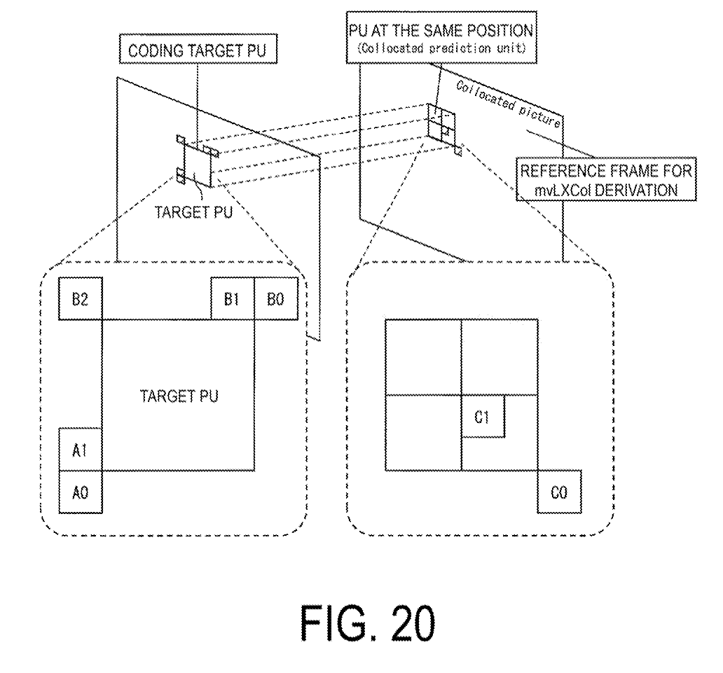

A description is given of the processing for deriving the merge candidate by the spatial merge candidate derivation unit 303611 in the merge candidate derivation unit 30361 with reference to FIG. 20. FIG. 20 is a conceptual diagram illustrating a block referred to in deriving a neighboring MV and a TMVP. The spatial merge candidate derivation unit 303611 identifies a PU neighboring to the target PU, the target PU being a PU on which the prediction processing is to be performed, to derive a motion vector MV of the identified PU.

To be more specific, first, at step S2011, in a case that among the PUs which share a lower left vertex of the target PU or include the vertex on sides thereof, the PU A1 that is a PU sharing a left side of the target PU satisfies all of conditions al to a4 described below, the spatial merge candidate derivation unit 303611 adds a motion vector MV of the PU A1 as the merge candidate to the merge candidate list.

Condition a1: The PU is a PU already processed.

Condition a2: The inter-prediction is to be applied to the PU.

Condition a3: The PU is not in the same motion compensation region (ME region) as the target PU.

Condition a4: The motion vector MV is different from the merge candidate already contained in the merge candidate list.

The ME region is a region obtained by dividing an image in a grid-like manner so that each region has a prescribed size, which is independent from a size of the PU.

Subsequently, at step S2012, in a case that among the PUs which share an upper right vertex of the target PU or include the vertex on sides thereof, the PU B1 that is a PU sharing an upper side of the target PU satisfies all of the above-described conditions al to a4, the spatial merge candidate derivation unit 303611 adds a motion vector MV of the PU B1 as the merge candidate to the merge candidate list.

Furthermore, at step S2013, in a case that among the PUs which share the upper right vertex of the target PU, the PU B0 that is a PU sharing no side of the target PU satisfies all of the above-described conditions al to a4, the spatial merge candidate derivation unit 303611 adds a motion vector MV of the PU B0 as the merge candidate to the merge candidate list.

Furthermore, at step S2014, in a case that among the PUs Which share the lower left vertex of the target PU, the PU A0 that is a PU sharing no side of the target PU satisfies all of the above-described conditions al to a4, the spatial merge candidate derivation unit 303611 adds a motion vector MV of the PU A0 as the merge candidate to the merge candidate list.

### ATMVP Derivation Processing

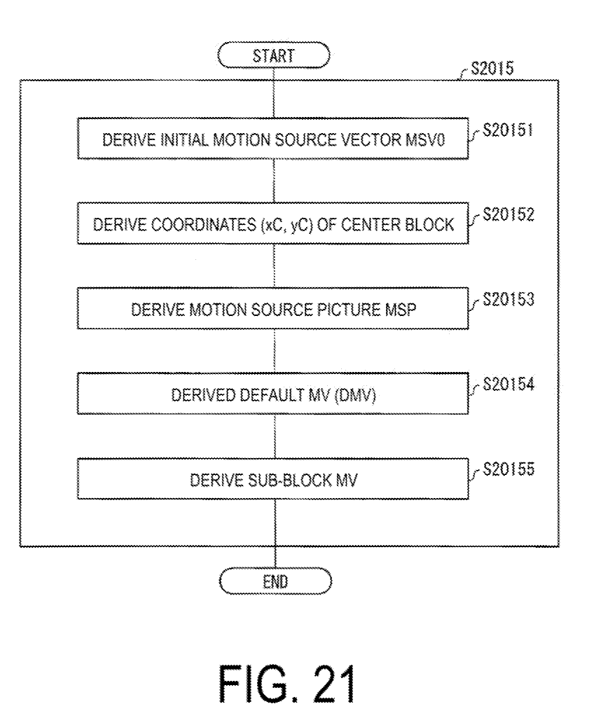

Subsequently, the ATMVP merge candidate derivation unit 303613 in the merge candidate derivation unit 30361 derives the ATMVP at step S2015 and adds the derived ATMVP as the merge candidate to the merge candidate list. A description is given of the processing for deriving the ATMVP by the ATMVP merge candidate derivation unit 303613 with reference to FIG. 21. FIG. 21 is a flowchart illustrating a flow of the ATMVP derivation processing which is performed by the ATMVP merge candidate derivation unit 303613 according to the present embodiment.

### Initial Motion Source Vector Derivation Processing

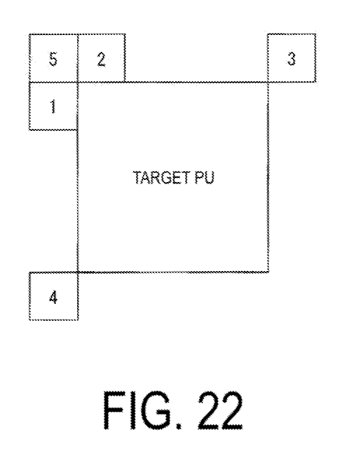

First, the first derivation unit 3036131 in the ATMVP merge candidate derivation unit 303613 derives the initial motion source vector MSV0 at step S20151. A description is given of the processing for deriving the initial motion source vector MSV0 by the first derivation unit 3036131 with reference to FIG. 22. FIG. 22 is a conceptual diagram illustrating a PU referred to in deriving the initial motion source vector MSV0.

The first derivation unit 3036131 searches for a PU satisfying conditions b1 and b2 described below, among the PUs neighboring to the target PU, in an order illustrated in FIG. 22.

Condition b1: The PU is available.

Condition b2: The inter-prediction is to be applied to the PU.

The specific order in which the first derivation unit 3036131 searches for the neighboring PU is as below:

(1) among the PUs sharing upper left vertex of the target PU, the PU sharing the left side of the target PU,

(2) among the PUs sharing the upper left vertex of the target PU, the PU sharing the upper side of the target PU,

(3) among the PUs sharing the upper right vertex of the target PU, the PU sharing no side of the target PU,

(4) among the PUs sharing the lower left vertex of the target PU, the PU sharing no side of the target PU, and

(5) among the PUs sharing the upper left vertex of the target PU, the PU sharing no side of the target PU. Then, the first derivation unit 3036131 configures the firstly found motion vector MV as the initial motion source vector MSV0.

In a case that a slice type of a slice containing the target PU is the B slice, the first derivation unit 3036131 searches for the motion vector MV which is valid (or has information of the reference image) for both the L0 list and the list of each neighboring PU. Then, the first derivation unit 3036131 configures the motion vector MV found in an earlier stage as the initial motion source vector MSV0.

A pseudo-code A1 for the processing of deriving the initial motion source vector MSV0 by the first derivation unit 3036131 is as below.

Pseudo-code A1

/* C: target PU */
getInitialMotionSourceVector(C) {
MSV0 = ZeroMV;
RefLists = getRefListsForSrarchingForMSV0(C);
for N in neighboring blocks of C {
if (N does not exist) next;
if (N is not an inter prediction block) next;
for LX in RefLists {
if (MV for LX of N is invalid) next;
MSV0 = MV for LX of N;
RefMSV0 = Reference picture of MSV0
return MSV0;
}
}
return MSV0;
}

In the above pseudo-code A1, first, the first derivation unit 3036131 initializes the initial motion source vector MSV0 to acquire the reference list. The processing of acquiring the reference list by the first derivation unit 3036131 is described later in detail referring to another drawing.

Subsequently, the first derivation unit 3036131 searches the neighboring PUs for the PU satisfying the above-described conditions b1 and b2 in an order illustrated in FIG. 22. Then, the first derivation unit 3036131 searches for a motion vector which is valid, for the neighboring PU satisfying the above-described conditions b1 and b2 in an order of the acquired reference list, and configures the firstly found motion vector MV as the initial motion source vector MSV0. A reference picture specified by MSV0 at this time is configured as RefMSV0.

### Reference List Acquisition Processing

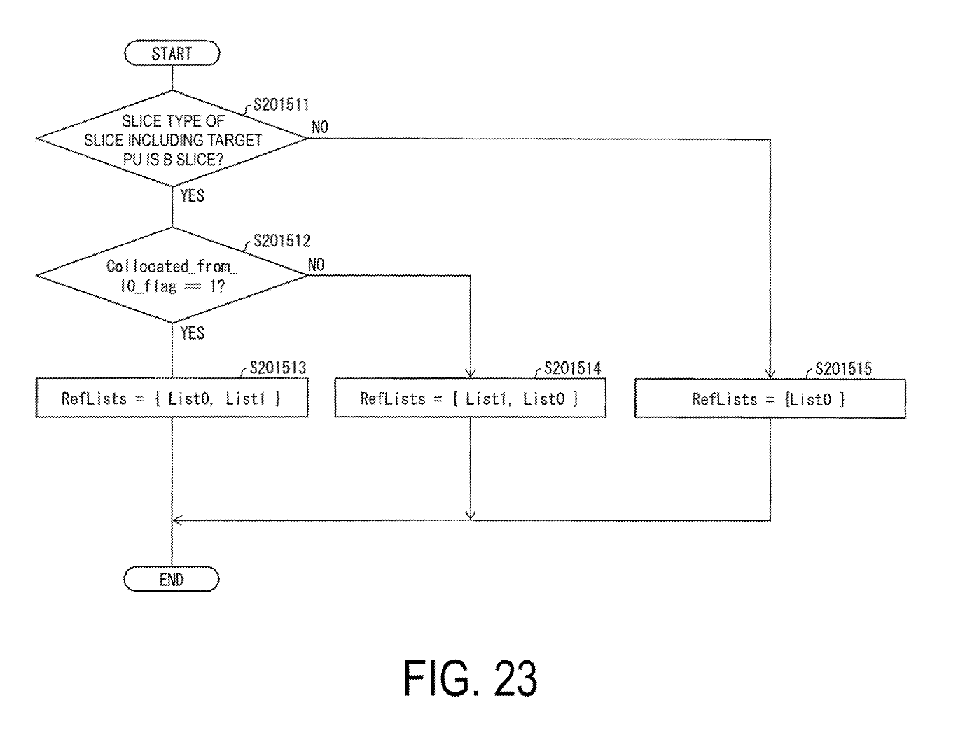

Subsequently, a description is given of the processing for acquiring the reference list by the first derivation unit 3036131 using FIG. 23.

The first derivation unit 3036131 determines at step S201511 whether or not the slice type of the slice including the target PU is the B slice.

In a case that the slice type of the slice including the target PU is the B slice (at S201511: Yes), the first derivation unit 3036131 determines at step S201512 whether or not collocated from_10_flag is 1 Which is coded in the slice header and indicates which of the L0 list and the L1 list is first selected.

In a case that collocated_from_10_flag is 1 (at S201512: Yes), the first derivation unit 3036131 configures the reference list RefLists as RefLists={List0, List1} so that a list search order is first the L0 list and then the L1 list.

On the other hand, in a case that collocated_from_10_flag is not 1 (at S201512: No), the first derivation unit 3036131 configures the reference list RefLists as RefLists={List1, List0} so that the list search order is first the L1 list and then the L0 list.

In a case that at step S201511 described above, the slice type of the slice including the target PU is not the B slice (at S201511: No), the first derivation unit 3036131 configures the reference list RefLists as RefLists={List0}.

A pseudo-code A2 for the processing of acquiring the reference list by the first derivation unit is as below.

Pseudo-code A2

/* C: target PU */
getRefListsForSearchingForMSV0(C) {
if (C is in B_slice) {
if (collocated_from_l0_flag == 1) {
RefLists = {List0, List1};
} else {
RefLists = {List1, List0};
}
} else {
RefLists = {List0};
}
return RefLists;
}

### Center Block Coordinates Derivation Processing

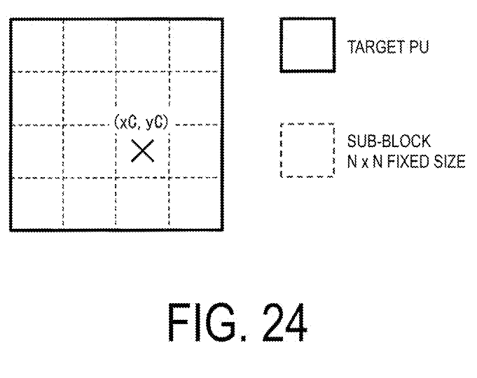

Subsequently, in the flowchart illustrate in FIG. 21, the second derivation unit 3036132 in the ATMVP merge candidate derivation unit 303613 derives coordinates (xC, yC) of a center block of the target PU at step S20152. The coordinates of the center block of the target PU are illustrated in FIG. 24. FIG. 24 is a conceptual diagram illustrating the center block in a case that the target PU is partitioned into 4×4 sub-blocks. As illustrated in FIG. 24, the second derivation unit 3036132 configures center coordinates of a sub-block at the lower right of the center of the target PU as the coordinates of the center block.

A pseudo-code A3 for the processing of deriving the coordinates (xC, yC) of the center block of the target PU by the second derivation unit 3036132 is as below.

Pseudo-code A3

/* C: target PU */
getCenterCoordinates(C) {
N = size of sub block;
wC = width of C;
hC = height of C;
(xPb, yPb) = top-left coordinates of C;
nSubBw = wC/N;
nSubBh = hC/N;
xC = xPb + N * nSubBw/2 + N/2;
yC = yPb + N * nSubBh/2 + N/2;
return(xC, yC);
}

In the above pseudo-code A3, N represents a size of the sub-block in units of the numbers of horizontal and vertical pixels, wC and hC represent respectively horizontal and vertical sizes of the target PU in units of the numbers of pixels, and nSubBw and nSubBh represent respectively the numbers of horizontal and vertical sub-blocks in the target PU.

### Motion Source Picture Derivation Processing

Subsequently, in the flowchart illustrate in FIG. 21, the second derivation unit 3036132 derives the motion source picture MSP at step S20153. First, the second derivation unit 3036132 creates an ordered list which contains, as elements, the reference picture specified by the initial motion source vector MSV0 and the reference picture of the target PU. The reference pictures contained in this list are referred to as MSP candidates Pr. Then, the second derivation unit 3036132 performs the following processing on each MSP candidate Pr.

First, the second derivation unit 3036132 scales the initial motion source vector MSV0 in conformity to a distance between the picture order counts POC of the picture Pc and the MSP candidate Pr, and configures the scaled vector as the motion source vector MSV.

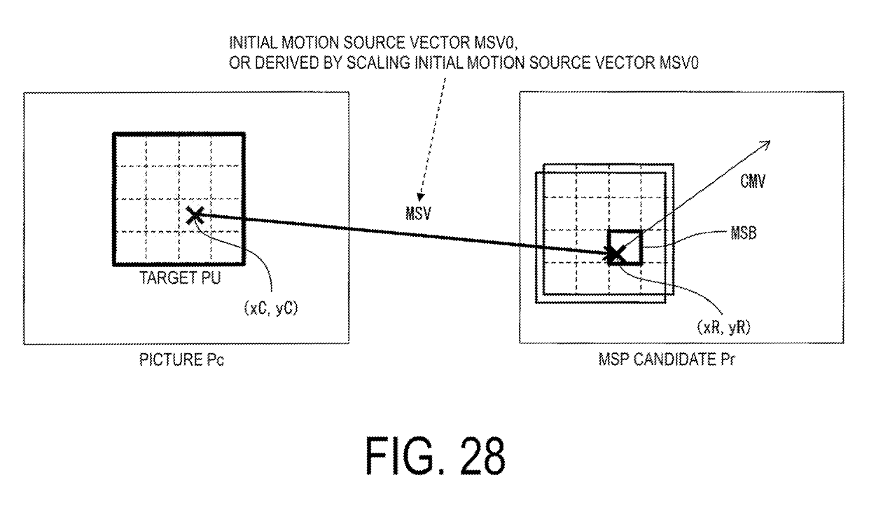

Subsequently, the second derivation unit 3036132 configures, as the motion source block MSB, a block containing coordinates (xR, yR) of a point on the MSP candidate Pr, the point being associated through the motion source vector MSV with the coordinates (xC, yC) of the center block of the target PU. The motion vector and reference picture of the motion source block MSB are configured respectively as the motion vector and reference picture of the PU containing the coordinates (xR, yR) as illustrated in FIG. 28.

Next, the third derivation unit 3036133 determines whether or not the motion source block MSB satisfies all of conditions c1 to c3 described below.

Condition c1: The motion source block MSB exists in a screen.

Condition c2: The inter-prediction is to be applied to the motion source block MSB.

Condition c3: The motion source block MSB has a valid motion vector MV.

In a case that the motion source block MSB satisfies all of the above conditions c1 to c3, the second derivation unit 3036132 acquires the motion vector MV of the motion source block MSB to configure the acquired motion vector MV as the AT reference vector CMV as illustrated in FIG. 28. The second derivation unit 3036132 configures the MSP candidate Pr including the motion source block MSB as the motion source picture MSP. Examples of a case that the condition c3 is not satisfied include a case that information of the reference picture used by the MSP candidate Pr does not already exist. in this case, the second derivation unit 3036132 cannot calculate the distance between the picture order counts POC of the picture Pc and the MSP candidate Pr, and therefore, cannot scale the AT reference vector CMV in the later processing. The second derivation unit 3036132, in a case of finding the MSB which satisfies all of the conditions c1 to c3, acquires the AT reference vectors CMV of L0 and L1 and terminates the process.

On the other hand, in a case that the motion source block MSB does not satisfy any of the conditions c1to c3, the second derivation unit 3036132 discards the motion source block MSB, and repeats the process described above on the next reference picture candidate Pr in the ordered list.

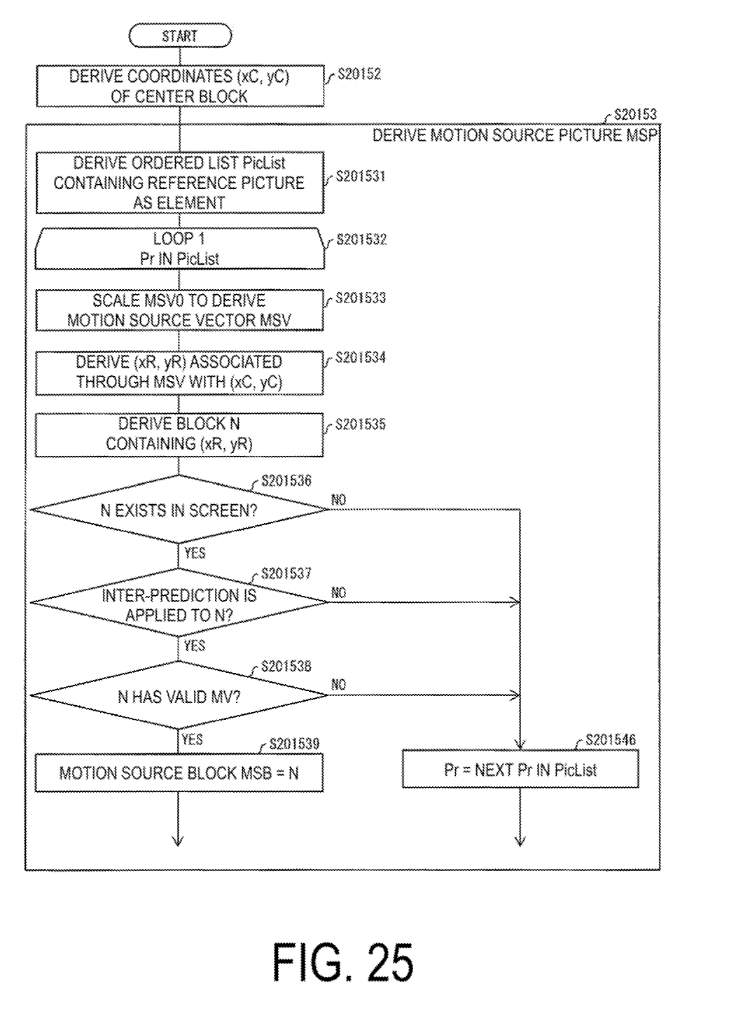

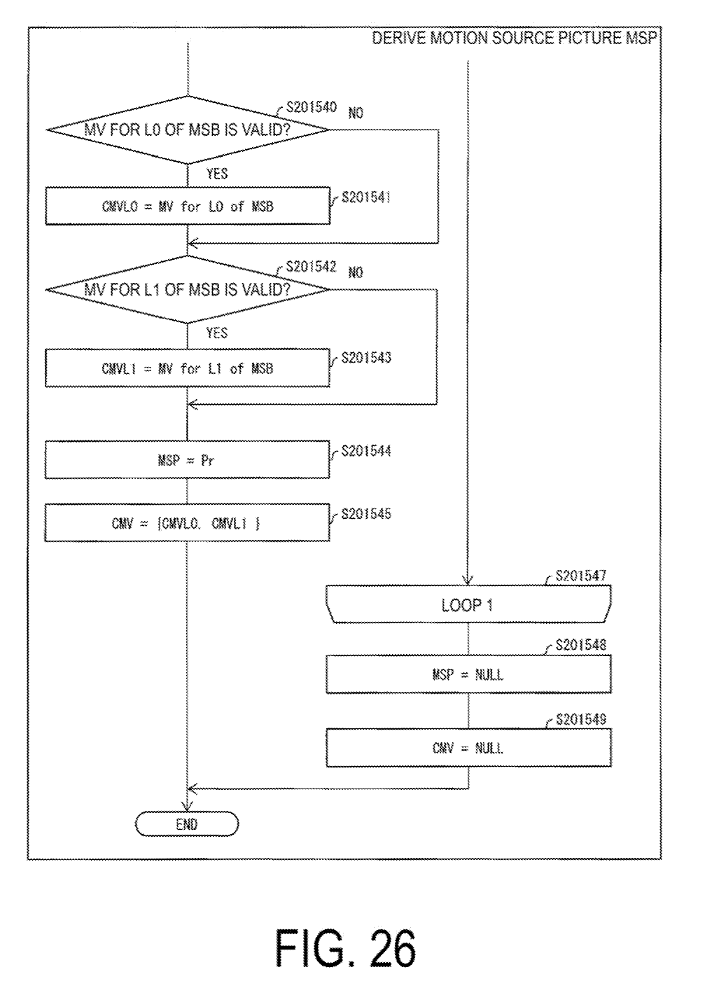

A description is given in detail of the processing of deriving the motion source picture MSP by the second derivation unit 3036132 with reference to FIG. 25 and FIG. 26.

FIG. 25 and FIG. 26 are flowcharts illustrating a flow of the motion source picture MSP derivation processing which is performed by the second derivation unit 3036132 according to the present embodiment.

The second derivation unit 3036132, after deriving the coordinates (xC, yC) of the center block of the target PU at step S20152 described above, derives the ordered list PicList containing the reference pictures as its elements. The processing of deriving the list PicList by the second derivation unit 3036132 is described later in detail referring to another drawing. Subsequently, the second derivation unit 3036132 selects the MSP candidate Pr first specified by the list PicList at step S201532. Then, the second derivation unit 3036132 starts loop 1 which is performed until no MSP candidates Pr contained in the list PicList remains.

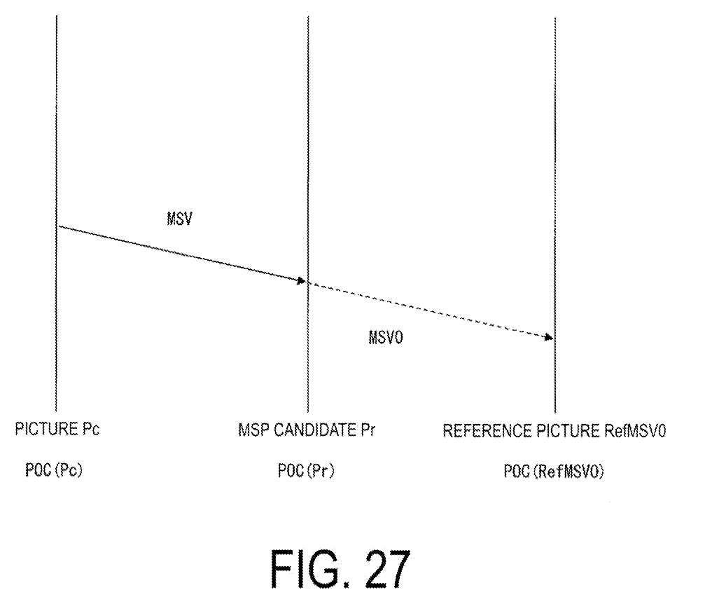

Next, the second derivation unit 3036132, at step S201533, scales the initial motion source vector MSV0 in conformity to a distance between the picture order counts POC of the picture Pc and the MSP candidate Pr, and configures the scaled vector as the motion source vector MSV. A description is given of the initial motion source vector MSV0 scale processing with reference to FIG. 27.

FIG. 27 is a conceptual diagram illustrating the initial motion source vector MSV0 scale processing which is performed by the second derivation unit 3036132 according to the present embodiment. As illustrated in FIG. 27, the second derivation unit 3036132 scales the initial motion source vector MSV0 in conformity of distances between a picture order count POC (Pc) that is a picture order count POC of the picture Pc, a picture order count POC (Pr) that is a picture order count POC of the MSP candidate Pr, and a picture order count POC (RefMSV0) that is a picture order count POC of the reference picture RefMSV0 of the initial motion source vector MSV0, and configures the scaled vector as the motion source vector MSV.

A pseudo-code A4 for the processing of scaling the initial motion source vector MSV0 by the second derivation unit 3036132 is as below,

Pseudo-code A4

/* Pc: target picture, Pr: picture of MSP candidate,
MSV0: initial motion source vector */
getScaledMSV0 (Pc, Pr, MSV0) {
MSV = MSV0 * (POC(Pc) − POC(Pr))/(POC(Pc) −
POC(RefMSV0));
return MSV;
}

Next, the second derivation unit 3036132 derives a point (xR, yR) on the MSP candidate Pr, the point being associated through the motion source vector MSV with the coordinates (xC, yC) of the center block at step S201534. The second derivation unit 3036132 derives a block N containing the point (xR, yR) at step S201535.

Subsequently, the second derivation unit 3036132 determines at step S201536 whether or not the block N exists in a screen,

In a case that the block N exists (at step S201536: Yes), the second derivation unit 3036132 determines at step S201537 whether or not the inter-prediction is applied to the block N.

In a case that the inter-prediction is applied to the block N (at step S201537: Yes), the second derivation unit 3036132 determines at step S201538 whether or not the block N has a valid motion vector MV.

In a case that the block N has a valid motion vector MV (at step S201538: Yes), the second derivation unit 3036132 configures the block N as the motion source block MSB at step S201539.

Next, the second derivation unit 3036132 determines at step S201540 whether or not the motion vector MV for the L0 list of the motion source block MSB is valid.

In a case that the motion vector MV for the L0 list of the motion source block MSB is valid (at step S201540: Yes), the second derivation unit 3036132 configures the motion vector MV for the L0 list of the motion source block MSB as an AT reference vector CMVL0 at step S201541.

Next, the second derivation unit 3036132 determines at step S201542 whether or not the motion vector MV for the L1 list of the motion source block MSB is valid.

In a case that the motion vector MV for the L1 list of the motion source block MSB is valid (at step S201542: Yes), the second derivation unit 3036132 configures the motion vector MV for the L1 list of the motion source block MSB as an AT reference vector CMVL1 at step S201543.

Furthermore, the second derivation unit 3036132 configures the selected MSP candidate Pr as the motion source picture MSP at step S201544. The second derivation unit 3036132 configures the AT reference vectors CMVL0 and CMVL1 as the AT reference vector CMV at step S201545. Then, the second derivation unit 3036132 terminates the processing of deriving the motion source picture MSP.

In a case that the block N does not exist in the screen (at step S201536: No), in a case that the inter-prediction is not applied to the block N (at step S201537: No), or in a case that the block N does not have a valid motion vector MV (at step S201538: No), the second derivation unit 3036132 selects the MSP candidate Pr specified next by the list PicList at step S201546. Then, the second derivation unit 3036132 again performs the process at step S201533.

In a case that the second derivation unit 3036132 searches all of the MSP candidates Pr contained in the list PicList with the motion source picture MSP not being fixed, the second derivation unit 3036132 terminates at step S201547 loop 1 started at step S201532. Then, the second derivation unit 3036132 configures the motion source picture MSP to be NULL at step S201548. The second derivation unit 3036132 configures the AT reference vector CMV to be NULL at step S201549.

A pseudo-code A5 for the processing of deriving the motion source picture MSP by the second derivation unit 3036132 is as below.

Pseudo-code A5

/* C: target PU, MSV0: initial motion source vector */
getMotionSourcePicture(C, MSV0) {
(xC, yC) = getCenterCoordinates(C);
PicList = getPicsForSearchingForMSP(C, MSV0);
for Pr in PicList {
MSV = getScaledMSV0(Pc, Pr, MSV0);
(xR, yR) = (xC, yC) + MSV;
N = a block that contains (xR, yR) on Pr;
if (N does not exist) next;
if (N is not an inter prediction block) next;
if (N does not have a valid MV) next;
MSB = N;
if (MV for L0 of MSB is valid) {
CMVL0 = MV for L0 of MSB;
}
if (MV for L1 of MSB is valid) {
CMVL1 = MV for L1 of MSB;
}
MSP = Pr;
CMV = {CMVL0, CMVL1};
return MSP, CMV;
}
return null, null;
}

FIG. 28 is a conceptual diagram illustrating the AT reference vector CMV. As illustrated in FIG. 28, acquired as the AT reference vector CMV is the motion vector MV at the point (xR, yR) which is associated, through the motion source vector MSV obtained by scaling the initial motion source vector MSV0, with the coordinates (xC, yC) of the center block of the target PU.

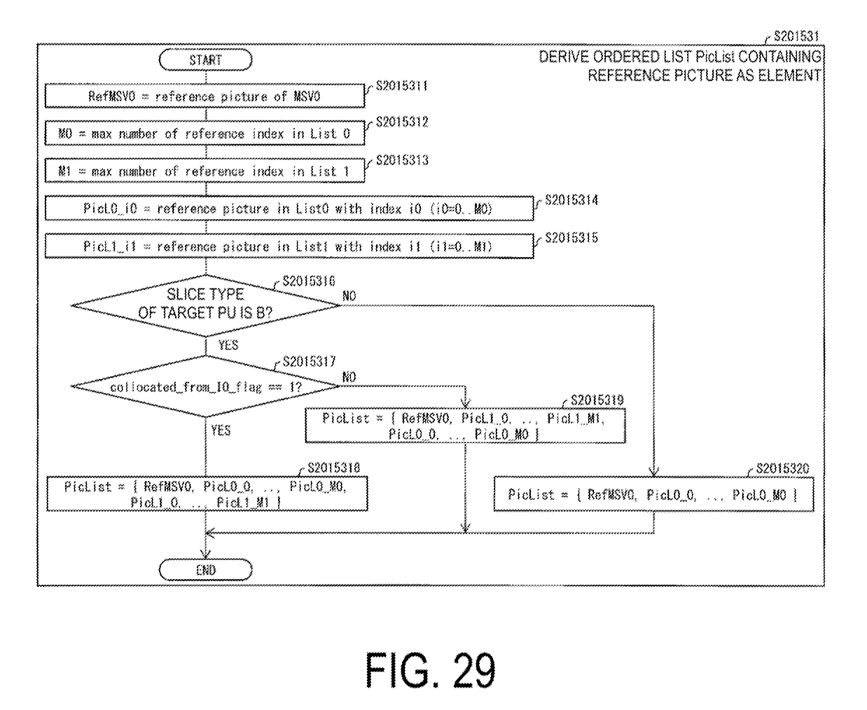

Processing of Deriving Ordered List Piclist Containing Reference Pictures as Elements FIG. 29 is a flowchart illustrating a flow of the processing of deriving the ordered list PicList containing the reference pictures, as elements, each of which is a search target in acquiring the motion source picture MSP according to the present embodiment, the processing being performed by the second derivation unit 3036132. The processing of deriving the list PicList by the second derivation unit 3036132 is described with reference to FIG. 29.

First, the second derivation unit 3036132 configures the reference picture of the initial motion source vector MSV0 as RefMSV0 at step S2015311. The second derivation unit 3036132 configures a maximum value of the reference index in the L0 list as M0 at step S2015312. The second derivation unit 3036132 configures a maximum value of the reference index in the L1 list as M1 at step S2015313. The second derivation unit 3036132 configures the reference picture in the L0 list having an index i0 (i0=0, . . . , M0) as PicL0_i0 at step S2015314. The second derivation unit 3036132 configures the reference picture in the L1 list having an index i1 (i1=0, . . . , M1) as PicL1_i1 at step S2015315.

Next, the second derivation unit 3036132 determines at step S2015316 whether or not the slice type of the slice including the target PU is the B

In a case that the slice type of the slice including the target PU is the B slice (at step S2015316: Yes), the second derivation unit 3036132 determines at step S2015317 whether or not collocated_from_10_flag is 1.

In a case that collocated from 10 flag is 1 (at step S2015317: Yes), the second derivation unit 3036132 derives the list PicList in which an order of the reference pictures is RefMSV0, PicL0_0, . . . , PicL0_M0, PicL1_0, . . . , and PicL1_M1 at step S2015318.

On the other hand, in a case that collocated_from_10_flag is not 1 (at step S2015317: No), the second derivation unit 3036132 derives the list PicList in which an order of the reference pictures is RefMSV0, PicL1_0, . . . , PicL1_M1, PicL0_0, . . . , and PicL0_M0 at step S2015319.

In a case that the slice type of the slice including the target PU is not the B slice (at step S2015316: No), the second derivation unit 3036132 derives the list PicList in which an order of the reference pictures is RefMSV0, PicL0_0, . . . , and PicL0_M0 at step S2015320.

A pseudo-code A6 for the processing of deriving the ordered list PicList containing the reference pictures as elements by the second derivation unit 3036132 is as below.

Pseudo-code A6

/* C: target PU, MSV0: initial motion source vector */
getPicsForSearchingForMSP(C, MSV0) {
RefMSV0 = reference picture of MSV0;
M0 = max number of reference index in List 0;
M1 = max number of reference index in List 1;
PicL0_i0 = reference picture in List0 with index i0
(i0=0..M0);
PicL1_i1 = reference picture in List1 with index i1
(i1=0..M1);
if (C is in B_slice) {
if (collocated_from_l0_flag == 1) {
PicList = {RefMSV0, PicL0_0),.., PicL0_M0, PicL1_0,..,
PicL1_M1};
} else {
PicList = {RefMSV0, PicL1_0,.., PicL1_M1, PicL0_0,..,
PicL0_M0};
}
} else {
PicList = {RefMSV0, PicL0_0,.., PicL0_M0};
}
Return PicList;
}

### Default Motion Vector Derivation Processing

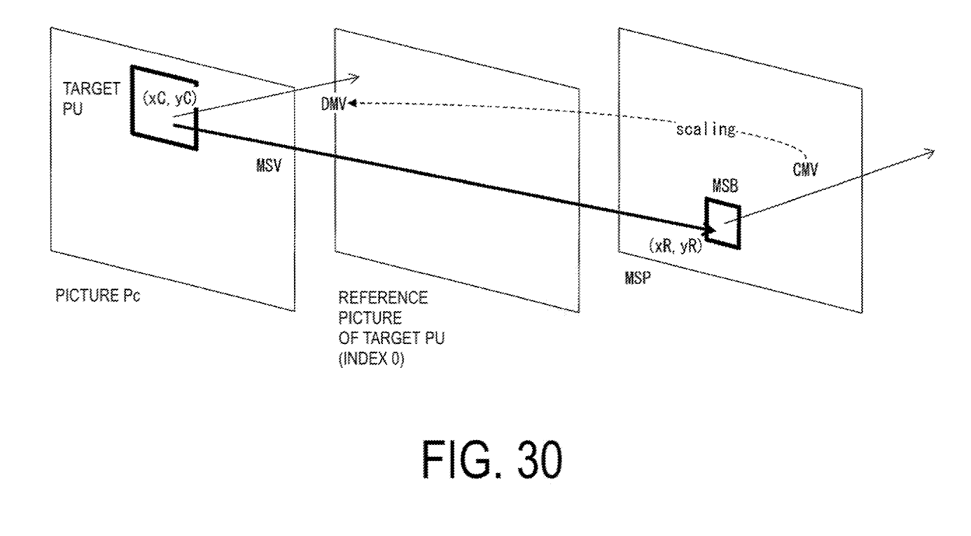

Subsequently, in the flowchart illustrate in FIG. 21, the second derivation unit 3036132 derives a default motion vector DMV at step S20154. A description is given of the default motion vector DMV with reference to FIG. 30.

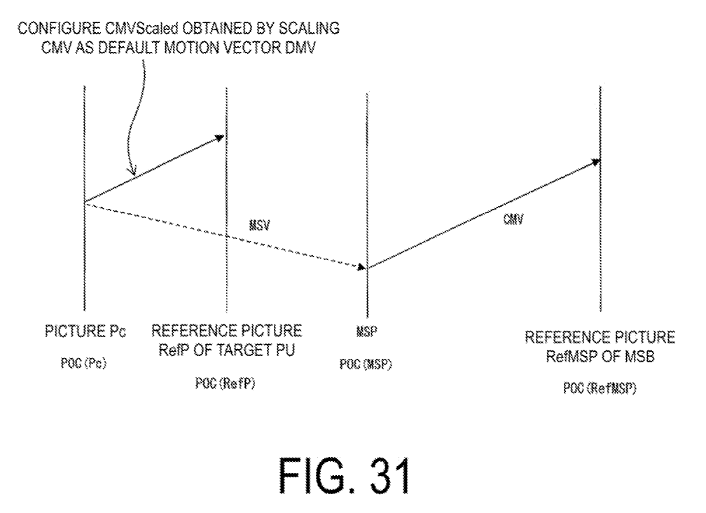

FIG. 30 is a conceptual diagram illustrating default motion vector derivation processing which is performed by the second derivation unit 3036132 according to the present embodiment. As described above, the second derivation unit 3036132 configures the motion vector MV of the motion source block MSB on the motion source picture MSP as the AT reference vector CMV. Then, the second derivation unit 3036132 scales the AT reference vector CMV in conformity to the picture having the reference picture index of 0 of the target PU and configures the scaled vector as a default motion vector DMV of the ATMVP. A description is given of corresponding motion vector CMV scale processing with reference to FIG. 31.

FIG. 31 is a conceptual diagram illustrating the default motion vector derivation processing which is performed by the second derivation unit 3036132 according to the present embodiment. As illustrated in FIG. 31, the second derivation unit 3036132 scales the corresponding motion vector CMV in conformity to a distance from a picture order count POC (MSP) to a picture order count POC (RefMSP) and a distance from a picture order count POC (Pc) to a picture order count POC (Ref?), and configures the scaled vector CMVScaled as the default motion vector DMV, the POC (MSP) being a picture order count POC of the motion source picture MSP, the POC (RefMSP) being a picture order count POC of the reference picture RefMSP of the AT reference vector CMV, the POC (Pc) being a picture order count POC of the picture Pc, and the POC (RefP) being a picture order count POC of the reference picture RefP of the target PU.

A pseudo-code A7 for the processing of deriving the default motion vector DMV by the second derivation unit 3036132 is as below.

Pseudo-code A7

/* Pc: target picture, Pref: reference picture having reference picture
index 0 of PU,
MSP: motion source picture, CMV: corresponding motion vector */
getScaledCMV (Pc, Pref, MSP, CMV) {
CMVScaled =
CMV * (POC(Pc) − POC(RefP))/(POC(MSP) − POC(RefMSP));
return CMVScaled;
}

### Sub-Block MV Derivation Processing

Subsequently, in the flowchart illustrate in FIG. 21, the third derivation unit 3036133 derives at step S20155 the corresponding sub-block motion vector CSBMV which is a motion vector of the corresponding sub-block CSB, the corresponding sub-block CSB being the sub-block on the motion source picture MSP and being the sub-block associated with the target sub-block SB. Then, the third derivation unit 3036133 derives the vector CSBMVScaled obtained by scaling the corresponding sub-block motion vector CSBMV for each of the sub-blocks of the target PU, and stores the derived vector CSBMVScale as the ATMVP for each sub-block. The CSBMVScaled is derived for each sub-block, while the default motion vector DMV is added as a representative value of the merge candidate in accordance with the ATMVP to the merge candidate list.

The third derivation unit 3036133 in a case of being incapable of deriving the corresponding sub-block motion vector CSBMV, may configure the default motion vector DMV as the merge candidate instead of the corresponding sub-block motion vector CSBMV.

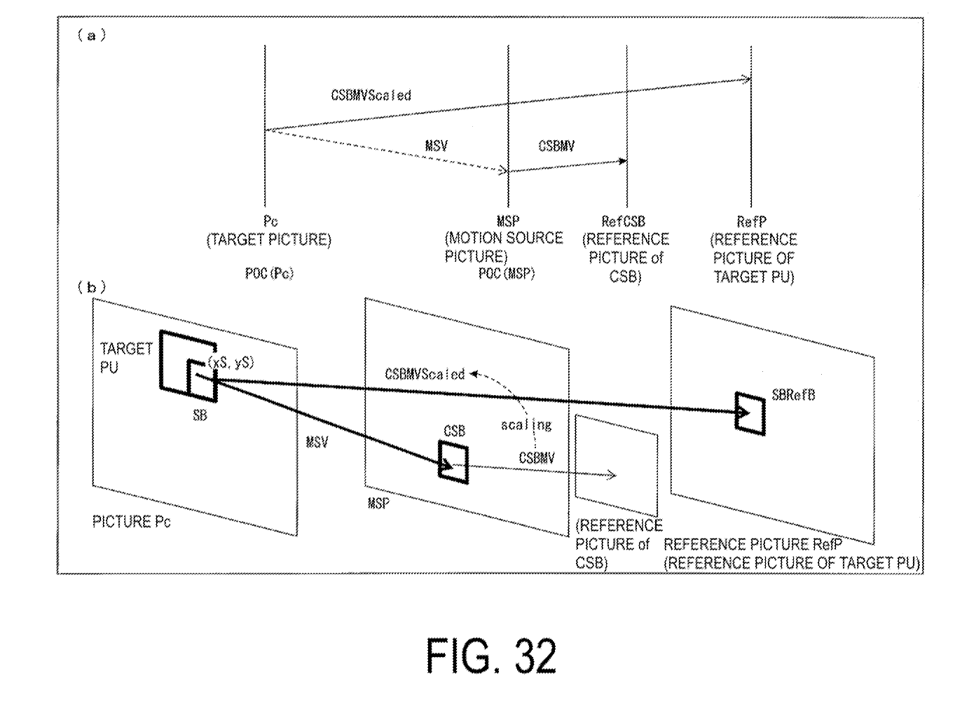

In the case that the slice type of the slice including the target PU is the B slice, the third derivation unit 3036133 derives two corresponding sub-block motion vectors CSBMV (CSBMVL0 and CSBMVL1) corresponding to the L0 list and the L1 list. A description is given of the corresponding sub-block motion vector CSBMV scale processing with reference to FIGS. 32A and 32B.

FIGS. 32A and 32B are conceptual diagrams illustrating the corresponding sub-block motion vector CSBMV scale processing which is performed by the third derivation unit 3036133 according to the present embodiment. As illustrated in FIG. 32B, the third derivation unit 3036133 identifies the corresponding sub-block CSB which is a corresponding sub-block associated through the motion source vector MSV with coordinates (xS, yS) of the target sub-block SB of the target PU and exists on the motion source picture MSP. Then, the third derivation unit 3036133 derives the corresponding sub-block motion vector CSBMV which is a motion vector in the corresponding sub-block CSB. The third derivation unit 3036133 derives CSBMVScaled obtained by scaling the corresponding sub-block motion vector CSBMV in conformity to the reference picture of the target PU RefP.

FIG. 32A is a conceptual diagram illustrating the CSBMVScaled derivation processing which is performed by the third derivation unit 3036133 according to the present embodiment. As illustrated in FIG. 32A, the third derivation unit 3036133 scales the corresponding sub-block motion vector CSBMV in conformity to a distance from a picture order count POC (MSP) to a picture order count POC (RefCSB) and a distance from a picture order count POC (Pc) to a picture order count POC (RefP) to derive the CSBMVScaled, the POC (MSP) being a picture order count POC of the motion source picture. MSP, the POC (RefCSB) being a picture order count POC of a reference picture RefCSB of the CSBMV, the POC (Pc) being a picture order count POC of the picture Pc, and the POC (RefP) being a picture order count POC of the reference picture RefP of the target PU.

In this way, the ATMVP merge candidate derivation unit 303613 in the merge candidate derivation unit 30361 derives the ATMVP at step S2015.

### STMVP Derivation Processing

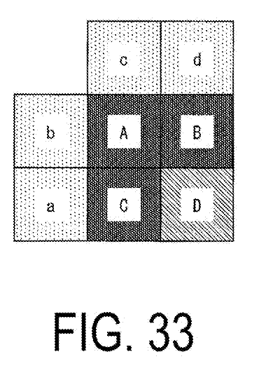

Subsequently, in the flowchart in FIG. 19, the STMVP merge candidate derivation unit 303614 in the merge candidate derivation unit 30361 derives the STMVP and adds the derived STMVP as the merge candidate to the merge candidate list. A description is given of the processing of deriving the STMVP by the STMVP merge candidate derivation unit 303614 with reference to FIG. 33.

FIG. 33 is a conceptual diagram illustrating blocks which are referred to in the derivation of the STMVP performed by the STMVP merge candidate derivation unit 303614 according to the present embodiment. In FIG. 33, the target PU includes a sub-block A, a sub-block B, a sub-block C, and a sub-block D. A sub-block a, a sub-block b, a sub-block c, and a sub-block d are sub-blocks neighboring to the target PU.

The STMVP merge candidate derivation unit 303614, in a case of driving the STMVP for the sub-block A in target PU, derives the motion vectors M V of both the sub-block b and the sub-block c spatially neighboring to the left and the upper side of the sub-block A, respectively. Here, in a case that the motion vector is not available such as in a case that neighboring sub-block is out of the screen, in the case of the intra-prediction mode, and the like, and (1) in a case that the neighboring sub-block is the upper sub-block, the STMVP merge candidate derivation unit 303614 searches sequentially the sub-blocks righter than the sub-block c to find a sub-block of which a motion vector is available. Moreover, (2) in a case that the neighboring sub-block is the left. block, the STMVP merge candidate derivation unit 303614 searches sequentially the sub-blocks lower than the sub-block b to find a sub-block of which a motion vector is available.

The STMVP merge candidate derivation unit 303614 derives a TMVP for the sub-block D neighboring to the lower right of the sub-block A. The processing for deriving the TMVP is described later in detail in a description for step S2018. In a case that the TMVP for the sub-block D is not available, the STMVP merge candidate derivation unit 303614 derives a TMVP at a center position corresponding to the center of the sub-block A.

In a case that a reference picture specified by the derived motion vector MV different from the reference picture of the target PU, the STMVP merge candidate derivation unit 303614 scales the derived motion vector MV in conformity to the reference picture of the target PU.

Then, the STMVP merge candidate derivation unit 303614 finds a weighted average of the motion vectors of the sub-blocks on the upper side, left and lower right of the derived target sub-block, and stores the derived vector as the STM VP for each sub-block.

Similarly, the above process is repeated also for the sub-blocks B, C, and D. The upper and left neighboring sub-blocks described above are respectively the sub-blocks d and A in the case of the sub-block B, the sub-blocks A and a in the case of the sub-block C, and the sub-blocks B and C in the case of the sub-block D.

The STMVP is derived for each sub-block, while a value of the STMVP of the sub-block lastly derived (on the lower right location) is added as a representative value of the merge candidate in accordance with the STMVP to the merge candidate list.

### Processing of Deriving Motion Vector MV of PU B2

In the flowchart illustrate in FIG. 21, the spatial merge candidate derivation unit 303611 identifies the PU B2 sharing no side of the target PU among the PUs sharing the upper left vertex of the target PU at step S2017. In a case that the PU B2 satisfies all of the above-described conditions al to a4, the spatial merge candidate derivation unit 303611 adds the motion vector MV of PU B2 as the merge candidate to the merge candidate list.

### TMVP Derivation Processing

In the flowchart illustrate in FIG. 21, the temporal merge candidate derivation unit 303612 derives the TMVP at step S2018. A description is given of the processing of deriving the TMVP by the temporal merge candidate derivation unit 303612 with reference to FIG. 20.

The temporal merge candidate derivation unit 303612 identifies a block, at the same location as the target PU, in the reference picture of the target PU. Then, the temporal merge candidate derivation unit 303612 determines whether or not a motion vector MV in a block C0 is available, the block C0 being a block sharing no side of the identified block among blocks sharing a lower right vertex of the identified block. For example, in a case that the block C0 exists in the screen and in the case of the inter-prediction mode, the motion vector MV of the block C0 is determined to be available. In the case that the motion vector MV of the block C0 is available, the temporal merge candidate derivation unit 303612 adds the motion vector MV as the TMVP to the merge candidate list.

On the other hand, in a case that the motion vector MV of the block C0 is not available, the temporal merge candidate derivation unit 303612 checks the availability of a block C1 instead of the block C0, the block C1 being located at the lower right of the center of the target PU on the reference picture, and, in a case that a motion vector MV of the block C1 is available, adds the derived motion vector MV as the TMVP to the merge candidate list.

### Combined Merge Candidate Derivation Processing

In the flowchart illustrate in FIG. 21, the combined merge candidate derivation unit 303615 derives a combined merge candidate at step S2019. To be more specific, the combined merge candidate derivation unit 303615 combines vectors and reference picture indices of the derived merge candidates which are already derived and stored in the merge candidate storage unit 30363 as the vectors for L0 and L1, respectively to derive the moving vector, and adds the derived moving vector to the combined merge candidate.

### Zero Merge Candidate Derivation Processing

In the flowchart illustrate in FIG. 21, the zero merge candidate derivation unit 303616 derives a zero merge candidate at step S2020. To he more specific, the zero merge candidate derivation unit 303616 derives a merge candidate including a reference picture index refIdxLX of 0 and both an X component and Y component of 0 of a motion vector mvLX, and configures the derived merge candidate as a zero merge candidate.

The merge candidate derivation unit 30361 derives the merge candidate by the process like this. In a case that the derived merge candidate is the same as the merge candidate already added to the merge candidate list, the merge candidate derivation unit 30361 does not add the derived merge candidate to the merge candidate list. In a case the number of merge candidates reaches the maximum merge candidate number defined for each slice, the merge candidate derivation unit 30361 terminates the merge candidate derivation processing.

Another Method for Deriving initial Motion Source Vector

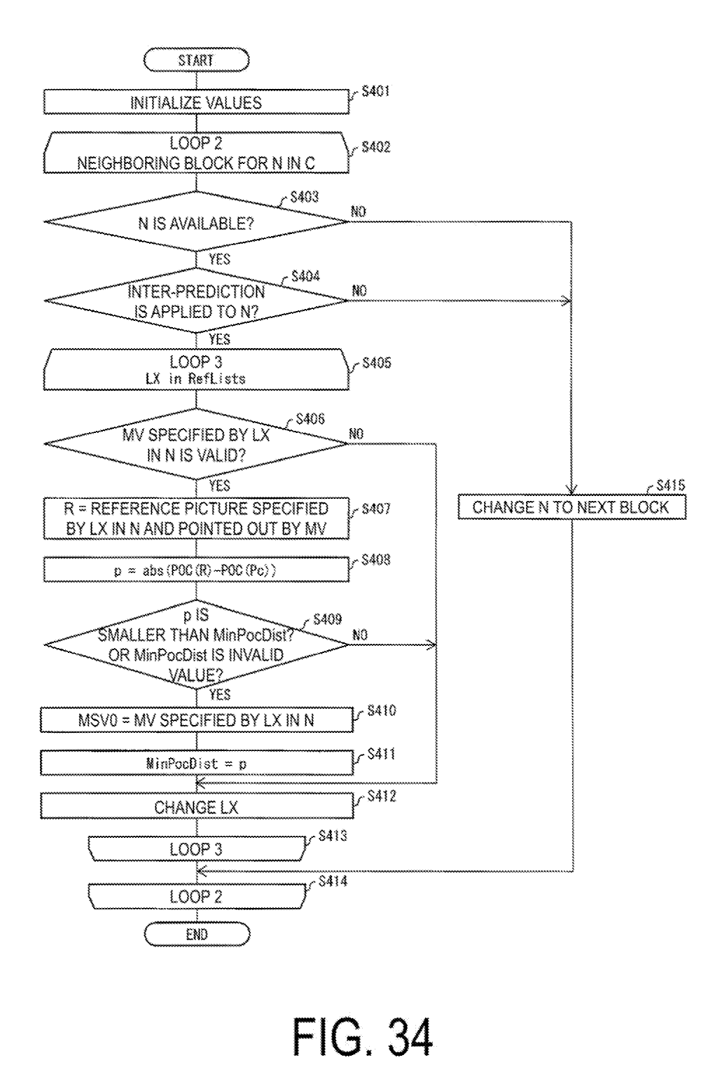

In the above-described process, as the initial motion source vector MSV0, the first derivation unit 3036131 searches the motion vectors MV of the neighboring PU in an order illustrated in FIG. 22, and configures the first found motion vector MV as the initial motion source vector MSV0. A description is given below of a method for deriving, as the initial motion source vector MSV0, by the first derivation unit 3036131, a motion vector in a block or sub-block having a feature amount satisfying a prescribed condition, among multiple blocks or sub-blocks neighboring to the target block including the target sub-block with reference to FIG. 34 to FIG. 38.

### Initial Motion Source Vector Derivation Method 1

FIG. 34 is a flowchart illustrating an example of a flow of the initial motion source vector MSV0 derivation processing which is performed by the first derivation unit 3036131 according to the present embodiment. A description is given of a method for configuring, as the initial motion source vector MSV0, a motion vector MV for a reference picture of which a picture order count POC is the closest to the picture order count POC of the target picture Pc, the method being performed by the first derivation unit 3036131, with reference to FIG. 34.

First, the first derivation unit 3036131 initializes at step S401 values used in the processing. Specifically, the first derivation unit 3036131 initializes the initial motion source vector MSV0, the reference list RefLists, and a distance MinPocDist representing a distance between the target picture and a reference picture the closest to the target picture.

Subsequently, the first derivation unit 3036131 starts at step S402 loop 2 which is performed until no block N remains that is a neighboring PU to be searched for.

Next, the first derivation unit 3036131 determines whether or not the block N is available.

In a case that block N is available (at step S403: Yes), the first derivation unit 3036131 determines at step S404 whether or not the inter-prediction applied to the block N.

In a case that the inter-prediction is applied to the block N (at step S404: Yes), the first derivation unit 3036131 starts at step S405 loop 3 which is performed until no LX list remains that is contained in the reference list RefLists.

Subsequently, the first derivation unit 3036131 determines at step S406 whether or not a motion vector MV specified by the LX list in the block N that is the target PU is valid.

In a case that the motion vector MV is valid (at step S406: Yes), the first derivation unit 3036131 at step S407 configures a reference picture which is specified by the LX list in the block N and is pointed out by the motion vector MV as a picture R. Then, the first derivation unit 3036131 configures at step S408, as a temporal distance p, an absolute value of a difference between the picture order count POC (Pc) of the target picture Pc and a picture order count POC (R) of the picture R.

Subsequently, the first derivation unit 3036131 determines at step S409 whether or not the distance p is smaller than the distance MinPocDist, or whether or not the MinPocDist is an invalid value (or the initial value).

In a case that the distance p is smaller than the distance MinPocDist, or the MinPocDist is an invalid value (at step S409: Yes), the first derivation unit 3036131 configures at step S410 the motion vector MV specified by the LX list in the block N as the initial motion source vector MSV0. Then, the first derivation unit 3036131 configures at step S411 the distance p as the distance MinPocDist.

In a case that the process at step S411 is completed, and the motion vector MV specified by the LX list in the block N is not valid (at step S406: No), or the distance p is not smaller than the distance MinPocDist and the MinPocDist is a valid value (is not the initial value) (at step S409: No), the first derivation unit 3036131 changes the LX list at step S412. Then, the first derivation unit 3036131 terminates loop 3 at step S413 in a case that no LX list contained in the reference list RefLists remains.

In a case that the block N is not available (at step S403: No) or the inter-prediction is not applied to the block N (at step S404: No), the first derivation unit 3036131 changes the block N to the next block (the neighboring PU) at step S415.

In a case that the process in loop 3 is terminated, or the process at step S415 is terminated, the first derivation unit 3036131 performs at step S414 loop 2 until no block N that is the target PU remains. Then, the first derivation unit 3036131 terminates the process illustrated in FIG. 34 in the case that no block N that is the target PU remains,

A pseudo-code A1-1 for the processing of deriving the initial motion source vector MSV0 by the first derivation unit 3036131 by using the method illustrated in FIG. 34 is as below.

Pseudo-code A1-1

/* C: target PU */
getInitialMotionSourceVector(C) {
MSV0 = ZeroMV;
RefLists = getRefListsForSearchingForMSV0(C);
MinPocDist = invalid value;
for N in neighboring blocks of C {
if (N is not available) next;
if (N is not an inter prediction block) next;
for LX in RefLists {
if (MV for LX of N is invalid) next;
R = reference picture of MV for LX of N;
p = abs(POC(R) − POC(Pc));
if (p < MinPocDist || MinPocDist == invalid value) {
MSV0 = MV for LX of N;
MinPocDist = p;
}
}
}
return MSV0;
}

In this way, the first derivation unit 3036131 uses as the feature amount, the distance between the picture order counts POC of the reference picture and the target picture to configure, as the initial motion source vector MSV0, the motion vector MV in the block on the reference picture which satisfies the condition that the reference picture is the closest to the target picture in the distance. For this reason, a motion vector MV which has high analogy to the motion vector MV for the target picture and which is for the reference picture closer to the target picture in the temporal distance is configured as the initial motion source vector MSV0, which allows the coding efficiency to be improved.

### Initial Motion Source Vector Derivation Method 2

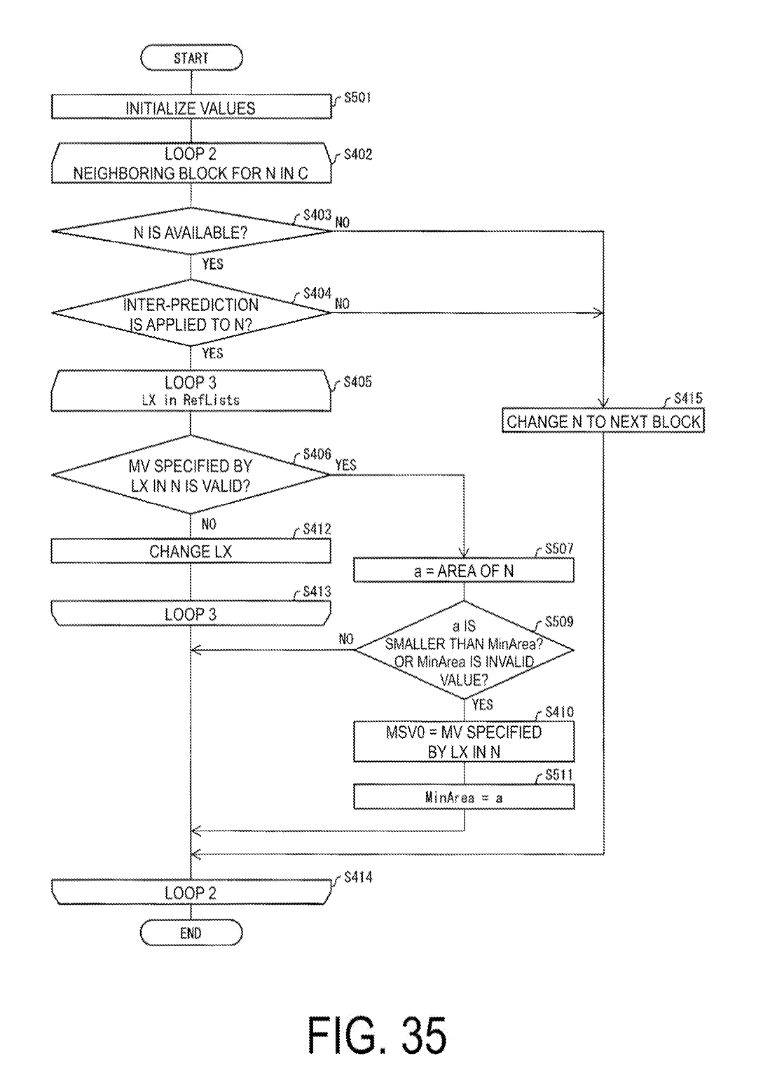

FIG. 35 is a flowchart illustrating another example of the flow of the initial motion source vector MSV0 derivation processing which is performed by the first derivation unit 3036131 according to the present embodiment. A description is given of a method for configuring as the initial motion source vector MSV0, a motion vector MV of a neighboring PU having the smallest area, the method being performed by the first derivation unit 3036131 as the initial motion source vector MSV0, with reference to FIG. 35. In the following description, the process denoted by the number of step the same as step already described is the same process as described above, and the description thereof is omitted.

First, the first derivation unit 3036131 initializes at step S501 values used in the processing. Specifically, the first derivation unit 3036131 initializes the initial motion source vector MSV0, the reference list RcfLists, and an area MinArea representing an area of a neighboring PU having the smallest area among the neighboring PUs. Subsequently, the description of the processes in steps S402 to S406 is omitted.

Next, in the case that the motion vector MV specified by the LX list in the block N is valid (at step S406: Yes), the first derivation unit 3036131 configures an area a as an area of the block N at step S507.

Subsequently, the first derivation unit 3036131 determines at step S509 whether or not the area a is smaller than the area MinArea, or whether or not the area MinArea is an invalid value (or the initial value).

In a case that the area a is smaller than the area MinArea, or the area MinArea is an invalid value (at step S509: Yes), the first derivation unit 3036131 configures at step S410 the motion vector MV specified by the LX list in the block N as the initial motion source vector MSV0. Then, the first derivation unit 3036131 configures the area MinArea as the area a.

On the other hand, in the case that the motion vector MV specified by the LX list in the block N is not valid (at step S406: No), the first derivation unit 3036131 performs the processes at step S412 and step S413 described above.

In a case that the area a is larger than the area MinArea, or the area MinArea is not an invalid value (at step S509: No), or in a case that the process at step S413, step S415, or step S511 is terminated, the first derivation unit 3036131 performs the process at step S414 described above. Then, the first derivation unit 3036131 terminates the process illustrated in FIG. 35 in a case that no block N that is the neighboring PU remains.

A pseudo-code A1-2 for the processing of deriving the initial motion source vector MSV0 by the first derivation unit 3036131 by using the method illustrated in FIG. 35 is as

Pseudo-code A1-2

/* C: target PU */
getInitialMotionSourceVector(C) {
MSV0 = ZeroMV;
RefLists = getRefLists(C);
MinArea = invalid value;
for N in neighboring blocks of C {
if (N is not available) next;
if (N is not an inter prediction block) next;
for LX in RefLists {
if (MV for LX of N is invalid) next;
a = area of N;
if (a < MinArea || MinArea == invalid value) {
MSV0 = MV for LX of N;
MinArea = a;
}
}
}
return MSV0;
}

In this way, the first derivation unit 3036131 uses the area of the neighboring PU as the feature amount to configure as the initial motion source vector MSV0 the motion vector MV of the neighboring PU which satisfies the condition of having the smallest area. Therefore, the motion vector MV of the neighboring PU which has information spatially closer to the target PU and has a smaller area, as compared with the neighboring PU having a larger area, is configured as the initial motion source vector MSV0, thus allowing the coding efficiency to be improved.

### Initial Motion Source Vector Derivation Method 3

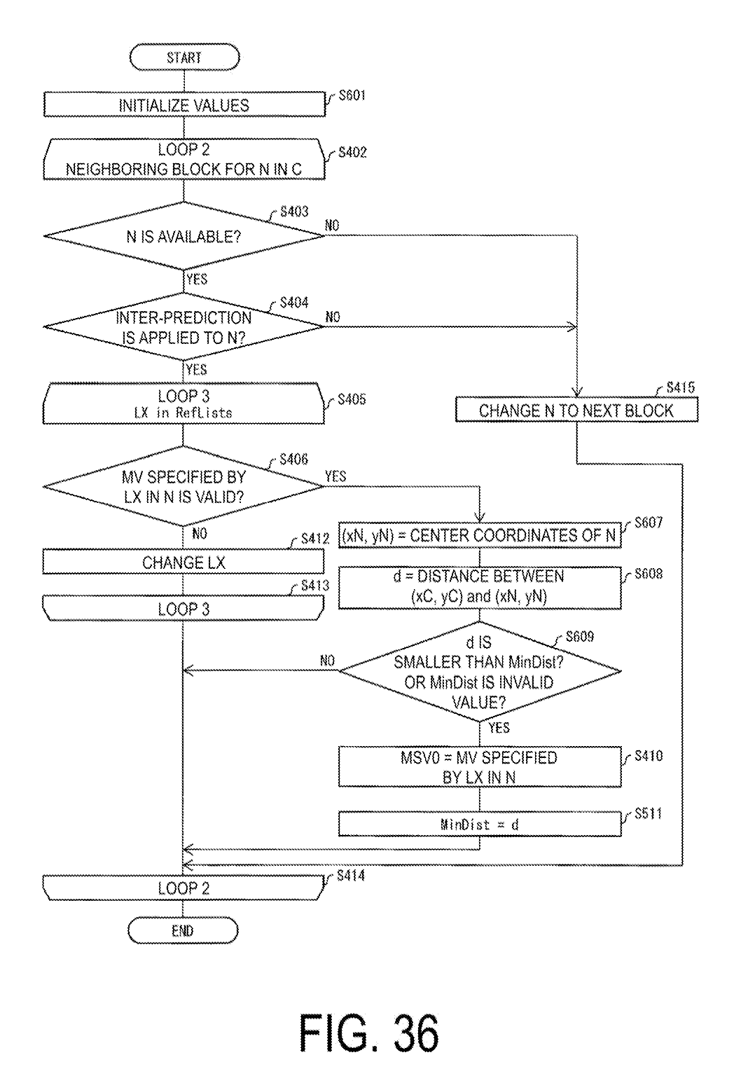

FIG. 36 is a flowchart illustrating still another example of the flow of the initial motion source vector MSV0 derivation processing which is performed by the first derivation unit 3036131 according to the present embodiment. A description is given of a method for configuring as the initial motion source vector MSV0, a motion vector MV of a neighboring PU having the center coordinates which is the closest to the center coordinates of the target PU, the method being performed by the first derivation unit 3036131 as the initial motion source vector MSV0, with reference to FIG. 36.

First, the first derivation unit 3036131 initializes at step S601 values used in the processing. Specifically, the first derivation unit 3036131 initializes the initial motion source vector MSV0, the reference list RefLists, the coordinates (xC, yC) representing the center coordinates of the target PU, and a distance MinDist representing a distance between the center coordinates of the target PU and the center coordinates of the neighboring PU. Subsequently, the description of the processes in steps S402 to S406 is omitted.

Next, in the case that the motion vector MV specified by the LX list in the block N is valid (at step S406: Yes), the first derivation unit 3036131 configures the center coordinates of the block N as coordinates (xN, yN) at step S607. Then, the first derivation unit 3036131 configures at step S608 a distance between the coordinates (xC, yC) and the coordinates (xN, yN) as a distance d.

Subsequently, the first derivation unit 3036131 determines at step S609 whether or not the distance d is smaller than the distance MinDist, or whether or not the distance MinDist is an invalid value (or the initial value)

In a case that the distance d is smaller than the distance MinDist, or the distance MinDist is an invalid value (at step S609: Yes), the first derivation unit 3036131 configures at step S410 the motion vector MV specified by the LX list in the block N as the initial motion source vector MSV0. Then, the first derivation unit 3036131 configures at step S611 the distance MinDist as the distance d.

On the other hand, in the case that the motion vector MV specified by the LX list in the block N is not valid (at step S406: No), the first derivation unit 3036131 performs the processes at step S412 and step S413 described above. The subsequent processes are the same as the processes described above, and therefore, the description thereof is omitted.

A pseudo-code A1-3 for the processing of deriving the initial motion source vector MSV0 by the first derivation unit 3036131 by using the method illustrated in FIG. 36 is as below.

Pseudo-code A1-3

/* C: target block */
getInitialMotionSourceVector(C) {
MSV0 = ZeroMV;
RefLists = getRefLists(C);
(xC, yC) = center coordinates of C;
MinDist = invalid value;
for N in neighboring blocks of C {
if (N is not available) next;
if (N is not an inter prediction block) next;
for LX in RefLists {
if (MV for LX of N is invalid) next;
(xN, yN) = center coordinates of N;
d = distance between (xC, yC) and (xN, yN);
if (d < MinDist || MinDist == invalid value) {
MSV0 = MV for LX of N;
MinDist = d;
}
}
}
return MSV0;
}

In this way, the first derivation unit 3036131 uses the distance between the center coordinates of the target PU and the neighboring PU as the feature amount to configure as the initial motion source vector MSV0 the motion vector MV of the neighboring PU which satisfies the condition that the distance is the smallest. For example, as for the target PU illustrated in FIG. 22, in a case that the areas of the neighboring PU (1) and the neighboring PU(5) are the same among the neighboring PUs sharing the upper left vertex of the target PU, the neighboring PU (1) sharing the left side of the target PU, and the neighboring PU(5) sharing no side of the target PU, the first derivation unit 3036131 configures as the initial motion source vector MSV0 a motion vector MV of the neighboring PU(1) of which the center coordinates are closer to the center coordinates of the target PU. Therefore, the motion vector MV of the neighboring PU is configured as the initial motion source vector MSV0, which has information spatially closer to the target PU, thus allowing the coding efficiency to be improved.

### Initial Motion Source Vector Derivation Method 4

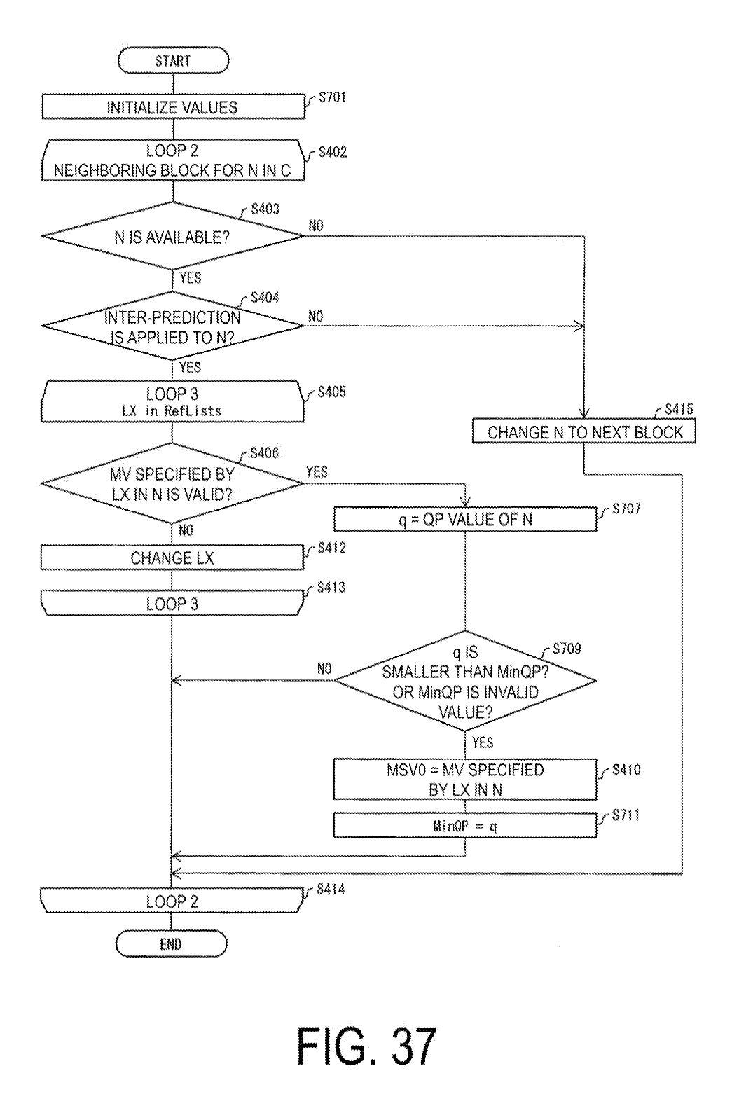

FIG. 37 is a flowchart illustrating still another example of the flow of the initial motion source vector MSV0 derivation processing which is performed by the first derivation unit 3036131 according to the present embodiment. A description is given of a method for configuring as the initial motion source vector MSV0, a motion vector MV of a neighboring PU having the smallest QP value, the method being performed by the first derivation unit 3036131 as the initial motion source vector MSV0, with reference to FIG. 37.

First, the first derivation unit 3036131 initializes at step S701 values used in the processing. Specifically, the first derivation unit 3036131 initializes the initial motion source vector MSV0, the reference list RefLists, and a QP value MinQP representing a QP value of a neighboring PU having the smallest QP value among the neighboring PUs. Subsequently, the description of the processes in steps S402 to S406 is omitted.

Subsequently, in the case that the motion vector MV specified by the LX list in the block N is valid (at step S406: Yes), the first derivation unit 3036131 configures a QP value of the block N as a QP value q at step S707.

Next, the first derivation unit 3036131 determines at step S709 whether or not the QP value q is smaller than the QP value MinQP, or whether or not the QP value MinQP is an invalid value (or the initial value).

In a case that the QP value q is smaller than the QP value MinQP, or the QP value MinQP is an invalid value (at step S709: Yes), the first derivation unit 3036131 configures at step S410 the motion vector MV specified by the LX list in the block N as the initial motion source vector MSV0. Then, the first derivation unit 3036131 configures at step S711 the QP value MinQP as the QP value q.

On the other hand, in the case that the motion vector MV specified by the LX list in the block N is not valid (at step S406: No), the first derivation unit 3036131 performs the processes at step S412 and step S413 described above. The subsequent processes are the same as the processes described above, and therefore, the description thereof is omitted.

A pseudo-code A1-4 for the processing of deriving the initial motion source vector MSV0 by the first derivation unit 3036131 by using the method illustrated in FIG. 37 is as below.

Pseudo-code A1-4

/* C: target block */
getInitialMotionSourceVector(C) {
MSV0 = ZeroMV;
RefLists = getRefLists(C);
MinQP = invalid value;
for N in neighboring blocks of C {
if (N is not available) next;
if (N is not an inter prediction block) next;
for LX in {
if (MV for LX of N is invalid) next;
q = QP value of N;
if (q < MinQP || MinQP == invalid value) {
MSV0 = MV for LX of N;
MinQP = q;
}
}
}
return MSV0;
}

In this way, the first derivation unit 3036131 uses the QP value of the neighboring PU as the feature amount to configure as the initial motion source vector MSV0 the motion vector MV of the neighboring PU which satisfies the condition of having the QP value. The neighboring PU smaller in the QP value (in other words, narrower in the quantization width) tends to he higher in the precision of the motion vector MV, as compared with the neighboring PU larger in the QP value din other words, wider in the quantization width). Therefore, the motion vector MV of the neighboring PU is configured as the initial motion source vector MSV0, which has the smallest QP thus allowing the coding efficiency to be improved.

### Initial Motion Source Vector Derivation Method 5

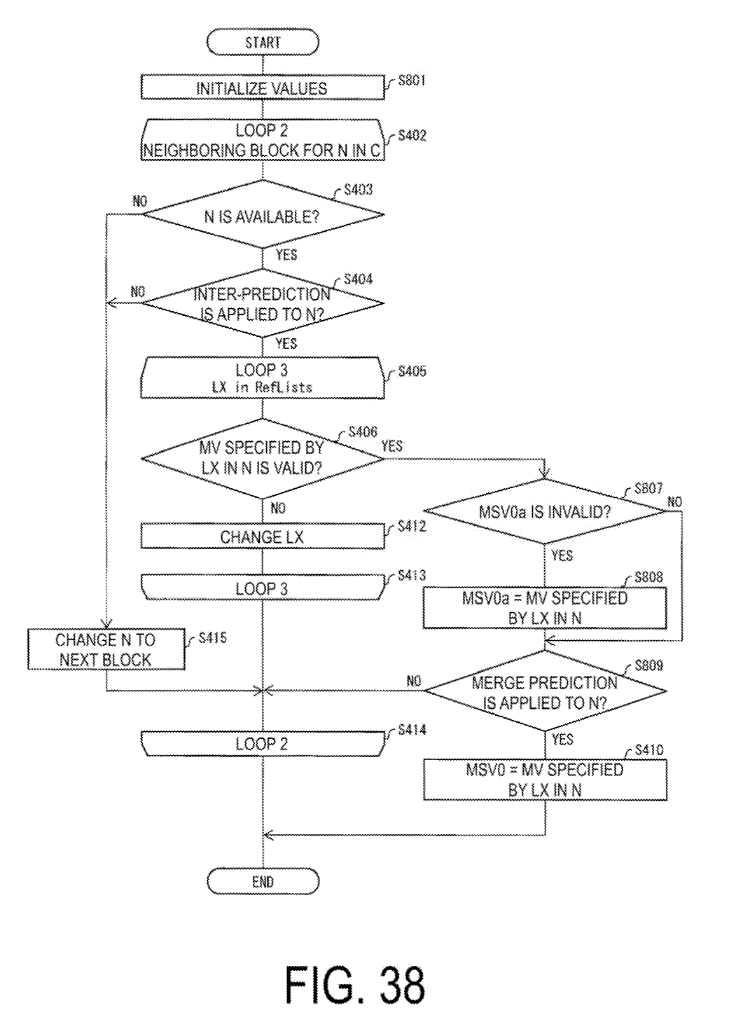

FIG. 38 is a flowchart illustrating still another example of the flow of the initial motion source vector MSV0 derivation processing which is performed by the first derivation unit 3036131 according to the present embodiment. A description is given of a method for configuring as the initial motion source vector MSV0, a motion vector MV of a neighboring PU to which the merge prediction is applied, the method being performed by the first derivation unit 3036131 as the initial motion source vector MSV0, with reference to FIG. 38.

First, the first derivation unit 3036131 initializes at step S801 values used in the processing. Specifically, the first derivation unit 3036131 initializes the initial motion source vector MSV0, the reference list RefLists, and a motion vector MSV0a representing a firstly found motion vector MV. Subsequently, the description of the processes in steps S402 to S406 is omitted.

Subsequently, in a case that the motion vector MV specified by the LX list in the block N is valid (at step S406: Yes), the first derivation unit 3036131 determines at step S807 whether or not the motion vector MSV0a is invalid (or the initial value).

In a case that the motion vector MSV0a is invalid (at step S807: Yes), the first derivation unit 3036131 configures at step S808 the motion vector MV specified by the LX list in the block N as the motion vector MSV0a.

On the other hand, in a case that the motion vector MSV0a is not invalid (at step S807: No), or the process at step S808 is completed, the first derivation unit 3036131 determines at step S809 whether or not the merge prediction is applied to the block N.

In a case that the merge prediction is applied to the block N (at step S809: Yes), the first derivation unit 3036131 configures at step S410 the motion vector MV specified by the LX list in the block N as the motion vector MSV0. Then, the process illustrated in FIG. 38 is terminated.

On the other hand, in a case that the merge prediction is not applied to the block N (at step S809: No), in a case that the process at step S413 is terminated, or the process at step S415 is terminated, the first derivation unit 3036131 performs the process at step S414 described above. Then, in a case that no block N remains, the first derivation unit 3036131 terminates the process illustrated in FIG. 38.

In a case that no block N to which the merge prediction is applied remains (that is, in the case that no block N remains and loop 2 is terminated), the first derivation unit 3036131 configures a firstly found motion vector MSV0a as MSV0.

A pseudo-code A1-5 for the processing of deriving the initial motion source vector MSV0 by the first derivation unit 3036131 by using the method illustrated in FIG. 38 is as below.

Pseudo-code A1-5

/* C: target block */
getInitialMotionSourceVector(C) {
MSV0 = ZeroMV;
RefLists = getRefLists(C);
MSV0a = invalid MV;
for N in neighboring blocks of C {
if (N is not available) next;
if (N is not an inter prediction block) next;
for LX in RefLists {
if (MV for LX of N is invalid) next;
if (MSV0a is invalid MV) {
MSV0a = MV for LX of N;
}
if (N uses merge mode) {
MSV0 = MV for LX of N;
return MSV0;
}
}
}
return MSV0a;
}

In this way, the first derivation unit 3036131 derives, as the initial motion source vector MSV0, the motion vector MV of the neighboring PU to which the merge prediction is applied, among the neighboring PUs to the target PU. Therefore, the motion vector MV of the neighboring PU to which the merge prediction is applied is configured as the initial motion source vector MSV0, which can merge, in the chain form regions of the same motion, thus allowing the coding efficiency to be improved.

The first derivation unit 3036131 may mutually combine the initial motion source vector derivation methods 1 to 5. For example, the initial motion source vector derivation methods 1 to 5 may be performed based on a priority order given to the initial motion source vector derivation methods 1 to 5 such that a firstly found motion vector may be configured as the initial motion source vector MSV0. The configuration above allows the proper initial motion source vector MSV0 to be derived in a case that any of the initial motion source vector derivation methods 1 to 5 is used, and even in a case that no or multiple motion vectors satisfy the condition. At this time, in the initial motion source vector derivation method using a scheme of finding the minimum value of the feature amount, a threshold for the minimum value of the feature amount is provided such that the proper MSV0 can be derived by using the initial motion source vector derivation method given the next priority in a case that the minimum value is larger than the threshold.

### Another Method for Deriving Sub-Block MV

In the sub-block MV derivation processing at step S20155 described above, in a case that the slice type of the slice including the target PU is the B slice, a bidirectional BiPred motion vector is derived as the sub-block MV.

To be more specific, the third derivation unit 3036133 refers to a LowDelayCoding (LDC) flag, and, in a case the LDC flag is 1, derives the motion vector for the L0 list (L0 vector) of the target sub-block SB in the target PU from the motion vector MV for the L0 list of the corresponding sub-block CSB. Similarly, the third derivation unit 3036133 derives the motion vector for the L1 list (L1 vector) of the target sub-block SB in the target PU from the motion vector MV for the L1 list of the corresponding sub-block CSB. However, in a case that the motion vector for the LX list of the corresponding sub-block CSB does not exist, the third derivation unit 3036133 uses a motion vector for LY list of the corresponding sub-block CSB (where, Y=1−X).

On the other hand, in a case that the LDC flag is 0, the third derivation unit 3036133 uses LZ (LZ, is L0 or L1) which is explicitly coded and is used for selection to derive the motion vector for the L0 list and L1 list of the target sub-block SB in the target PU.

A description is given below of a sub-block MV derivation method capable of further improving the coding efficiency.

### Sub-Block MV Derivation Method 1

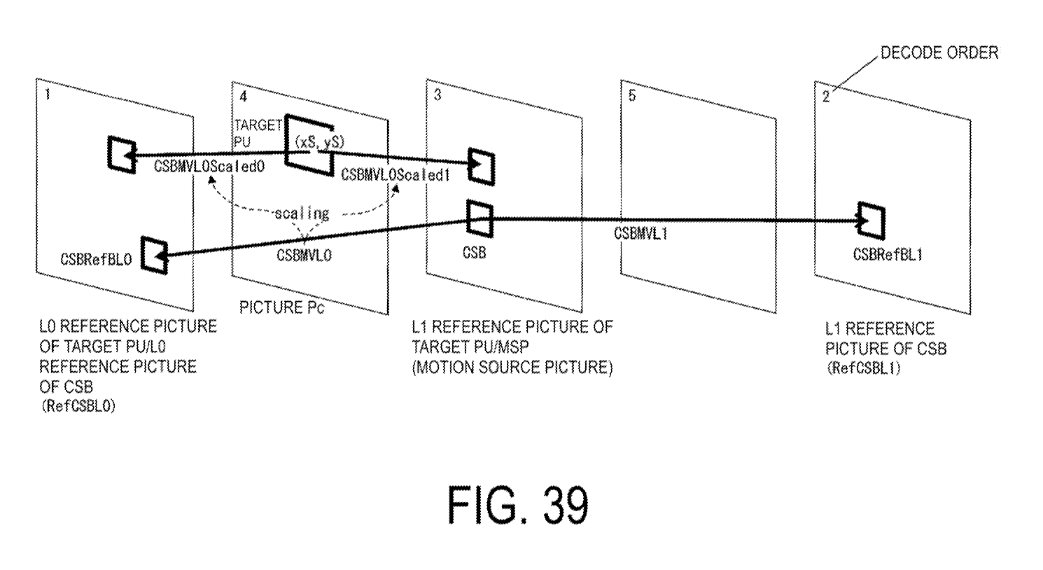

In a case that a slice which is obtained by partitioning the target picture Pc and includes the target sub-block SB on the target picture Pc is a B slice to which the bidirectional prediction is applied, and the corresponding sub-block CSB is associated with multiple corresponding sub-block motion vectors CSBMV, the third derivation unit 3036133 derives, as bidirectional motion vector candidates for the target sub-block SB, higher priority corresponding sub-block motion vectors CSBMV among the multiple corresponding sub-block motion vectors CSBMV, or vectors obtained by scaling the CSBMV. Details of the method are described with reference to FIG. 39. The higher priority corresponding sub-block motion vector CSBMV is described later in detail.

FIG. 39 is a conceptual diagram illustrating the corresponding sub-block motion vector CSBMV scale processing using the higher priority corresponding sub-block motion vector CSBMV, which is performed by the third derivation unit 3036133 according to the present embodiment. In the following description, the higher priority corresponding sub-block motion vector CSBMV may be referred to as a priority motion block MV.

As illustrated in FIG. 39, in a case that a slice including the target sub-block SB in the target PU on the target picture Pc is the B slice, the third derivation unit 3036133 derives the bidirectional motion vector candidates for the target sub-block SB. Here, in a case that the motion vector of the corresponding sub-block CSB on the motion source picture MSP includes a corresponding sub-block motion vector CSBMVL0 associated with the L0 list and a corresponding sub-block motion vector CSBMVL1 associated with the L1 list, the third derivation unit 3036133 uses the motion vector associated with the higher priority list to derive the bidirectional motion vector candidates for the target sub-block SB.

For example, in FIG. 39, in a case that the motion vector associated with the higher priority list is the corresponding sub-block motion vector CSBMVL0, the third derivation unit 3036133 scales the corresponding sub-block motion vector CSBMVL0 to derive a motion vector CSBMVLOScaled0 and a motion vector CSBMVL0Scaled1 which are the bidirectional motion vector candidates for the target sub-block SB.

In this way, the third derivation unit 3036133 uses the higher priority corresponding sub-block motion vector CSBMVLZ (LZ is L0 or L1) to derive the motion vector CSBMVLZScaled0 and the motion vector CSBMVLZScaled1 which are the bidirectional motion vector candidates for the target sub-block SB. Therefore, the motion vector candidate using the more proper motion vector can be derived, thus allowing the coding efficiency to be improved.

### Sub-Block MV Derivation Method 2

In a case that the corresponding sub-block motion vector CSBMVL0 and the corresponding sub-block motion vector CSBMVL1 that are the motion vectors of the corresponding sub-block CSB are in a relationship in which speeds thereof are equal to each other, the third derivation unit 3036133 preferably uses the corresponding sub-block motion vector CSBMVL0 and the corresponding sub-block motion vector CSBMVL1 to derive the motion vectors that are the bidirectional motion vector candidates for the target sub-block SB.

Therefore, the third derivation unit 3036133 first determines whether or not the corresponding sub-block motion vector CSBMVL0 and the corresponding sub-block motion vector CSBMVL1 that are the motion vectors of the corresponding sub-block CSB are in the relationship in which speeds thereof are equal to each other. In a case that the corresponding sub-block motion vector CSBMVL0 and the corresponding sub-block motion vector CSBMVL1 are in the relationship in which speeds thereof are equal to each other, the third derivation unit 3036133 derives, as motion vector candidates, the corresponding sub-block motion vector CSBMVL0 or the motion vector CSBMVL0Scaled0 obtained by scaling CSBMVL0, and the corresponding sub-block motion vector CSBMVL1 or the motion vector CSBMVL1Scaled1 obtained by scaling CSBMVL1.

On the other hand, in a case that the corresponding sub-block motion vector CSBMVL0 and the corresponding sub-block motion vector CSBMVL1 are not in the relationship in which speeds thereof are equal to each other, the higher priority corresponding sub-block motion vector CSBMVLZ is used to derive the motion vector CSBMVLZScaled0 and the motion vector CSBMVLZScaled1 that are the bidirectional motion vector candidates for the target sub-block SB, as described above.

Here, a vector Va and a vector Vb being in the relationship in which speeds thereof are equal to each other refers to that the vector Va and the vector Vb satisfy a relationship below.

D=|Va/(POC(Va)−POC(VaRef))−Vb/(POC(Vb)−POC(VbRef))|

or

ti D=(POC(Vb)−POC(VbRef))*Va−(POC(Va)−POC(VaRef))*Vb|,

where

D<D_Th (prescribed value)

Specifically, first, the third derivation unit 3036133 scales the vector Va and the vector Vb to be the same directional vectors at the same picture order count POC distances and in the same picture order count POC orders, based on the picture order counts POC derived from the reference pictures of the vector Va and the vector Vb. In a case that an absolute value of a length of a difference vector of the scaled vectors is smaller than D_Th which is a prescribed value (threshold) for determining whether D is close to 0, an expression is made that the vector Va and the vector Vb are in the relationship in which the speeds thereof are equal to each other. Alternatively, in a case that the absolute value D of the length of the difference vector is in a range of −D_Th<D<D_Th, the vector Va and the vector Vb can be said to be equal to in the speed.

In this way, in the case that the corresponding sub-block motion vector CSBMVL0 and the corresponding sub-block motion vector CSBMVL1 that are the motion vectors of the corresponding sub-block CSB are in the relationship in which speeds thereof are equal to each other, the third derivation unit 3036133 uses CSBMVL0 and CSBMVL1 to derive the bidirectional motion vector candidates for the target sub-block SB. In the case that CSBMVL0 and CSBMVL1 are not in the relationship in which speeds thereof are equal to each other, the higher priority corresponding sub-block motion vector CSBMVLZ is used to derive the bidirectional motion vector candidates for the target sub-block SB. Therefore, the motion vector candidate using the more proper motion vector can be derived, so this allows the coding efficiency to be improved.

### Higher Priority Corresponding Sub-Block Motion Vector CSBMVLZ Derivation Method 1

A description is given of an example of a method for deriving the higher priority corresponding sub-block motion vector CSBMVLZ.

The third derivation unit 3036133 derives, as the higher priority corresponding sub-block motion vector CSBMVLZ, the corresponding sub-block motion vector associated with the reference picture which is temporally closer to the target picture Pc, among the corresponding sub-block motion vector CSBMVL0 and the corresponding sub-block motion vector CSBMVL1 that are the motion vectors of the corresponding sub-block CSB.

For example, in FIG. 39, the reference picture of the corresponding sub-block CSB includes a reference picture RefCSBL0 and a reference picture RefCSBL1. Among the reference picture RefCSBL0 and the reference picture RefCSBL1, the reference picture which is temporally closer to the target picture Pc (that is, a difference between the picture order counts POC is smaller) is the reference picture RefCSBLZ. Therefore, the third derivation unit 3036133 derives CSBMVLZ as the higher priority corresponding sub-block motion vector.

In this way, the third derivation unit 3036133 derives, as the higher priority corresponding sub-block motion vector, the corresponding sub-block motion vector CSBMVLZ associated with the reference picture which is temporally closer to the target picture Pc, among the corresponding sub-block motion vector CSBMVL0 and the corresponding sub-block motion vector CSBMVL1 that are the motion vectors of the corresponding sub-block CSB. Therefore, the motion vector candidate using the more appropriate motion vector can be derived, thus allowing the coding efficiency to be improved.

### Higher Priority Corresponding Sub-Block Motion.Vector CSBMVLZ Derivation Method 2

A description is given of another example of the method for deriving the higher priority corresponding sub-block motion vector CSBMVLZ.

Assuming that the picture order count of the target picture Pc is POC (Pc), the picture order count of the reference picture RefCSBLX of the corresponding sub-block CSB is POC (RefCSBLX), and the picture order count of the motion source picture MSP is POC (MSP), the third derivation unit determines, as the higher priority corresponding sub-block motion vector CSBMVLZ, the corresponding sub-block motion vector CSBMVLX associated with the reference picture which satisfies

POC(MSP)>POC(Pc)>POC(RefCSBLX) or

POC(MSP)<POC(Pc)<POC(RefCSBLX),

among the reference pictures in both directions of the corresponding sub-block CSB. The picture order count POC (Pc) of the target picture Pc may be called a currPOC.

For example, in FIG. 39, the reference picture of CSB includes the reference picture RefCSBL0 and the reference picture RefCSBL1. Then, among the reference picture RefCSBL0 and the reference picture RefCSBL1, the reference picture for which the POC(Pc) exists between the POC (RefCSBL0) and the POC (MSP) or between the POC (RefCSBL1) and the POC (MSP) is the reference picture RefCSBL0. Therefore, the third derivation unit 3036133 derives the corresponding sub-block motion vector CSBMVL0 associated with the reference picture RefCSBL0 as the higher priority corresponding sub-block motion vector CSBMVLZ.

In this way, the third derivation unit 3036133 derives the corresponding sub-block motion vector associated with the reference picture which satisfies the condition that the POC (Pc) of the target picture Pc exists between the picture order count of the reference picture of CSB and the picture order count of the reference picture of MSP, as the higher priority corresponding sub-block motion vector. Therefore, the motion vector candidate using the more appropriate motion vector can be derived, thus allowing the coding efficiency to be improved.

### Motion Vector Derivation Processing in AMVP Mode

In the AMVP mode, the difference motion vector mvdLX is derived from the decoded syntaxes mvdAbsVal and my_sign_flag and the difference motion vector mvdLX is added to the prediction vector mvpLX to derive the motion vector mvLX. In the description of the syntaxes, mvdAbsVal [0], mvdAbsVal [1], and the like are described using [0], [1] and the like to distinguish a horizontal component and a vertical component but in the following description, are merely described as the mvdAbsVal without distinguishing the components for the purpose of simplification. The motion vector practically includes the horizontal component and the vertical component, and therefore, the process described without distinguishing the components may be sequentially performed on the respective components.

On the other hand, FIG. 18B is a flowchart illustrating a flow of the motion vector derivation processing in the AMVP mode. As illustrated in FIG. 18B, the vector candidate derivation unit 3033 derives at S301 the prediction motion vector list mvpListLX, and the prediction vector selection unit 3034 selects at S302 the prediction vector mvpLX=mvpListLX [mvp_LX_idx] specified by the prediction vector index mvp_LX_idx.

Next, the inter-prediction parameter decoding controller 3031 derives at S303 the difference vector mvdLX. As illustrated in FIG. 18B, at S304, the vector candidate selection unit 3034 may perform the round process on the selected prediction vector. Next, at S305, the prediction vector mvpLX and the difference vector mvdLX are added by the addition unit 3035 to compute the motion vector mvLX. In other words, mvLX is computed in accordance with

mvLX=mvpLX+mvdLX

### Configuration of Image Coding Device

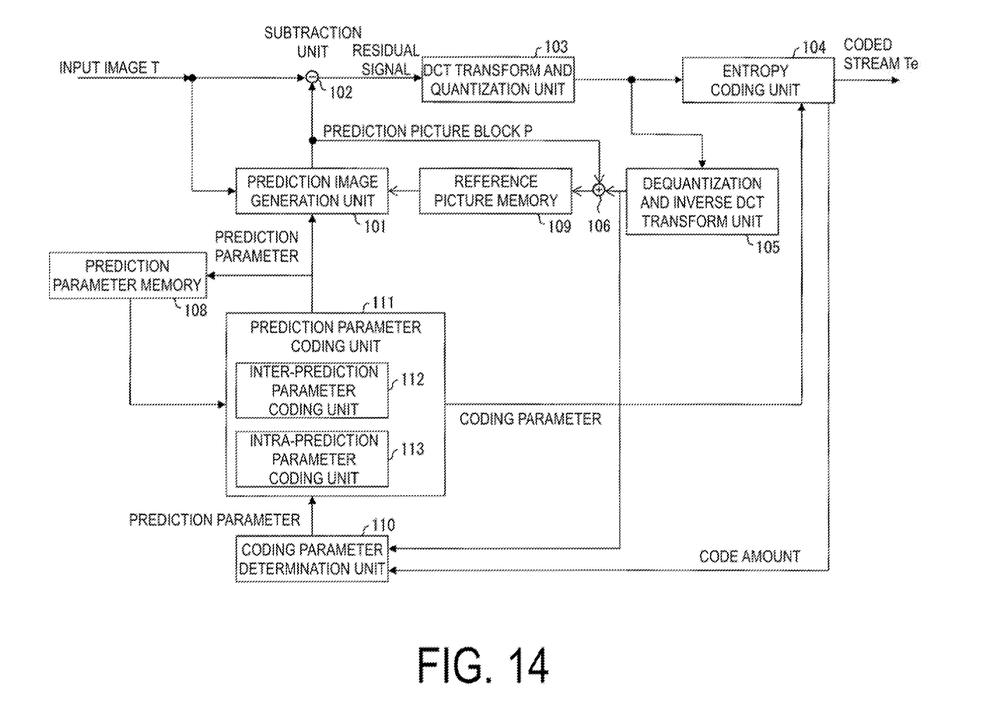

Next, a configuration of the image coding device 11 according to the present embodiment will be described. FIG. 14 is a block diagram illustrating the configuration of the image coding device 11 according to the present embodiment. The image coding device 11 is configured to include a prediction image generation unit 101, a subtraction unit 102, a DCT and quantization unit 103, an entropy coding unit 104, a dequantization and inverse DCT unit 105, an addition unit 106, a prediction parameter memory (prediction parameter storage unit, frame memory) 108, a reference picture memory (reference image storage unit, frame memory) 109, a coding parameter determination unit 110, and a prediction parameter coding unit 111. The prediction parameter coding unit 111 is configured to include an inter-prediction parameter coding unit 112 and an intra-prediction parameter coding unit 113.

The prediction image generation unit 101 generates a prediction image P of the PU for each CU for each picture of an input image T input from outside, the CU being an area obtained by partitioning the picture. Here, the prediction image generation unit 101 reads out a reference picture block from the reference picture memory 109, based on a prediction parameter input from the prediction parameter coding unit 111. The prediction parameter input from the prediction parameter coding unit 111 is a motion vector, for example. The prediction image generation unit 101 reads out a block at a location indicated by a motion vector predicted with a starting point being a coding target CU. The prediction image generation unit 101 generates the prediction image P of the PU for the read-out reference picture block by use of one prediction scheme of multiple prediction schemes. The prediction image generation unit 101 outputs the generated prediction image P of the PU to the subtraction unit 102. The prediction image generation unit 101 operates in the same way as the prediction image generation unit 308 described already, and therefore, a detailed description of generating the prediction picture P of the PU is omitted.

The prediction image generation unit 101, in selecting the prediction scheme, selects a prediction scheme which minimizes an error value based on a difference between a pixel value of the PU included in the image and a corresponding pixel value of the prediction image P of the PU, for example. The method of selecting the prediction scheme is not limited to the above.

Multiple prediction schemes include the intra-prediction, the motion prediction, and the merge prediction. The motion prediction is the prediction in a time direction among the inter-predictions described above. The merge prediction is prediction using the reference picture block and prediction parameter the same as for a PU which is in a predefined range from the coding target CU, the reference picture block being already coded.

The prediction image generation unit 101, in a case of selecting e intra prediction, outputs a prediction mode IntraPredMode indicating the intra-prediction mode which has been used in generating the prediction image P of the PU to the prediction parameter coding unit 111.

The prediction image generation unit 101, in a case of selecting the motion prediction, stores the motion vector mvLX which has been used in generating the prediction image P of the PU in the prediction parameter memory 108, and outputs the motion vector to the inter-prediction parameter coding unit 112. The motion vector mvLX indicates a vector from a location of the coding target PU to a location of the reference picture block in generating the prediction image P of the PU. Information indicating the motion vector mvLX includes information indicating the reference picture (e.g., reference picture index refIdxLX, picture order count POC), and may indicate the prediction parameter. The prediction image generation unit 101 outputs the prediction mode predMode indicating the inter-prediction mode to the prediction parameter coding unit 111.

The prediction image generation unit 101, in a case of selecting the merge prediction, outputs the merge index merge_idx indicating the selected merge candidate to the inter-prediction parameter coding unit 112. The prediction image generation unit 101 outputs the prediction mode predMode indicating the merge prediction mode to the prediction parameter coding unit 111.

The prediction image generation unit 101 may include a configuration to generate motion compensation filter coefficients referred to by the motion compensation unit 3091 included in the image decoding device 31.

The prediction image generation unit 101 may include a configuration corresponding to switching of the precision of the motion vector described regarding the image decoding device 31. To be more specific, the prediction image generation unit 101 may switch the precision of the motion vector depending on the block size, the QP, and the like. Moreover, the prediction image generation unit 101 may be configured to code a motion vector precision flag mvd_dequant_flag which is referred to in switching the precision of the motion vector in the image decoding device 31.

The subtraction unit 102 subtracts a signal value of the prediction image P of the PU input from the prediction image generation unit 101 from a pixel value of the corresponding PU of the input image T to generate the residual signal. The subtraction unit 102 outputs the generated residual signal to the DCT and quantization unit 103 and the coding parameter determination unit 110.

The DCT and quantization unit 103 performs DCT on the residual signal input from the subtraction unit 102 to compute DCT coefficients. The DCT and quantization unit 103 quantizes the computed DCT coefficients to find quantized coefficients. The DCT and quantization unit 103 outputs the found quantized coefficients to the entropy coding unit 104 and the dequantization and inverse DCT unit 105.

To the entropy coding unit 104, input are the quantized coefficients from the DCT and quantization unit 103 and coding parameters from the coding parameter determination unit 110. Examples of the input coding parameters include the codes such as the reference picture index refIdxLX, the prediction vector index mvp_LX_idx, the difference vector mvdLX, the prediction mode predMode, and the merge index merge_idx.

The entropy coding unit 104 may be configured to perform, before coding the difference vector mvdLX, processing corresponding to the non-linear dequantization process described regarding the image decoding device 31, that is, to perform the non-linear dequantization process on the difference vector.

The entropy coding unit 104 performs entropy coding on the input quantized coefficients and coding parameters to generate a coded stream Te, and outputs, to the outside, the generated coded stream Te.

The dequantization and inverse DCT unit 105 dequantizes the quantized coefficients input from the DCT and quantization unit 103 to find DCT coefficients. The dequantization and inverse DCT unit 105 performs inverse DCT on the found DCT coefficients to compute a decoded residual signal. The dequantization and inverse DCT unit 105 outputs the computed decoded residual signal to the addition unit 106.

The addition unit 106 adds a signal value of the prediction image P of the PU input from the prediction image generation unit 101 and a signal value of the decoded residual signal input from the dequantization and inverse DCT unit 105 for each pixel to generate a decoded image. The addition unit 106 stores the generated decoded image in the reference picture memory 109.

The prediction parameter memory 108 stores the prediction parameter generated by the prediction parameter coding unit 111 in a predefined location for each coding target picture and CU.

The reference picture memory 109 stores the decoded image generated by the addition unit 106 in a predefined location for each coding target picture and CU.

The coding parameter determination unit 110 selects one set from among multiple sets of coding parameters. The coding parameters are the prediction parameters described above or parameters to be coded that are generated in association with the prediction parameters. The prediction image generation unit 101 uses each of these sets of coding parameters to generate the prediction image P of the PU.

The coding parameter determination unit 110 computes a cost value indicating the size of an amount of information and a coding error for each of multiple sets. The cost value is a sum of a code amount and a value obtained by multiplying a square error by a coefficient λ, for example. The code amount is an amount of information of the coded stream Te obtained by performing entropy coding on the quantization error and the coding parameters. The square error is a sum of squares of residual values computed by the subtraction unit 102 for respective pixels. The coefficient λ is a preconfigured real number greater than zero. The coding parameter determination unit 110 selects a set of coding parameters for which the computed cost value is minimum. This allows the entropy coding unit 104 to output, to outside, the selected set of coding parameters as the coded stream Te and not to output the non-selected set of coding parameters.

The prediction parameter coding unit 111 derives a prediction parameter used for generating the prediction image, based on the parameter input from the prediction image generation unit 101 and codes the derived prediction parameter to generate a set of coding parameters. The prediction parameter coding unit 111 outputs the generated set of coding parameters to the entropy coding unit 104.

The prediction parameter coding unit 111 stores the prediction parameter corresponding to the set of coding parameters selected by the coding parameter determination unit 110 among the generated set of coding parameters in the prediction parameter memory 108.

In a case that the prediction mode predMode input from the prediction image generation unit 101 specifies the inter-prediction mode, the prediction parameter coding unit. 111 causes the inter-prediction parameter coding unit 112 to operate. In a case that the prediction mode predMode specifies the intra-prediction mode, the prediction parameter coding unit 111 causes the intra-prediction parameter coding unit 113 to operate.

The inter-prediction parameter coding unit 112 derives an inter-prediction parameter, based on the prediction parameter input from the coding parameter determination unit 110. The inter-prediction parameter coding unit 112 includes, as a configuration for deriving the inter-prediction parameter, a configuration the same as the configuration in which the inter-prediction parameter decoding unit 303 (see FIG. 5, or the like) derives the inter-prediction parameter. The configuration of the inter-prediction parameter coding unit 112 is described below.

The intra-prediction parameter coding unit 113 defines, as a set of inter-prediction parameters, the intra-prediction mode IntraPredMode which is specified by the prediction mode predMode input from the coding parameter determination unit 110.

### Configuration of Inter-Prediction Parameter Coding Unit

Next, a description is given of the configuration of the inter-prediction parameter coding unit 112. The inter-prediction parameter coding unit 112 is means corresponding to the inter-prediction parameter decoding unit 303.

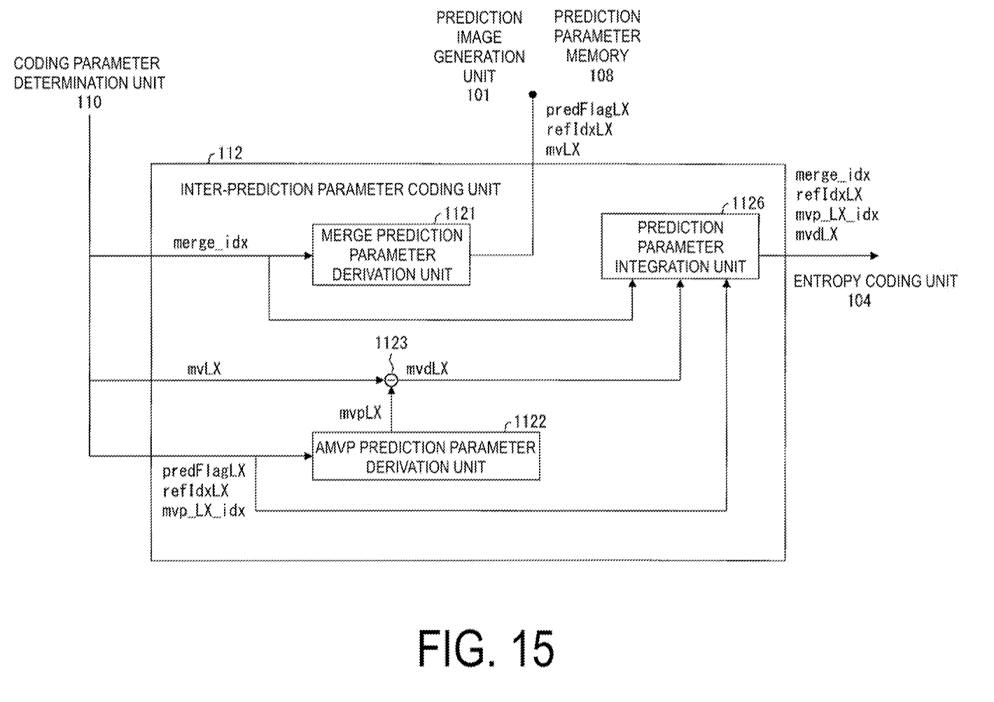

FIG. 15 is a schematic diagram illustrating the configuration of the inter-prediction parameter coding unit 112 according to the present embodiment.

The inter-prediction parameter coding unit 112 is configured to include a merge prediction parameter derivation unit 1121, an AMVP prediction parameter derivation unit 1122, a subtraction unit 1123, and a prediction parameter integration unit 1126.

The merge prediction parameter derivation unit 1121 includes a configuration similar to the merge prediction parameter derivation unit 3036 described above (see FIG. 7). To be more specific, the merge prediction parameter derivation unit 1121 includes a configuration similar to the merge candidate derivation unit 30361, the ATMVP merge candidate derivation unit 303613, the first derivation unit 3036131, the second derivation unit 3036132, and the third derivation unit 3036133 which are described above. The AMVP prediction parameter derivation unit 1122 includes a configuration similar to the AMVP prediction parameter derivation unit 3032 described above (see FIG. 10).

In a case that the prediction mode predMode input from the prediction image generation unit 101 specifies the merge prediction mode, the merge index merge idx is input from the coding parameter determination unit 110 to the merge prediction parameter derivation unit 1121. The merge index merge idx is output to the prediction parameter integration unit 1126. The merge prediction parameter derivation unit 1121 reads out a reference picture index refIdxLX and motion vector mvLX of a reference block indicated by the merge index merge idx among the merge candidates from the prediction parameter memory 108. The merge candidate is a reference PU in a predefined range from the coding target CU (e.g., a PU in contact with a lower left end, upper left end, or upper right end of the coding target PU), and is a PU on which the coding processing is completed

The AMVP prediction parameter derivation unit 1122 includes a configuration similar to the AMVP prediction parameter derivation unit 3032 described above (see FIG. 10).

To be more specific, in a case that the prediction mode predMode input from the prediction image generation unit 101 specifies the inter-prediction mode, the motion vector mvLX is input from the coding parameter determination unit 110 to the AMVP prediction parameter derivation unit 1122. The AMVP prediction parameter derivation unit 1122 derives a prediction vector mvpLX, based on the input motion vector mvLX. The AMVP prediction parameter derivation unit 1122 outputs the derived prediction vector mvpLX to the subtraction unit 1123. The reference picture index refIdx and the prediction vector index mvp_LX_idx are output to the prediction parameter integration unit 1126.

The subtraction unit 1123 subtracts the prediction vector mvpLX input from the AMVP prediction parameter derivation unit 1122 from the motion vector maX input from the coding parameter determination unit 110 to generate a difference vector mvdLX. The difference vector mvdLX is output to the prediction parameter integration unit 1126.

In a case that prediction mode predMode input from the prediction image generation unit 101 specifies the merge prediction mode, the prediction parameter integration unit 1126 outputs the merge index merge idx input from the coding parameter determination unit 110 to the entropy coding unit 104.

In a case that the prediction mode predMode input from the prediction image generation unit 101 specifies the inter-prediction mode, the prediction parameter integration unit 1126 performs the processing below.

The prediction parameter integration unit 1126 integrates the reference picture index refIdxLX and prediction vector index mvp_LX idx input from the coding parameter determination unit 110, and the difference vector mvdLX input from the subtraction unit 1123. The prediction parameter integration unit 1126 outputs the integrated code to the entropy coding unit 104.

The inter-prediction parameter coding unit 112 may include an inter-prediction parameter coding controller (not illustrated) which instructs the entropy coding unit 104 to decode the code (syntax element) associated with the inter-prediction to code the code (syntax element) included in the coding data, for example, the partition mode part_mode, the merge flag merge_flag, the merge index merge_idx, the inter-prediction indicator inter_pred_idc, the reference picture index refIdxLX, the prediction vector index mvp_idx, and the difference vector mvdLX.

In this case, an inter-prediction parameter coding controller 1031 is configured to include a merge index coding unit (corresponding to the merge index decoding unit 30312 in FIG. 12), a vector candidate index coding unit (corresponding to the vector candidate index decoding unit 30313 in FIG. 12), and a partition mode coding unit, a merge flag coding unit, an inter-prediction indicator coding unit, a reference picture index coding unit, a vector difference coding unit and the like. The partition mode coding unit, the merge flag coding unit, the merge index coding unit, the inter-prediction indicator coding unit, the reference picture index coding unit, the vector candidate index coding unit, and the vector difference coding unit code respectively the partition mode part_mode, the merge flag merge_flag, the merge index merge_idx, the inter-prediction indicator inter_pred_idc, the reference picture index refIdxLX, the prediction vector index mvp_LX_idx, and the difference vector mvdLX.

A part of the image coding device 11 and the image decoding device 31 in the embodiment described above, for example, the entropy decoding unit 301, the prediction parameter decoding unit 302, the prediction image generation unit 101, the DCT and quantization unit 103, the entropy coding unit 104, the dequantization and inverse DCT unit 105, the coding parameter determination unit 110, the prediction parameter coding unit 111, the entropy decoding unit 301, the prediction parameter decoding unit 302, the prediction image generation unit 308, and the dequantization and inverse DCT unit 311 may be implemented by a computer. In this case, this configuration may be realized by recording a program for realizing such control functions on a computer-readable recording medium and causing a computer system to read the program recorded on the recording medium for execution. Note that it is assumed that the “computer system” herein refers to a computer system built into any of the image coding devices 11 to 11h, the image decoding devices 31 to 31h, and the computer system includes an OS and hardware components such as a peripheral device. Furthermore, the “computer-readable recording medium” refers to a portable medium such as a flexible disk, a magneto-optical disk, a ROM, and a CD-ROM, and a storage device such as a hard disk built into the computer system. Moreover, the “computer-readable recording medium” may include a medium that dynamically retains the program for a short period of time, such as a communication line that is used to transmit the program over a network such as the Internet or over a communication line such as a telephone line, and a medium that retains, in that case, the program for a fixed period of time, such as a volatile memory within the computer system which functions as a server or a client. Furthermore, the program may be configured to realize some of the functions described above, and also may be configured to be capable of realizing the functions described above in combination with a program. already recorded in the computer system.

The image coding device 11 and image decoding device 31 in the present embodiment described above may be partially or completely realized as an integrated circuit such as a Large Scale Integration (LSI) circuit. The functional blocks of the image coding device 11 and the image decoding device 31 may be individually realized as processors, or may be partially or completely integrated into a processor. The circuit integration technique is not limited to LSI, and the integrated circuits for the functional blocks may be realized as dedicated circuits or a multi-purpose processor. Furthermore, in a case where with advances in semiconductor technology, a circuit integration technology with which an LSI is replaced appears, an integrated circuit based on the technology may be used.

The embodiment of the disclosure has been described in detail above referring to the drawings, but the specific configuration is not limited to the above embodiment and various amendments can be made to a design that fall within the scope that does not depart from the gist of the disclosure.

### Application Example

The image coding device 11 and the image decoding device 31 described above can be used in a state of being equipped on various devices for transmitting, receiving, recording, and reproducing video. The video may be a natural video imaged by a camera or the like, or an artificial video (including CG and GUI) generated by using a computer or the like.

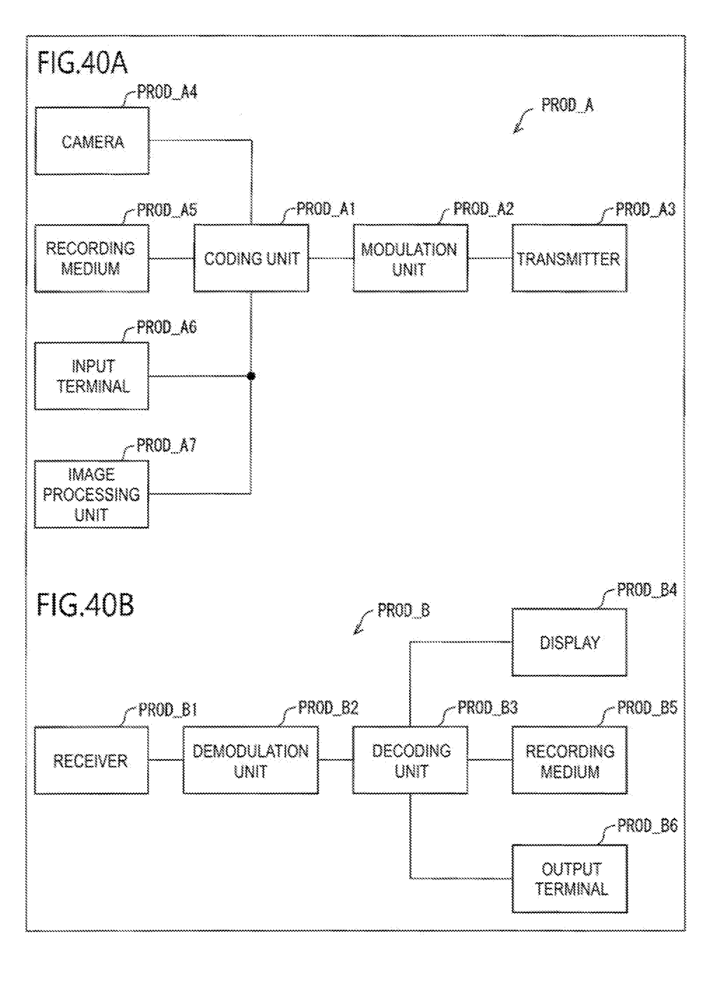

First, a description is given of that the image coding device 11 and the image decoding device 31 described above can be used to transmit and receive the video with reference to FIGS. 40A and 40B.

FIG. 40A is a block diagram illustrating a configuration of a transmission device PROD_A equipped with the image coding device 11. As illustrated in FIG. 40A, the transmission device PROD_A includes a coding unit PROD_A1 that codes video to acquire coded data, a modulation unit PROD_A2 that modulates a carrier wave by using the coded data acquired by the coding unit PROD_A1 to acquire a modulated signal, and a transmitter PROD_A3 that transmits the modulated signal acquired by the modulation unit PROD_A2. The image coding device 11 described above is used as the coding unit PROD_A1.

The transmission device PROD_A may further include, as resources for supplying video to input to the coding unit PROD_A1, a camera PROD_A4 that images the video, a recording medium PROD_A5 that records video therein, an input terminal PROD_A6 that inputs video from outside, and an image processing unit A7 that generates or processes images. FIG. 40A illustrates the configuration in which the transmission device PROD_A includes all of the above components, but some of these may be omitted.

The recording medium PROD_A5 may record the video not coded, or the video coded using a coding scheme for recording different from the coding scheme for transmission. In the latter case, a decoding unit (not illustrated) which decodes the coded data read out from the recording medium PROD_A5 in accordance with the coding scheme for recording may be provided between the recording medium PROD_A5 and the coding unit PROD_A1.

FIG. 40B is a block diagram illustrating a configuration of a reception device PROD_B equipped with the image decoding device 31. As illustrated in FIG. 40, the reception device PROD_B includes a receiver PROD_B1 that receives a modulated signal, a demodulation unit PROD_B2 that demodulate the modulated signal received by the receiver PROD_B1 to acquire coded data, and a decoding unit PROD_B3 that decodes the coded data acquired by the demodulation unit PROD_B2 to acquire the video. The image decoding device 31 described above is used as the decoding unit PROD_B3.

The reception device PROD_B may further include, as supply destinations of the video output by the decoding unit PROD_B3, a display PROD_B4 that displays the video, a recording medium PROD_B5 that records the video, and an output terminal PROD_B6 that outputs the video to outside. FIG. 40B illustrates the configuration in which the reception device PROD _B includes all of the above components, but some of these may be omitted.

The recording medium PROD_B5 may be configured to record the video not coded, or the video coded using a coding scheme for recording different from the coding scheme for transmission. In the latter case, a coding unit (not illustrated) which codes the video acquired from the decoding unit PROD_B3 in accordance with the coding scheme for recording may be provided between the decoding unit PROD_B3 and the recording medium PROD_B5.

A transmission medium for transmitting the modulated signal may be wireless or wired. A transmission aspect of transmitting the modulated signal may be a broadcast (here, referred to a transmission aspect of which transmission destination is not specified in advance), or a communication (here, referred to a transmission aspect of which transmission destination is specified in advance). To be more specific, transmission of the modulated signal may be achieved by any of the following including a radio broadcast, a cable broadcast, a radio communication, and a cable communication.

For example, a broadcast station (such as broadcast facilities)/receiving station (such as a TV set) of digital terrestrial broadcasting is an example of the transmission device PROD_A/reception device PROD_B transmitting and/or receiving the modulated signal on the radio broadcast. A broadcast station (such as broadcast facilities)/receiving station (such as a TV set) of a cable television broadcasting is an example of the transmission device PROD_A/reception device PROD_B transmitting and/or receiving the modulated signal on the cable broadcast.

A server (such as a workstation)/client (such as a TV set, a personal computer, a smartphone) including a Video On Demand (VOD) service or video-sharing service using the Internet is an example of the transmission device PROD_A/reception device PROD_B transmitting and/or receiving the modulated signal on the communication (in general, a wireless or wired transmission medium is used in LAN, and a wired transmission medium is used in WAN). Here, the personal computer includes a desktop PC, a laptop PC, and a tablet PC. The smartphone also includes a multifunctional mobile phone terminal.

The video-sharing service client has a function to decode coded data downloaded from the server to display on a display, and a function to code video imaged by a camera to upload to the sever. To be more specific, the video-sharing service client functions as both the transmission device PROD_A and the reception device PROD_B.

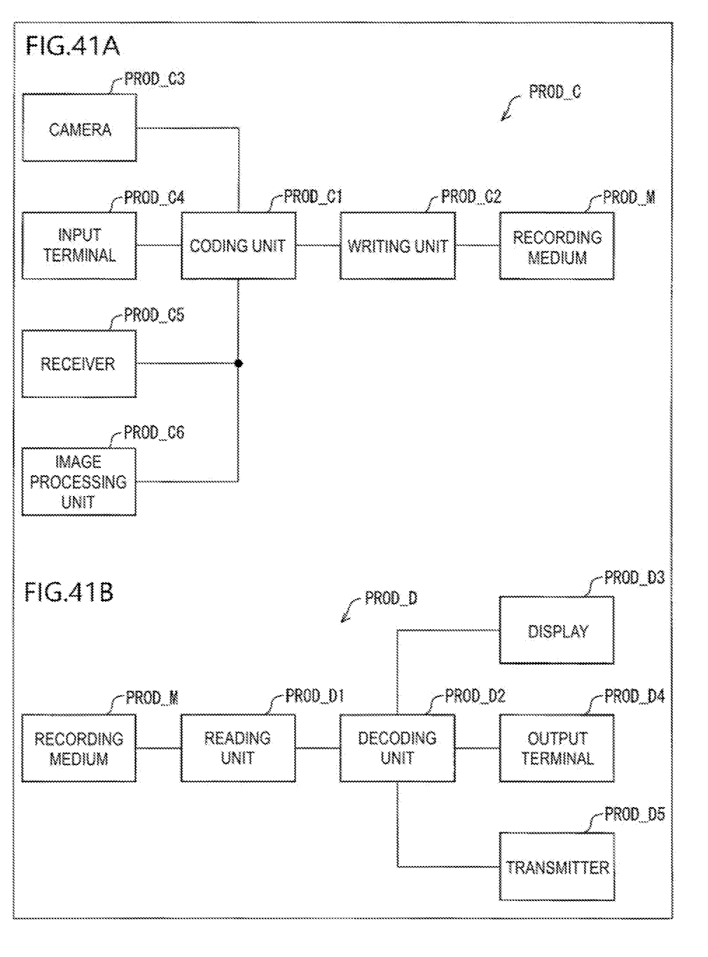

Next, a description is given of that the image coding device 11 and the image decoding device 31 described above can be used to record and reproduce the video with reference to FIGS. 41A and 41B.

FIG. 41A is a block diagram illustrating a configuration of a recording device PROD C equipped with the image coding device 11 described above. As illustrated in FIG. 41A, the recording device PROD _C includes a coding unit PROD Cl that codes video to acquire coded data, and a writing unit PROD C2 that writes the coded data acquired by the coding unit PROD_C1 into a recording medium PROD_M. The image coding device 11 described above is used as the coding unit PROD_C1.

The recording medium PROD _M may be (1) of a type that is built in the recording device PROD_C such as a Hard Disk Drive (HDD) and a Solid State Drive (SSD), (2) of a type that is connected with the recording device PROD_C such as an SD memory card and a Universal Serial Bus (USB) flash memory, or (3) of a type that is loaded into a drive device (not illustrated) built in the recording device PROD_C such as a Digital Versatile Disc (DVD) and a Blu-ray Disc (registered trademark) (BD).

The recording device PROD _C may further include, as resources for supplying video to input to the coding unit PROD_C1, a camera. PROD_C3 that images video, an input terminal PROD_C4 that inputs video from outside, a receiver PROD_C5 that receives video, and an image processing unit C6 that generates or processes images FIG. 41A illustrates the configuration in which the recording device PROD_C includes all of the above components, but some of these may be omitted.

The receiver PROD_C5 may receive the video not coded, or the coded data coded using a coding scheme for transmission different from the coding scheme for recording, in the latter case, a decoding unit for transmission (not illustrated) which decodes the coded data coded by using the coding scheme for transmission may be provided between the receiver PROD_C5 and the coding unit PROD_C1.

Examples of the recording device PROD C like this include a DVD recorder, a BD recorder, and a Hard Disk Drive (HDD) recorder (in this case, the input terminal PROD_C4 or the receiver PROD_C5 is mainly the resource for supplying the video). A camcorder (in this case, the camera PROD_C3 is the main resource for supplying the video), a personal computer (in this case, the receiver PROD_C5 or the image processing unit C6 is mainly the resource for supplying the video), and a smartphone (in this case, the camera PROD_C3 or the receiver PROD_C5 is the main resource for supplying the video) are also included in the examples of the recording device PROD_C like this.

FIG. 41B is a block diagram illustrating a configuration of a reproducing device PROD_D equipped with the image decoding device 31. As illustrated in FIG. 41B, the reproducing device PROD_D includes a reading unit PROD_D1 that reads out coded data written into the recording medium PROD_M, and a decoding unit PROD_D2 that decodes the coded data read out by the reading unit PROD_D1 to acquire video. The image decoding device 31 described above is used as the decoding unit PROD_D2.

The recording medium PROD_M may be (1) of a type that is built in the reproducing device PROD_D such as an HDD and an SSD, (2) of a type that is connected with the reproducing device PROD_D such as an SD memory card and a USB flash memory, or (3) of a type that is loaded into a drive device (not illustrated) built in the reproducing device PROD_D such as a DVD and a BD.

The reproducing device PROD_D may further include, as supply destinations of the video output by the decoding unit PROD_D2, a display PROD_D3 that displays the video, an output terminal PROD_D4 that outputs the video to outside, and a transmitter PROD_D5 that transmits the video. FIG. 41B illustrates the configuration in which the reproducing device PROD_D includes all of the above components, but some of these may be omitted.

The transmitter PROD_D5 may transmit the video not coded, or the coded data coded using a coding scheme for transmission different from the coding scheme for recording. In the latter case, a coding unit (not illustrated) which codes the video by using the coding scheme for transmission may be provided between the decoding unit PROD_D2 and the transmitter PROD_D5.

Examples of the reproducing device PROD_D like this include a DVD player, a BD player, and an HDD player (in this case, the output terminal PROD_D4 connected with a TV set or the like is the main supply destination of the video). A TV set (in this case, the display PROD_D3 is mainly the supply destination of the video), a digital signage (also referred to as an electronic signage or an electronic bulletin board, and the display PROD_D3 or the transmitter PROD_D5 is mainly the supply destination of the video), a desktop PC (in this case, the output terminal PROD_D4 or the transmitter PROD_D5 is mainly the supply destination of the video), a laptop or tablet PC (in this case, the display PROD_D3 or the transmitter PROD_D5 is the main supply destination of the video), and a smartphone (in this case, the display PROD_D3 or the transmitter PROD_D5 is the main supply destination of the video) are also included in the examples of the reproducing device PROD_D like this.

### Hardware Implementation and Software Implementation

The blocks in the image decoding device 31 and the image coding device 11 described above may be implemented by hardware using a logic circuit formed on an integrated circuit (IC chip), or by software using a Central Processing Unit (CPU).

In the latter case, the above-described devices include a CPU to execute commands of a program for achieving the functions, a Read Only Memory (ROM) to store the program, a Random Access Memory (RAM) to load the program, and a storage device (storage medium) such as a memory to store the program and various types of data. The object of an embodiment of the disclosure can be attained by causing a program code of a control program, which is software for realizing the functions described above, for the above respective devices (executable program, intermediate code program, source program) to be recorded in a recording medium in a computer-readable manner, causing the recording medium to be supplied to the above respective devices, and causing the computer (or the CPU or MPU) to read out the program code recorded in the recording medium for execution.

Examples of the above-described recording medium to use include tapes such as a magnetic tape and a cassette tape, disks or discs including a magnetic disk such as a floppy (registered trademark) disk/hard disk or an optical disc such as a Compact. Disc Read-Only Memory (CD-ROM)/Magneto-Optical (MO) disc/Mini Disc (MD)/Digital Versatile Disc (DVD)/CD Recordable (CD-R)/Blu-ray Disc (registered trademark), cards such as an IC card (including a memory card)/optical card, semiconductor memories such as a mask ROM/Erasable Programmable Read-Only Memory (EPROM)/Electrically Erasable and Programmable Read-Only Memory (EEPROM: registered trademark)/flash ROM, or logic circuits such as a Programmable logic device (PLD) and a Field Programmable Gate Array (FPGA).

The above-described devices may be configured to be connectable with a communication network to be supplied with the above-described program code through the communication network. This communication network is not specifically limited so long as the program code can be transmitted. For example, the Internet, an intranet, an extranet, a Local Area Network (LAN), an Integrated Services Digital Network (ISDN), a Value-Added Network (VAN), a Community Antenna television/Cable Television (CATV) communication network, a Virtual Private Network, a telephone network, a mobile communication network, a satellite communication network and the like are available. Transmission media constituting this communication network are not limited to a specific configuration or type so long as the program code can be transmitted. For example, a wired medium such as institute of Electrical and Electronic Engineers (IEEE) 1394, a USB, a power-line carrier, a cable TV line, a telephone line, and an Asymmetric Digital Subscriber Line (ADSL), or a wireless medium such as an infrared-ray including Infrared Data Association (IrDA) and a remote controller, Bluetooth (registered trademark), IEEE 802.11 wireless communication, High Data Rate (HDR), Near Field Communication (NFC), Digital Living Network Alliance (registered trademark) (DLNA), a mobile telephone network, a satellite circuit, and a digital terrestrial network are also available.

An embodiment of the disclosure may also be implemented in a form of a computer data signal embedded in a carrier wave in which the above-described program code is embodied by electronic transmission.

An embodiment of the disclosure is not limited to the above-described embodiments, and can be variously modified within a scope of the claims. To be more specific, embodiments made by combining technical means which are adequately modified within the scope of the claims are also included in the scope of an embodiment of the disclosure.

### CROSS-REFERENCE OF RELATED APPLICATION

This application claims priority based on JP 2016-097458 filed in Japan on May 13, 2016, the contents of which are entirely incorporated herein by reference.

### INDUSTRIAL APPLICABILITY

An embodiment of the disclosure can be preferably applied to an image decoding device that decodes coded data in which image data is coded and an image coding device that generates coded data in which image data is coded. An embodiment of the disclosure can be also preferably applied to a data structure of the coded data which is generated by the image coding device and referred to by the image decoding device.

### REFERENCE SIGNS LIST

11 . . . Image coding device (video coding device)

31 . . . Image decoding device (video decoding device)

302 . . . Prediction parameter decoding unit

303 . . . Inter-prediction parameter decoding unit

3036 . . . Merge prediction parameter derivation unit (motion vector candidate derivation unit)

30361 . . . Merge candidate derivation unit

303613 . . . ATMVP merge candidate derivation unit

3036131 . . . First derivation unit

3036132 . . . Second derivation unit

3036133 . . . Third derivation unit

1. A video decoding device for referring to a prediction image obtained by motion compensation using a motion vector to generate a decoded image, the video decoding device comprising:
a motion vector candidate derivation unit configured to derive a motion vector candidate used for the motion compensation, wherein
the motion vector candidate derivation unit includes
a first derivation unit configured to derive an initial motion source vector MSV0,
a second derivation unit configured to derive, as a motion source vector MSV, the initial motion source vector MSV0 or a vector obtained by scaling the initial motion source vector MSV0, and
a third derivation unit configured to identify, as a corresponding sub-block CSB, a sub-block which is associated through the motion source vector MSV with a target sub-block on a target picture and is on a motion source picture MSP, and derive, as a motion vector candidate for the target sub-block, a corresponding sub-block motion vector CSBMV which is a motion vector in the corresponding sub-block CSB or a vector obtained by scaling the corresponding sub-block motion vector CSBMV, and
the first derivation unit derives, as the initial motion source vector MSV0, a motion vector in a block or sub-block with a feature amount satisfying a prescribed condition among multiple blocks or sub-blocks neighboring to a target block including the target sub-block.

2. The video decoding device according to claim 1, wherein
the first derivation unit derives, as the initial motion source vector MSV0, a motion vector in the block or sub-block for a reference picture from which a temporal distance to the target picture is the smallest among the multiple blocks or sub-blocks neighboring to the target block including the target sub-block.

3. The video decoding device according to claim 1, wherein
the first derivation unit derives, as the initial motion source vector MSV0, a motion vector in the block or sub-block having the smallest area among the multiple blocks or sub-blocks neighboring to the target block including the target sub-block.

4. The video decoding device according to claim 1, wherein
the first derivation unit derives, as the initial motion source vector MSV0, a motion vector in the block or sub-block from which a spatial distance to the target block is the smallest among the multiple blocks or sub-blocks neighboring to the target block including the target sub-block.

5. The video decoding device according to claim 1, wherein
the first derivation unit derives, as the initial motion source vector MSV0, a motion vector in the block or sub-block with the smallest quantization parameter among the multiple blocks or sub-blocks neighboring to the target block including the target sub-block.

6. A video decoding device for referring to a prediction image obtained by motion compensation using a motion vector to generate a decoded image, the video decoding device comprising:
a motion vector candidate derivation unit configured to derive a motion vector candidate used for the motion compensation, wherein
the motion vector candidate derivation unit includes
a first derivation unit configured to derive an initial motion source vector MSV0,
a second derivation unit configured to derive, as a motion source vector MSV, the initial motion source vector MSV0 or a vector obtained by scaling the initial motion source vector MSV0, and
a third derivation unit configured to identify, as a corresponding sub-block CSB, a sub-block which is associated through the motion source vector MSV with a target sub-block on a target picture and is on a motion source picture MSP, and derive, as a motion vector candidate for the target sub-block, a corresponding sub-block motion vector CSBMV which is a motion vector in the corresponding sub-block CSB or a vector obtained by scaling the corresponding sub-block motion vector CSBMV, and
the first derivation unit derives, as the initial motion source vector MSV0, a motion vector in a block or sub-block to which merge prediction is applied among multiple blocks or sub-blocks neighboring to a target block including the target sub-block.

7. A video decoding device for referring to a prediction image obtained by motion compensation using a motion vector to generate a decoded image, the video decoding device comprising:
a motion vector candidate derivation unit configured to derive a motion vector candidate used for the motion compensation, wherein
the motion vector candidate derivation unit includes
a first derivation unit configured to derive an initial motion source vector MSV0,
a second derivation unit configured to derive, as a motion source vector MSV, the initial motion source vector MSV0 or a vector obtained by scaling the initial motion source vector MSV0, and
a third derivation unit configured to identify, as a corresponding sub-block CSB, a sub-block which is associated through the motion source vector MSV with a target sub-block on a target picture and is on a motion source picture MSP, and derive, as a motion vector candidate for the target sub-block, a corresponding sub-block motion vector CSBMV which is a motion vector in the corresponding sub-block CSB or a vector obtained by scaling the corresponding sub-block motion vector CSBMV, and
the third derivation unit
in a case that a slice which is obtained by partitioning the target picture and includes the target sub-block is a slice to which bidirectional prediction is applied, and the corresponding sub-block CSB is associated with multiple corresponding sub-block motion vectors CSBMV,
derives, as bidirectional motion vector candidates for the target sub-block, higher priority corresponding sub-block motion vectors CSBMV among the multiple corresponding sub-block motion vectors CSBMV, or vectors obtained by scaling the higher priority corresponding sub-block motion vector CSBMV.

8. The video decoding device according to claim 7, wherein
in a case that bidirectional motion vectors for the corresponding sub-block CSB are not in a relationship in which speeds thereof are equal to each other, the third derivation unit derives, as the bidirectional motion vector candidates for the target sub-block, higher priority corresponding sub-block motion vectors CSBMV among the multiple corresponding sub-block motion vectors CSBMV, or a vector obtained by scaling the higher priority corresponding sub-block motion vector CSBMV.

9. The video decoding device according to claim 7
the third derivation unit determines a motion vector associated with a reference picture temporally closer to the target picture as a higher priority motion vector, among reference pictures in both directions of the corresponding sub-block CSB.

10. The video decoding device according to claim 7, wherein
in a case of assuming that
a picture order count of the target picture is expressed as POC (Pc), and
a picture order count of the reference picture is expressed as POC (RefCSBLX), and
a picture order count of the MSP is expressed as POC (MSP),
the third derivation unit determines, as a higher priority motion vector, a motion vector associated with a reference picture satisfying
POC(MSP)>POC(Pc)>POC(RefCSBLX) or
POC(MSP)<POC(Pc)<POC(RefCSBLX),
among the reference pictures in both directions of the corresponding sub-block CSB.

11. The video decoding device according to claim 1, wherein the video decoding device
derives, as a motion source block MSB, a block which is associated through the motion source vector MSV with the target block and is on the motion source picture MSP,
identifies a motion vector in the motion source block MSB as a corresponding motion vector CMV,
derives, as a default motion vector, a vector obtained by scaling the corresponding motion vector CMV, and
derives the default motion vector as a motion vector candidate for the target sub-block, in a case that the corresponding sub-block motion vector CSBMV fails to be derived.
